(19) United States
(12) Patent Application Publication
(10) Pub. No.: US 2004/0054690 A1
(43) Pub. Date: Mar. 18, 2004

(54) Modeling and using computer resources over a heterogeneous distributed network using semantic ontologies

(76) Inventors: Eric T. Hillerbrand, Atlanta, GA (US); Girish Padmalyan, Atlanta, GA (US); Michelle Pauly, Duluth, GA (US); Jhong-Hee Park, Suwanee, GA (US); Sujith Kumar, Atlanta, GA (US); William S. Glasgow, Peachtree City, GA (US); Sambasiva Murakonda, Marietta, GA (US); Tim D. Sebel, Atlanta, GA (US); Vivekanand Velmuran, Chamblee, GA (US); Chitta Basu, Planboro, NJ (US)

Correspondence Address: Jack D. Todd, Morris, Manning & Martin, LLP, 1600 Atlanta Financial Center, 3343 Peachtree Road, Atlanta, GA, 30326-1044, US

(21) Appl. No.: 10/386,362

(22) Filed: Mar. 10, 2003

Related U.S. Application Data
(60) Provisional application No. 60/362,734, filed on Mar. 8, 2002.

(51) Int. Cl. G06F 7/00

(52) U.S. Cl. 707/104.1

(57) ABSTRACT

A method of computing to address a predetermined computing requirement involving access to and use of computer resources, where more than one resource is capable of addressing the computing requirement. The method includes steps of describing plural computer resources using a description language, thereby obtaining descriptions of the resources; arranging the descriptions in one or more semantic ontologies; accessing one or more of the ontologies to select a particular one of the plural resources as available and/or qualified for addressing the computing requirement; and executing a computing process that utilizes the selected one of the plural resources to satisfy the computing requirement.

The disclosed method involves use of description language and the computer resources comprise web services. The describing step involves identifying attributes of the computer-accessible resources. The attributes of the computer resources are selected from the group comprising but not limited to: message formatting for the computer resources, transport mechanisms associated with the computer resources, protocols associated with the computer resources, type serialization associated with the computer resources, and invocation requirements of the computer resources. In further accordance with the method, the invocation requirements of the computer resources may be selected from the group comprising: HTTP, SOAP, CORBA, JAVA RMI, and equivalent computer invocation specifications.

### CROSS REFERENCE TO RELATED APPLICATION

This application claims the benefit under 35 U.S.C. § 119(e) of U.S. provisional patent application No. 60/362,734, entitled, “Web Services Management Through the Use of an Ontology,” filed Mar. 8, 2002, which is incorporated herein by reference. The application incorporates co-pending PCT Pat. Appl. No.______, entitled “METHODS AND SYSTEMS FOR MODELING AND USING COMPUTER RESOURCES OVER A HETEROGENEOUS DISTRIBUTED NETWORK USING SEMANTIC ONTOLOGIES,” filed concurrently herewith.

### FIELD OF THE PRESENT INVENTION

The present invention relates generally to network-based computer systems and, more particularly, to methods and systems for enabling the management and dynamic use of computer resources, such as web services, in a heterogeneous distributed network through the use of semantic ontological models.

### BACKGROUND OF THE PRESENT INVENTION

The dynamics of business are changing. In the past, business optimization resulted from standardized processes, centralized control, and fixed or clearly defined boundaries for activities and transactions. Presently, businesses are looking to adopt business models that can respond more flexibly to change. In the future, businesses will require models that support decentralized control and enhanced patterns of business interaction across enterprises that are distributed and virtual.

As businesses have evolved, so has the information technology (IT) used by such businesses. No longer can enterprise computer systems be contained within an environment that is homogenous, centrally-managed, clearly-bounded, totally-insulated, and secure. Thus, CIOs of companies have increasingly witnessed the decomposition of highly-integrated internal IT infrastructure into a collection of heterogeneous and fragmented systems. Parallel with this decomposition has come increased business requirements for flexible integration of and uniform access to these fragmented computer resources.

The ability to integrate disparate computer resources, such as computer applications, databases, and web-accessible services, both within a single organization and among business partners and customers, remains a daunting task. For example, computer software continues to be developed by numerous independent companies across many platforms, using a variety of ever-changing computer languages, and without widespread adoption of standards, norms, or protocols that would enable seamless integration of such computer resources. Although integration of a plurality of computer resources within an enterprise or between selected business partners is possible, albeit expensive, on a case-by-case basis, there currently does not exist a system or methodologies for enabling distributed technologies to communicate in a meaningful manner on a large scale or scalable basis.

Numerous attempts have been made and will continue to be made to improve the prospects for integration of and communication between all types of computer resources. For example, in the Internet arena, “web services” represent an emerging set of standards that enable companies to provide web-accessible software functions to users or business partners through structured interaction and non-proprietary standards. Technically, a web service is a programmatic interface, which is network-addressable through a universal resource identifier (e.g., a URL), and which is transported, routed, and packaged over network protocols, such as HyperText Transport Protocol (HTTP) or TCP/IP. This standards-based interface is enabled through the use of the eXtensible Mark-up Language (XML). XML is an increasingly-adopted standard for describing data format and syntax using a mark-up format. XML is used in the web service's programmatic interface to define Remote Procedure Calls (RPC) for accessing legacy systems. A generally-accepted standard for defining web service interfaces is the Web Service Description Language (WSDL). The WSDL standard provides a standardized, XML-based format for describing the interfaces, their operations, and inputs/outputs. In a typical web services scenario, a business application sends a request to an Internet-accessible application at a given URL using the Simple Object Access Protocol (SOAP) over HTTP. The request is formatted based on a WSDL specification. The application receives the request, processes it, and returns a response based on the formatted WSDL specification.

Associated with each web service is a set of descriptors, such as service creator, origin, and type. Descriptors also include technical details, including inputs, outputs, preconditions, effects, and implementation specifics. Web service implementation may also include information, such as message formatting, transport mechanisms, protocols, type serialization, and invocation requirements. Invocation requirements include, for example, HTTP form, SOAP specifications, CORBA IDL, and Java RMI. Finally, in order to create service flows or composites of services, these composites must describe flows in terms of “constructs” describing as sequence, if-then-else logic, fork conditions, and data and control flow in a machine understandable form. Machine understandability is required in order for there to be automatic web service invocation, composition, interoperation, and monitoring.

An oft-cited example of a web service is that of an airline reservation web service, which acts as an interface to an airline reservation software application. The web service describes, in an XML format, a specific operation of the airline reservation software application, such as “Get Reservation.” This operation contains several input parameters such as “Location,” “Date,” and “Airline.” The operation also contains several output parameters such as “Date,” “Time,” and “Reservation Number.” When executed, the input parameters and operation name are passed to the application using the web service description, and an airline reservation is returned.

While web services have the potential to revolutionize the way business is conducted on the web, there are numerous obstacles that must be overcome. Some of the obstacles include finding ways to describe web services, the operations, and inputs/outputs, finding ways of finding those web services based on these descriptions, and executing a web service, or a sequence of web services based on those descriptions. As companies begin deployment of services, or as application vendors begin creating web service interfaces to their applications, companies will face problems in finding web services—especially if there are multiple services that can perform competing functions the company desires. Meaningful access to competing web services is difficult because each web service uses its own terminology and typically identifies its input and output variables and its functional methods differently. XML, as the standard for describing web services, provides no structure for creating definitions of these web service functions. Software development does not require a standardized nomenclature for developers to describe a particular function or variables. Software developers oftentimes choose function descriptions that provide development utility rather than understandability. With the complexities inherent in the English language, as well as any other language, developers typically describe similar functions, tasks, or operations in a wide variety of manners. As a result, two applications may have two totally different ways of describing and invoking applications to return essentially the same information. Even with standards for such naming functions (as is being attempted and required by Microsoft's .NET platform), discrepancies in applying the standards make it difficult for widespread access and use of such web services. Further, forcing each web service to conform to a standard naming convention may not make logical or semantic sense based on the “non-standard” terminology that already exists in any particular business industry. Most importantly, standards are seldom universally-adopted, so there will always be complexities in understanding or translating function descriptions.

Even if there is, ultimately, widespread adoption of a particular web service description language, it is likely that these descriptions will be targeted to computer program developers rather than business end users. If the utilization of the host of web services is limited to employees with an advanced degree in computer sciences, then the majority of companies that could benefit from such a system will be left wanting. Thus, there is a need in the art for systems and methods that allow a wide variety of users to exploit the available web services.

Thus, there is a need for effective categorization and description of services based on the various service descriptors. Effective description and categorization of services would resolve a number of problems related to discovery, invocation, interoperation, composition and execution monitoring. In order to discover and execute web services, and in order to compose execution flows of disparate web service flows, however, it will be necessary to perform searches and queries based on properties and attributes. Even if a web service is discovered, in order for data about the web service to be understood, the context of that data must be understood. If the entity's “context,” such as how it was developed, who developed it, and what it is used for cannot be understood, then it will remain difficult to interact effectively with the service. Without technologies for structuring and managing data and meta-data, web services will remain undiscoverable or misunderstood. The ability to attribute meta data to services, and then run queries based on that meta data is, therefore, central to the purpose of service registration, publication, and discovery at both design time and run time. Absent technologies for service description and classification, web services will not be adopted in a wholesale manner. Given the increasing fragmentation of their systems, IT departments require a mechanism for creating abstractions of the functions defined in web service in order to be relevant and of value to the business user. Software technologies have typically created interoperable functions and systems by creating more abstract descriptions of those computer functions (typically called “abstractions”).

Thus, there is a need for effective data abstractions within the field of computer science that will translate across different data definitions and formats. There is a need for data abstraction for the purposes of classification and description to provide for dynamic translation and discovery. Dynamic data management and representation technologies will engender a dynamic configuration methodology to web services software architecture.

For these and many other reasons, there is a general need for system and methods for enabling businesses to create, manage, and share complicated descriptions of computer resources. In order to create, manage and share these resources, whether data stored in a database, or a web service interface to a software application, systems and methods are necessary to create, maintain, and utilize descriptions of those resources based on abstract definitions that are in a format that is simultaneously computer interpretable and human understandable. When a computer resource is described in a human understandable form, it defines the resource in terms of business operations and definitions. As a result these resources can be categorized, indexed, and discovered based on certain business contexts. In parallel, a computer resource is computer interpretable when it can be discovered, invoked, interoperate with other computer resources, and monitored despite disparate formats and descriptions.

Thus, there is a need for systems and methods to enable users to describe computer resources in native terminologies that are computer interpretable and support cross-terminology discovery and interoperation. In order to create these terminologies for describing these resources and based on abstractions of what a resource is and does, system and methods are required for creating, managing, and using terminology models that can provide a high-level description of the resource and its provider, including a specification of the functionalities provided by the computer resource, the resources functional attributes, including its requirements and capabilities. Such descriptions can be used for designing use of computer resources or invoking computer resources either during a software design phase or during actual execution. Dynamic discovery and invocation of resources and the creation of resource composites in which disparate resources are able to interoperate is dependent on the robustness of resource descriptions and the richness of the resource's meta data.

The present invention meets one or more of the above-referenced needs as described herein in greater detail.

### SUMMARY OF THE PRESENT INVENTION

The present invention relates generally to network-based computer systems and, more particularly, to methods and systems for enabling the management and dynamic use of computer resources, such as web services, in a heterogeneous distributed network through the use of semantic ontological models. The present invention provides systems and methods for use of a core set of markup language constructs as part of general-purpose models and corresponding syntax for describing the properties and capabilities of computer resources in unambiguous, computer-interpretable form. This allows for automated computer resource discovery, invocation, interoperation, composition, and execution monitoring. Computer-interpretability allows software applications to be created that perform: (i) automatic web service discovery by locating web services that provide a particular service that adheres to requested constraints; (ii) atomatic web service invocation through use of a machine understandable description of the service and how specific operations within the service are invoked; (iii) automatic web service flow generation and interoperation by describing interfaces and pre- and post conditions so as to allow software automatically to translate and transform between disparate services based on a specific objective; and (iv) automatic event and execution monitoring by describing service execution and critical events so that software monitor services that have disparate descriptions.

Briefly described, aspects of the present invention include the following. In a first aspect of the present invention, a method of computing is provided to address a predetermined computing requirement involving access to and use of computer resources, where more than one resource is capable of addressing the computing requirement. The method includes steps of (a) describing plural computer resources using a description language, thereby obtaining descriptions of the resources; (b) arranging the descriptions in one or more semantic ontologies; (c) accessing one or more of the ontologies to select a particular one of the plural resources as available and/or qualified for addressing the computing requirement; and (d) executing a computing process that utilizes the selected one of the plural resources to satisfy the computing requirement.

The disclosed method according to this aspect, it will be appreciated, involves use of description language such as XML, DAML, DAML+OIL, RDF, and WSDL. In particular preferred embodiment, the computer resources comprise web services.

In accordance with the method, the describing step involves identifying attributes of the computer-accessible resources. Preferably, the attributes of the computer resources are selected from the group comprising but not limited to: message formatting for the computer resources, transport mechanisms associated with the computer resources, protocols associated with the computer resources, type serialization associated with the computer resources, and invocation requirements of the computer resources. In further accordance with the method, the invocation requirements of the computer resources may be selected from the group comprising: HTTP, SOAP, CORBA, JAVA RMI, and equivalent computer invocation specifications.

A first ontology in the method may represent a computer resource structural ontology, and a second ontology may represent a computer resource classification ontology relating to metadata associated with one or more computer resources. A third ontology may represent an information model. Yet another ontology may represent an execution model corresponding to a set, sequence, and/or conditions of invoking computer resources to carry out a complex computing process. Further still, yet another ontology may comprise a transformation ontology representing predetermined transformations to be applied to selected computer resources.

In further accordance with the method, the computer resources may be selected from the group comprising but not limited to: computer application programs; web services; databases; directory services for users and groups of users (e.g., LDAP); file systems; digital media repositories; content repositories; enterprise resource registries; network-accessible resource registries; application interfaces; productivity applications such as spreadsheets or word processing applications; and network and system management systems.

According to another aspect of the invention, we disclose a method of computing to address a predetermined computing requirement involving access to and use of computer resources. This method comprises steps including registering one or more computer resources in a computer resource registry; storing informational attributes of the computer resources obtained by marking up the one or more computer resources; storing metadata associated with the computer resources reflecting supplemental informational attributes of the computer resources; creating and storing descriptions of the computer resources in an information model utilizing the informational attributes and the supplemental informational attributes; creating and storing a computer process execution model reflecting utilization of a an information model to address the predetermined computing requirement; receiving input parameters from a computer system user, as a part of executing a computer process execution model; and providing results of execution of the computer process execution model utilizing the user's input parameters.

In this disclosed method, the informational attributes of the computer resources may also be selected from the group comprising but not limited to an interface to the computer resource, a pre-condition of executing the computer resource, a post-condition associated with the computer resource, a constraint associated with the computer resource, and one or more semantic relationships between the computer resources and other information. The informational attributes of the computer resources are preferably stored in a computer resource structural ontology. The metadata is stored in a computer resource classification ontology.

The disclosed method may further involve the step of applying a transformation utilizing a transformation ontology to determine a correspondence between parameters of two different computer resources.

According to yet another aspect of the invention, there is disclosed a method of computing to satisfy a predetermined computing requirement involving access to and use of computer-accessible resources. In accordance with this method, computer resources that may be available to address a portion of the predetermined computing requirement are first located. Located computer resources are registered in a computer resource registry. The registered computer resources are then marked up to reflect their capabilities, constraints, and conceptual relationships in a mark-up language, thereby creating one or more ontologies and instances thereof. The created one or more ontologies and instances thereof are stored in an ontology store. An information model is created that addresses aspects of the predetermined computing requirement, the information model utilizing the stored ontologies and instances thereof. The information model is stored in an information model store. Ultimately, the information model is executed based on input data, to address the predetermined computing requirement.

In a preferred aspect of the method, the mark-up language is DAML+OIL, but other equivalent description logics may be applied. The input data may be provided by a user of the information model. The input data may conveniently be provided by a transformation ontology that stores default data for use in the process.

In accordance with yet another aspect of the invention, we disclose a computer system operative to address a predetermined computing requirement utilizing one or more disparate computer resources via a networked arrangement. The disclosed system includes a computer resource structural ontology for storing informational attributes associated with the available computer resources, a computer resource classification ontology for storing supplemental informational attributes associated with the available computer resources; an information model ontology for storing aspects of the predetermined computing requirement; and an execution model ontology for storing information related to execution of a particular set and sequence of execution of computer resources. These ontologies may be represented electronically, and/or stored on an electronic medium.

The supplemental information associated with the available computer resources typically comprises metadata. The metadata may be provided by a user of the computer system during a mark-up process.

A system according to this aspect of the invention further comprises a transformation ontology for enabling translation and/or transformation of relationships between specific parameters required by particular computer resources.

According to yet another aspect of the invention, we disclose a method of computing to address a predetermined computing requirement utilizing one or more networked computer resources, comprising the steps of storing at least one semantic ontology for describing informational attributes of the computer resources and metadata reflecting supplemental informational attributes of the computer resources, thereby reflecting the form and function of such computer resources; and executing a computing process involving access to and utilization of the at least one semantic ontology. In accordance with this aspect of the invention, the information attributes of the computer resources are selected from the group comprising but not limited to: an interface to the computer resource, a pre-condition of executing the computer resource, a post-condition associated with the computer resource, a constraint associated with the computer resource, and one or more semantic relationships between the computer resources and other information. As in other aspects of the invention, the supplemental informational attributes of the computer resources may comprise information not directly acquired from the computer resources but provided by a third party. The third party may be an entity that ascribes predetermined subjective and/or objective qualities about the computer resources.

In accordance with yet another aspect of the invention, we disclose a method of computing to address a predetermined computing requirement utilizing one or more networked computer resources, comprising the steps of utilizing a description logic to represent abstractions of computer resources to facilitate discovery, invocation, and interoperability of such computer resources; and executing a computing process involving access to and utilization of the abstractions to invoke the computer resources to address the computing requirement. As in other aspects of the invention, the description logic is selected from the group comprising, but not limited to: DAML, DAML+OIL, XML, RDF, WSDL, and other equivalent description logic languages and/or systems. Preferably, the description logic is utilized to create and store one or more ontologies representing informational attributes of the computer resources.

In accordance with still another aspect of the invention, we disclose a method of computing to address a computing requirement of a computer end user involving access to and utilization of one or more networked computer resources, involving steps for searching for execution models and executing them. In this aspect of the invention, the method involves accessing a network-accessible computer system storing a computer resource structural ontology, to characterize one or more computer resources in terms of certain business or abstract technical concepts using one or more business information model ontologies. An execution model representing a set, sequence, and/or conditions of invoking the computer resources to carry out a computing requirement is stored. A search is thereafter conducted for a pre-stored execution model. A retrieved pre-stored execution models is executed by providing a command and input parameters as required by the business information model ontology and associated computer resources, so as to carry out the computing requirement.

In still and yet another aspect of the invention, we disclose a method of computing to facilitate interoperability of network-accessible computer resources. This method comprises providing a service for computer resource discovery by locating one or more computer resources that provide a desired computing service that adheres to a particular constraint; providing a service for computer resource invocation through use of a machine understandable description of the one or more computer resource and a manner of invoking the one or more computer resources; providing a service for computer process flow generation and interoperation of one or more computer resources by describing interfaces and any applicable pre- and post conditions for invocation of the one or more computer resources so as to translation and/or transformation between different computer resources services based on a specific objective; and providing a service for event and execution monitoring of a computing process that invokes the one or more computer resources by describing service execution and critical events of the computing process.

In accordance with yet another aspect of the invention, we disclose a method for representing network-accessible computer resources such that one or more computer resources may be invoked to execute a required computing requirement. In this disclosed method, structural descriptions of the computer resources are extracted from pre-existing information sources (registry, XML) to provide a structural ontology instance of a structural ontology populated with informational attributes relating to the computer resources. The structural ontology instance and the structural ontology are stored in an ontology store. First metadata descriptions of the computer resources are stored so as to provide supplemental informational attributes about the computer resources. The first metadata descriptions correspond to a classification ontology instance of a classification ontology in the ontology store. Information relating to context comprising second metadata from a metadata component is extracted so as to populate the classification ontology instance with context information associated with the computer resource. A final ontological model of the computer resources is stored in the ontology store, the final ontological model comprising collective descriptions of the computer resources.

The ontology store may then be queried to obtain a collective description of at least one computer resource based on a search criterion. At least one computer resource satisfying the search criterion is located.

As in other aspects of the invention, the computer resources may comprise web services. The collective descriptions of the computer resources may include but are not limited to security parameters, methods, applicable inputs and outputs, and access control information.

It will be understood that this and other methods may further comprise the step of locating computer resources stored in a resource registry prior to extracting of the structural descriptions of the computer resources. Further, the computer resources may be described in a DAML/XML format and stored in the ontology store, or in any of a number of other equivalent description logic representations and/or formats.

According to another aspect of the invention, we disclose a system for invoking one or more network-accessible computer resources to carry out a complex computing task. This disclosed system includes a user interface component for receiving user commands and input information from users and/or external computer systems. A model editor component is provided for registration of computer resources and creation of ontology schemas and instances of ontology schemas, thereby forming at least one descriptive model and at least one information model, said descriptive model and said information model represented by ontologies. A services broker component is provided for communicating with and monitoring computer resources invoked by said information model. A semantic broker component is provided for managing an ontology database that stores said ontologies. An event manager component is provided for managing the creation and/or execution of rules related to events associated with invoking of said computer resources.

In this disclosed system, the user interface component is operative for functions of security, user authentication, and a graphical user interface for human users. Further, the user interface component may determine the format and content of information to be presented to external entities operatively connected to the system, and interpret inputs that are presented to the system by any external entities. The user interface component may be further operative for providing a graphical display to human users of the operations of the model editor component.

The model editor component allows for construction of an information model that enables execution of a single computer resource or of multiple computer resources either sequentially or based on pre-conditions or post-conditions, to carry out complex computing tasks. The model editor component also provides for creation and storage of event-condition-action rules for execution of said information model.

The services broker component initiates calls to computer resources, monitors the status of operation of initiated computer resources, and receives data back from the operations of such computer resources.

The semantic broker component provides for an index and classification of specific computer resources and their functions, data structures, metadata corresponding thereto, and use based on ontological representations stored in the ontology database.

Rules associated with the event manager component relate to searching of ontologies in the ontology database, discovery of computer resources, and execution of the computer resources.

In accordance with yet another system embodiment of the invention, we disclose a system for invoking one or more network-accessible computer resources to carry out a computing task on behalf of external entities such as individual user and/or a third party computer system. Such a system comprises a presentation layer component for handling communications with the system from said external entities. The system further comprises a public service component for processing input data streams and determining if data streams should be directed to an ontology composer component or a service broker component. The system further comprises an ontology composer component for allowing construction of ontological representations of computer resources, metadata associated with computer resources, information models, and execution models. The system further comprises a service broker component for communicating with and monitoring invoked computer resources. The system further comprises a model editor component operative for handling the construction of ontology schemas and/or population of instances of ontology schemas. The system further comprises a search component operative for searching within said resource registry to obtain information about one or more available and/or suitable computer resources. The system further comprises a messaging component operative for communicating messages to and from selected computer resources. The system further comprises a semantic broker component operative for controlling storage and access to said ontological representations in an ontology store.

In further accordance with this disclosed system, a metadata component operative to control the accessing by the search component as a function of user context and/or application may be provided. The metadata component may be operative to apply constraints to search results based on user authentication.

In accordance with this system, the ontology schemas include but are not limited to one or more of the following: computer resource structure ontology, computer resource classification ontology, information model ontology, execution model ontology, and transformation ontology.

The service broker component may comprise a business logic analyzer subcomponent and a service handler subcomponent, as we describe. The business logic analyzer component is preferably operative for receiving an execution model ontology, deconstructing it into executable segments; and initiating the segments to cause invocation of the corresponding computer resource(s). The business logic analyzer is further operative for sequencing the invocation of computer resources. The business logic analyzer component is preferably coupled to the messaging component for handling invocation of computer resources and receiving information back from the execution of computer resources.

This system preferably includes an ontology store for storing the described ontological representations. The ontological representations are typically expressed in a description logic. The description logic may be selected from the group comprising but not limited to: RDF, DAML, DAML+OIL, XML, WSDL, and other equivalent description logic languages and/or systems.

The semantic broker in this system may comprises an atlas subcomponent and a mark-up subcomponent. Further, a resource registry for storing information about computer resources that are available and/or suitable for addressing the computing task may be included. In accordance with an aspect of the invention, the resource registry is UDDI-compliant.

The messaging component may include a publisher subcomponent and a listener subcomponent. The messaging component is operatively associated with a message queue that stores messages for transmission to selected computer resources and information received back from invoked computer resources.

This disclosed system may also include an interpretation component operative for applying transformations between parameters associated with selected computer resources. This system may also include an inference component operative for applying inference rules to elements of ontologies.

In accordance with yet another aspect of the invention, we disclose a system for invoking one or more network-accessible computer resources to carry out a complex computing task. This system includes a computer resource control system that is operative to control an ontology store for storing ontological representations of a computer resources, metadata associated with said computer resources, information models that invoke computer resources to carry out complex computing tasks, and execution models comprising information associated with execution of an information model. This system further includes a computer resource registry for storing information corresponding to computer resources that are represented in said ontological representations stored in said ontology store and are available and/or suitable for use in connection with said complex computing task.

In this aspect of the invention, the ontology store further stores an ontological representation of at least one transformation ontology.

The computer resource control system is also operative for management of ontologies stored in said ontology store and execution of said information models. The management of ontologies comprises creation, editing, storing, searching, and querying of ontologies stored in said ontology store.

In accordance with this aspect of the invention, the computer resource control system comprises a presentation layer component for handling communications with the system from said external entities; a public service component for processing input data streams and determining if data streams should be directed to an ontology composer component or a service broker component; an ontology composer component for allowing construction of ontological representations of computer resources, metadata associated with computer resources, information models, and execution models; a service broker component for communicating with and monitoring invoked computer resources; a model editor component operative for handling the construction of ontology schemas and/or population of instances of ontology schemas; a search component operative for searching within said resource registry to obtain information about one or more available and/or suitable computer resources; a messaging component operative for communicating messages to and from selected computer resources; and a semantic broker component operative for controlling storage and access to said ontological representations in an ontology store. Various of these components, in various combinations, provide functionality as will be fully disclosed herein.

A system according to this aspect of the invention may include a metadata component operative to control the accessing by the search component as a function of user context and/or application. The metadata component is operative to apply constraints to search results based on user authentication.

As in other aspects of the invention, the ontology schemas may include but are not limited to one or more of the following: computer resource structural ontology, computer resource classification ontology, information model ontology, execution model ontology, and transformation ontology.

The service broker component may comprise a business logic analyzer subcomponent and a service handler subcomponent. The business logic analyzer component is operative for receiving an execution model ontology, deconstructing it into executable segments; and initiating the segments to cause invocation of the corresponding computer resource(s). The business logic analyzer is further operative for sequencing the invocation of computer resources. The business logic analyzer component is coupled to the messaging component for handling invocation of computer resources and receiving information back from the execution of computer resources.

As in other aspects of the invention, a system made in accordance with this aspect of the invention preferably includes an ontology store for storing said ontological representations. The ontological representations are expressed in a description logic. The description logic is selected from the group comprising but not limited to: RDF, DAML, DAML+OIL, XML, WSDL, and other equivalent description logic languages and system.

The semantic broker may comprises an atlas subcomponent and a mark-up subcomponent.

Further the system may include a resource registry for storing information about computer resources that are available and/or suitable for addressing the computing task. The resource registry is preferably UDDI compliant.

The messaging component may include a publisher subcomponent and a listener subcomponent. The messaging component is operatively associated with a message queue that stores messages for transmission to selected computer resources and information received back from invoked computer resources.

This system preferably further includes an interpretation or transformation component operative for applying transformations between parameters associated with selected computer resources. The system may also include an inference component operative for applying inference rules to elements of ontologies.

In accordance with yet another aspect of the invention, we disclose a method of computing to address a predetermined computing requirement involving access to and use of network-accessible computer resources operatively associated with a computer resource control system. The disclosed method comprises steps of receiving a query request from an external entity coupled to the computer resource control system; forming the query request into an RDF search request; communicating the RDF search request to an ontology store, the ontology store storing one or more ontologies in RDF format representing one or more of the following ontologies: computer resource structural ontology, a computer resource classification ontology, a transformation ontology, an information model ontology, and an execution model ontology; conducting a search in accordance with the RDF search request in the ontology store; receiving search results corresponding to execution of the RDF search request; assembling the search results into a format for use by the external entity; and communicating the search results to the external entity.

In this and other of the disclosed methods and systems, the external entity may be a third party computer system coupled to the system via a computer network, or may be an individual computer system user.

The assembling of the search results and the communicating of the search results comprise displaying the search results on a graphical user interface. The displaying of the search results comprises display of a graphical node/arc representation of a stored ontology to the user.

In accordance with still another aspect of the invention, we disclose a method of computing to address a predetermined computing requirement involving access to and use of network-accessible computer resources, comprising the steps of storing informational attributes of the computer resources in a computer resource ontology, and providing a transformation ontology for enabling translation and/or transformation of relationships between specific parameters required by particular computer resources represented in the computer resource ontology. In this aspect of the invention, the computer resource ontology comprises a computer resource structural ontology and/or specific instances thereof associated with particular computer resources. The transformation ontology is utilized to store default parameter information required by a selected computer resources. Transformation ontology is utilized to determine a correspondence between parameters of two different computer resources.

In accordance with yet another aspect of the invention, we disclose a method for facilitating interaction with networked computer resources by different user entities, comprising the steps of providing at least one object-oriented information model for use by a user entity, said information model corresponding to an ontological representation of one or more related computing processes that utilize one or more different computer resources, wherein the different user entities may construct and/or utilize different business models that utilize one or more of the computer resources in common with other user entities; and providing an ontology management component that maintains information about the computer resources in one or more semantic ontologies, the semantic ontologies being accessible to different user entities such that said user entities may utilize its own specific semantic references to the computer resources without constraint to the semantic references of other entities or of the computing resources.

It will by now be appreciated that in accordance of this and other aspects of the invention, the semantic ontologies are selected from the group comprising but not limited to: a computer resource structural ontology for storing informational attributes associated with the computer resources; a computer resource classification ontology for storing supplemental informational attributes associated with the available computer resources; a information model ontology for storing aspects of the predetermined computing requirement; an execution model ontology for storing information related to execution of a particular set and sequence of execution of computer resources; and a transformation ontology for enabling translation and/or transformation of relationships between specific parameters required by particular computer resources.

In accordance with yet another aspect of the invention, we disclose a method for accessing and utilizing one or more of a plurality of network-accessible computer resources for a computing operation of an enterprise. This disclosed method involves providing a semantic representation system for constructing and maintaining one or more semantic ontological models corresponding to information associated with one or more network-accessible computer resources, providing a process modeling system for constructing and maintaining one or more information models associated with the computing operations of the enterprise, said information model comprising information corresponding to a complex computing process that utilizes one or more of the plurality of computer resources represented by aspects of the semantic ontological models; providing a semantic database for storing the information models and the semantic ontological models,; and providing a user interface for accessing and executing one of the stored information models to execute the computing operation.

In accordance with yet another aspect of the invention, we disclose a method of computing to address a predetermined computing requirement utilizing one or more networked computer resources. This aspect of the invention involves storing a plurality of semantic ontologies for describing informational attributes of the computer resources and metadata reflecting supplemental informational attributes of the computer resources, thereby reflecting the form and function of such computer resources; executing a computing process involving access to and utilization of the at least one semantic ontology; and making an inference as to determine relationships between elements of different ones of the plurality of semantic ontologies.

In accordance with this “inferencing” aspect of the invention, the inference is effected through an inference component operatively associated with an ontology management component that effects portions of the method. The inference may be effected through rules stored in association with the inference component. The inference may also be effected through the execution of indexing algorithms against the plurality of ontologies for the purpose of establishing semantic relationships between concepts. Or, the inference may be effected through a transformation ontology maintained as one of the semantic ontologies. This inferencing aspect of the invention may be applied in connection with various other aspects of the invention, as will be understood.

The present invention also encompasses computer-readable medium having computer-executable instructions for performing methods of the present invention, and computer networks that implement the methods of the present invention.

Features of the present invention are disclosed and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a high level overview diagram of systems and methods of a preferred embodiment of the present invention;

FIG. 2 is a high level block diagram of components of a computer resource control system of FIG. 1;

FIG. 3 is a more detailed block diagram of the computer resource control system and other components of FIG. 1;

FIG. 4 is a flow diagram illustrating the communications and relationships of the components of FIGS. 1 and 3;

FIG. 5 is a block diagram of a system and method of the embodiment of FIG. 1;

FIG. 6 is a flow chart illustrating a preferred method of the embodiment of FIG. 1;

FIG. 7 is a high level overview diagram of systems and methods associated with a specific, exemplary embodiment in accordance with FIG. 1;

FIG. 8 is a block diagram illustrating ontology schemas as used in the present invention;

FIG. 9 is a graphical representation of a web service structural ontology corresponding with the example of FIG. 7;

FIG. 10 is an XML representation of the ontology of FIG. 9;

FIG. 11 is a graphical representation of a web service classification ontology corresponding with the example of FIG. 7;

FIG. 12 is an XML representation of the ontology of FIG. 11;

FIGS. 13A and 13B are an XML representation of a first instance of a web service ontology corresponding with the example of FIG. 7;

FIGS. 14A and 14B are an XML representation of a second instance of a web service ontology corresponding with the example of FIG. 7;

FIG. 15 is a graphical representation of an airline reservation business information model ontology for use with the example of FIG. 7;

FIG. 16 is an XML representation of the ontology of FIG. 15;

FIG. 17 is a graphical representation of a car rental reservation business information model ontology for use with the example of FIG. 7;

FIG. 18 is an XML representation of the ontology of FIG. 15;

FIGS. 19A, 19B, 19C, and 19D illustrate various transformation ontologies for use with the example from FIG. 7;

FIG. 20 is a graphical representation of a pre-service-discovery execution model ontology for use with the example from FIG. 7;

FIG. 21 is an XML representation of the ontology of FIG. 20;

FIG. 22 is a graphical representation of a post-service-discovery execution model ontology for use with the example from FIG. 7;

FIG. 23 is an XML representation of the ontology of FIG. 22;

FIG. 24 is a screen shot illustrating an exemplary display of an aspect of the present invention for use with the example from FIG. 7;

FIG. 25 is a screen shot illustrating another exemplary display of an aspect of the present invention for use with the example from FIG. 7;

FIG. 26 is a screen shot illustrating another exemplary display of an aspect of the present invention for use with the example from FIG. 7;

FIG. 27 is a screen shot illustrating another exemplary display of an aspect of the present invention for use with the example from FIG. 7;

FIG. 28 is a screen shot illustrating another exemplary display of an aspect of the present invention for use with the example from FIG. 7;

FIG. 29 is a screen shot illustrating another exemplary display of an aspect of the present invention for use with the example from FIG. 7;

FIG. 30 is a screen shot illustrating another exemplary display of an aspect of the present invention for use with the example from FIG. 7;

FIG. 31 is a screen shot illustrating another exemplary display of an aspect of the present invention for use with the example from FIG. 7;

FIG. 32 is a screen shot illustrating another exemplary display of an aspect of the present invention for use with the example from FIG. 7;

FIG. 33 is a screen shot illustrating another exemplary display of an aspect of the present invention for use with the example from FIG. 7;

FIG. 34 is a screen shot illustrating another exemplary display of an aspect of the present invention for use with the example from FIG. 7;

FIG. 35 is a screen shot illustrating another exemplary display of an aspect of the present invention for use with the example from FIG. 7;

FIG. 36 is a screen shot illustrating another exemplary display of an aspect of the present invention for use with the example from FIG. 7;

FIG. 37 is a screen shot illustrating another exemplary display of an aspect of the present invention for use with the example from FIG. 7;

FIG. 38 is a screen shot illustrating another exemplary display of an aspect of the present invention for use with the example from FIG. 7;

FIG. 39 is a block diagram illustrating inference processes as used in the present invention;

FIG. 40 is a sequence diagram illustrating methods associated with an aspect of the present invention;

FIG. 41 is a sequence diagram illustrating methods associated with another aspect of the present invention;

FIG. 42 is a sequence diagram illustrating methods associated with another aspect of the present invention;

FIG. 43 is a sequence diagram illustrating methods associated with another aspect of the present invention;

FIG. 44 is a sequence diagram illustrating methods associated with another aspect of the present invention;

FIG. 45 is a sequence diagram illustrating methods associated with another aspect of the present invention; and

FIG. 46 is a sequence diagram illustrating methods associated with another aspect of the present invention.

### DETAILED DESCRIPTION OF PREFERRED EMBODIMENTS

As will be explained hereinafter, the present invention provides aspects of various systems and methods for modeling and using computer resources over a distributed network using semantic ontological models. Before turning to the figures and the detailed description of the present invention, however, it may be helpful to explain what is meant by some of the terminology used in the previous sentence.

At its simplest, the term “ontology” is used to describe listings of synonyms, such as in a thesaurus. In information science, an ontology means a hierarchical structuring (e.g., a tree-structured index of terms) of knowledge about things by categorizing and subcategorizing them according to their essential (or at least relevant) qualities. In the realm of artificial intelligence, an ontology is an explicit, formal specification of how to represent objects, concepts, and other entities and the relationships that hold among them. These specifications may or may not be hierarchically structured. The artificial intelligence definition of ontology provides the closest definition for purposes of understanding the present invention.

As used herein, “ontology” or “ontological model” is used to describe conceptual models that describe concepts and their relationships. These models rely upon a logical framework (i.e., “formalism” or “description logic”) that describes how these concepts and their relationships can be represented. Specifically, this logical framework represents information about individuals/objects, classes of individuals/objects, and their description based on structural or object-oriented constructs and specific “instances” of such constructs. This logical framework enables facts to be asserted about concepts (e.g., “Today is Monday”), enables properties to be associated with concepts (e.g., “Date has month/day/year”), enables rules to apply to concepts (e.g., “Departure Date must be before Return Date”), and enables queries to be run (e.g., “Provide Travel Itinerary”). The logical framework also enables relationships to be defined among concepts, for example by using constructors for concept expressions, such as “unions,” “negations,” number restrictions,” or “inverses.”

“Semantics” is a word that merely means “of or relating to the meaning of language.” When used in the context of semantic ontologies or semantic ontological models, this term refers to the interpretation of ontologies and the use of inferences that can be drawn from particular ontologies and ontological models.

Advantageously, in the preferred embodiments of the present invention, XML is used for describing information based on a defined set of structures for describing data. However, XML has limited use in defining complex structures necessary for capturing definitional semantics. When defining an object, such as asserting meta-data (i.e., data or information about other data) about a particular object, complex structures are required to provide a consistent way of articulating meaning. Without these structures XML, by itself, cannot provide a means for drawing simple inferences about information. For example, the following two statements may be rendered satisfactorily in XML: (1) “A dog is a type of animal” and (2) “Fido is a dog.” However, XML has no way of “inferring” that “Fido is an animal.”

For this reason, the present invention advantageously uses DARPA Agent Markup Language (DAML) and Resource Description Framework Schema (RDFs), which build on existing data definition standards like XML. RDFs assert certain structures in XML such as the construct of classes of objects and object properties. DAML further extends RDFs and the XML standard by providing additional descriptive structures in the form of a description logic that is capable of making the above inference. DAML provides the logical framework within XML structures for creating ontological models that are rendered and manipulated in the present invention. A further advantage of DAML, which is not permitted within an XML-linear-only environment, is its ability to describe concepts for varying and even non-overlapping contexts (e.g., “jaguar” can be defined to be a type of car as well as a type of animal, depending upon its context) in complex non-linear relationships. DAML is defined not as a tree hierarchy like XML but as a “directed graph” consisting of nodes and arcs. This structure, consisting of node/arc relationships, can be broken into base structures of nodes and arcs in the form of “node”:“arc”:“node,” which are commonly described as “triples” in RDFs (or “RDF triples”). Ontologies in the present invention are comprised of pluralities of RDF triplets. Each RDF triplet is used to relate two concepts (a “subject” and an “object”) through a predicate. For example, “Jaguar is car” is an example of a triplet in which “Jaguar” is the subject, “car” is the object, and “is” is the predicate.

Although preferred embodiments and specific examples of the present invention will be described in the context and framework of DAML+OIL, which is the name of the most-current version of DAML and which is an accepted and approved open standard for description logic based XML, it should be understood that the systems and methodologies of the present invention are applicable within the context of any description logic framework now used or hereinafter developed. Thus, the present invention should not be limited to or construed to be limited merely to XML, DAML, or DAML+OIL applications.

System Overview

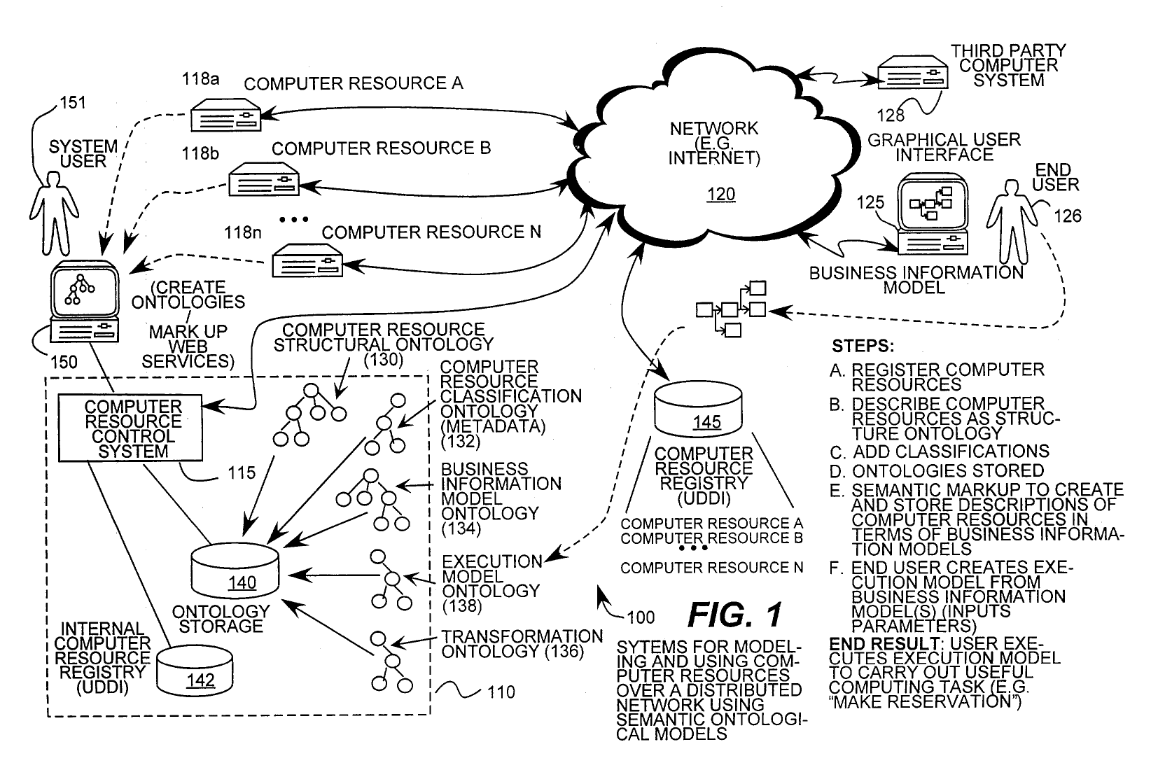

Turning first to FIG. 1, a preferred environment 100 for the systems and methods of the present invention is illustrated. A primary element of the present invention is a computer resources management system 110, which includes a number of components and carries out a number of steps, as will be described in detail hereinafter. Specifically, the computer resources management system 110 includes a computer resource control system 115, an ontology storage 140, and an internal computer resources registry 142. The computer resources management system 110 is coupled to a network 120, such as the Internet or other distributed area network, for communications with a number of computer resources 118a, 118b, . . . 118n, which are also coupled to the network 120.

These computer resources 118 are all network-accessible computers or computer systems that provide a specific computing task or function, when provided with specific parameters or instructions, and return particular data in response to being provided such stimuli. Computer resources include, for example, computer applications, databases, directory services for users and groups of users (e.g., LDAP), file systems, digital media repositories, content repositories, enterprise resource registries, application interfaces, productivity applications such as spreadsheets or word processing applications, network and system management systems, and web-accessible services, such as web services. For purposes of the remaining discussion hereinafter, we will assume that the computer resources 118 are web services, that is, a network or Internet-accessible programmatic interface that is presented in a non-proprietary format.

A system user computer system 150 is coupled to the computer resources management system 110 to enable a system user 151 to access the computer resource control system 115. An end user's computer system 125 is also coupled to the network 120, which allows an end-user 126, working with a graphical user interface on the end user's computer system 125, to access the disclosed computer resources management system 110. A third party computer system 128 is also shown coupled to the network 120, which enables the computer system 128 to access the disclosed computer resources management system 110 as well.

The various aspects of the present invention described herein use ontologies, as described elsewhere herein, to represent and store various descriptive models that can be used to define a computer resource 118. These descriptive models consist of concepts, concept properties, and relationships. The models are used to describe the structure of specific computer resources 118, including their use, invocation requirements, their security and access rights, and any preconditions or post condition requirements that are related to the specific computer resource, inputs or stimuli or parameters that are required to access and invoke a particular computer resource, and the interfaces between resources that allow computing tasks to be coupled together in sequences to carry out complex computing needs. In order to describe and define computer resources, broader and more abstract models are necessary. For instance, a computer resource could be defined in terms of a particular business process or technical process. For example, the structure of a “Jaguar” can be described as consisting of “four legs” and “eyes”. Its environment can also be described as “lives in Asia.” However, the broadest and most complete definition of a Jaguar is “a large cat (Panthera onca syn. Felis onca) chiefly of Central and South America that is larger and stockier than the leopard and is brownish yellow or buff with black spots,” which requires use of broader and more abstract constructs such as “cat,” “Central America,” “South America,” “leopard,” and “spots.”

These models enable end-users 126 and automated systems 128 to “discover” computer resources that may be able to address and carry out a specific computing task based on specific criteria. In accordance with the present invention, several different types of ontologies are provided so as to enable computer resources to be registered, discovered, accessed, invoked, and executed.

Firstly, a computer resource structural ontology 130 is provided to represent the structure of the computer resource. Specifically, the structural ontology is used to describe common structural elements that comprise a web service, such as “operation” or “input.” A computer resource classification ontology 132 is provided to represent additional information or “meta data” describing various additional aspects of a respective computer resource or computer service that are not represented in the computer resource structural ontology 130 but that are used to classify or characterize the respective computer resource 118. A business information model ontology 134 defines business or more abstract technical concepts that are used to define further the computer resource according to specific computing needs desired by users (system or end users) of the present invention. An execution model ontology 138 is provided to represent concepts related to invocation and execution of a particular set and sequence of computer resources. Finally, a transformation ontology 136 is provided to enable the translation or transformation of relationships between certain specific parameters between computer resources, as defined within a specific execution model ontology. For example, one particular concept used in the discussion examples below includes the notion of a “date” as a parameter needed in a computing task of the automatic on-line reservation of an airplane ticket. In one airline reservation web service, the date is represented as a parameter entitled DepartureDate. In another computer resource, such as an enterprise's internal travel coordination system, a similar date is represented as DateofDeparture. Conceptually, these relate to similar ideas that just happen to be represented differently within the different computer systems. A transformation ontology 136 provides a mechanism to relate these different parameter formats within the context of execution of a specific execution model.

The various ontologies (computer resource structural ontology 130, computer resources classification ontology 132, business information model ontology 134, execution model ontology 138, and transformation ontology 136) are stored in the ontology storage system 140 (or “ontology store”) that is coupled to and associated with the computer resource control system 115. These various ontologies are accessed, manipulated and utilized as described herein. It should also be understood at this juncture that each of the various ontologies are provided in conceptual form as a “schema,” which as known to those skilled in the art represents the basic structure of the information represented in the ontology. The ontologies also include specific instances of a given schema wherein specific information arranged according to the predetermined format of the schema is generated and stored in the ontology storage 140. In object-oriented parlance, a particular schema is said to be “instantiated” when the schema is populated with specific information arranged in the format of the schema. It is the specific instantiations or instances of the schema that represent actual information within the system. As will be appreciated by one skilled in the art, because schemas are based on description logic, instances are so organized and inference, as described hereinafter, is made possible.

The internal computer resources registry 142 is also provided within the disclosed system 110 for registering, indexing, and storing information associated with various computer resources 118, to reflect their availability for incorporation into an instance of an execution model ontology and to carry out computing tasks.

With regard to the ontology storage 140 and the resource registry 142, it should be understood that each such data storage may comprise one or more physical data storages co-located at a single location or located across a distributed network, as will be appreciated by one skilled in the art.

The system user 151, in coordination with the system user computer 150 and the computer resource control system 115, is primarily responsible for constructing ontologies, creating instances of various ontologies, running instances of execution model ontologies (or “execution models”) for tests and other purposes, and registering resources within the internal computer resources registry 142, as will be described in greater detail hereinafter. Briefly summarized, the system user 151 carries out the principal and general tasks of (i) conducting searches to locate various computer resources that may be accessible and available to be used within the system 110, (ii) registering the computer resources within the internal computer registry 142, (iii) “marking up” the computer resources to reflect their capabilities, constraints, and conceptual relationships in an appropriate mark up language, such as DAML+OIL, to thereby create ontologies and instances of ontologies, (iv) storing such created ontologies and instances thereof in the ontology storage 140, (v) creating business information models and storing them also within the ontology storage 140, and (vi) test-executing or, in the appropriate case, executing of their own accord, particular execution models, so as to carry out specific computing tasks. It should be understood that some execution models may be complex computer-driven business models that access a number of different computing resources so as to complete complex computing tasks that may or may not be sequential to one another and may or may not be dependent upon results from a previous computing task(s). After the following discussion, those skilled in the art will understand that the aspects of the present invention's systems and methods enable construction of such complex computing tasks.

End-users 126 access the system 110 (i) in some cases, to define and classify computer resources in a manner similar to that done by system users 151 but also to define the computer resource in terms of certain business or abstract technical concepts using one or more business information model ontologies 134, (ii) to create execution models, (iii) to search for and locate appropriate pre-stored execution models, and (iv) to invoke or execute such execution models by invoking them and providing appropriate input parameters, as required by the various business information models and underlying computer resources, so as to carry out the intended computing tasks.

It should be understood that the independently-operating or pre-programmed third party computer system 128 may also be operative to invoke and execute execution models automatically, such as at pre-programmed times, or in response to particular input stimuli that causes such independently-operating computer system to run a program to access the disclosed computer resources management system 110. Thus, although the discussion in the examples which follow is primarily in the context of an end-user person 126, it should be understood that the examples apply equally regardless of whether web services are being discovered and invoked or executed at the initiation of the end-user's computer system 125 or an automated third party computer system 128.

Finally, still referring to FIG. 1, in many implementations of the present invention, an external computer resources registry 145 may also be provided or may previously exist. An external computer resources registry 145 also stores information corresponding to various computer resources 118 that are available for accessing via the network 120 and for use within more complex computing tasks. As will be known to those skilled in the art, a number of organizations are endeavoring to provide publicly-accessible computer resource registration services so as to enable searchability of and access to various computer resources. One example of such an external registry is a UDDI (Universal Description, Discovery, and Integration) compliant directory that, like a typical yellow pages directory, provides a database of businesses and computing resources searchable by the type of business or resource. Other information about the UDDI standard format for resources registration is available in publicly accessible literature. Preferably, the internal resources registry 142 of the system 110 is also UDDI-compliant.

For example, and as described in greater detail below, an end-user 126 may desire to invoke a computer-based travel web service so as to locate the availability of airline flights, car rental, hotels, and the like automatically to make reservations, perhaps using selected default or preferred values (e.g. of a favorite airline or seating arrangements), and, in general, to make arrangements for a business trip. Using the systems and methods as described herein, a complex travel execution model may be constructed to describe the desired process of making a travel reservation in a particular business context or process. Various computer resources made publicly available by airlines, car rental services, hotels, and the like may be registered, defined, and classified based on a variety of business information models. These computer resources may subsequently be identified and incorporated into complex execution models, and ultimately executed with the provision of specific parameters (such as departure and return dates, preferred seating arrangements, accommodations, and the like). Further features and advantages of the operation of the present invention will become apparent to the reader as further details are described in connection with later figures.

System Architectural Details

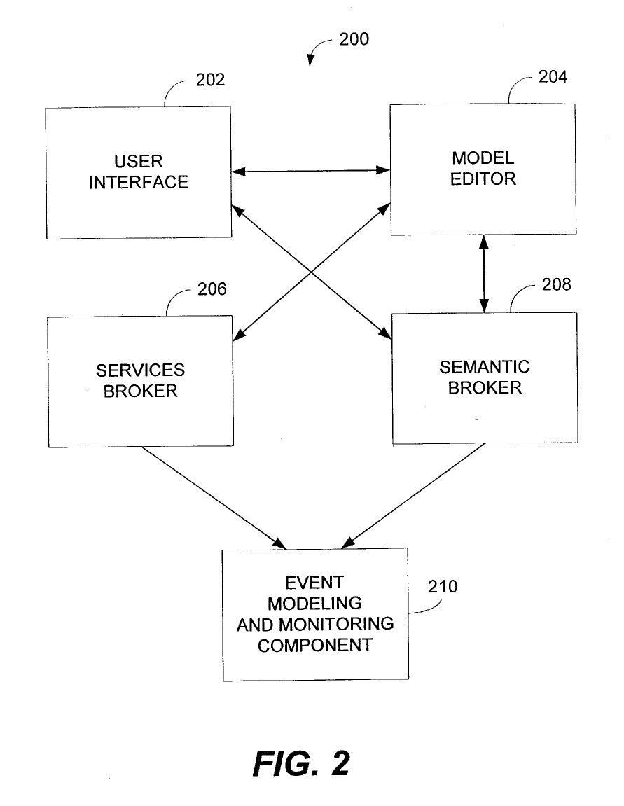

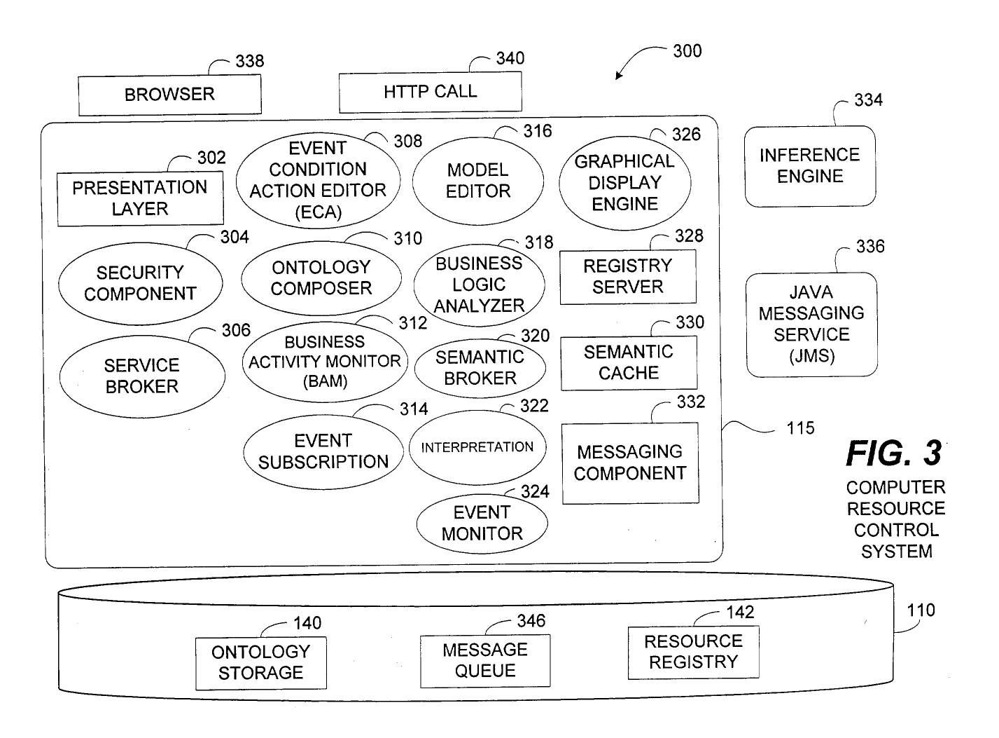

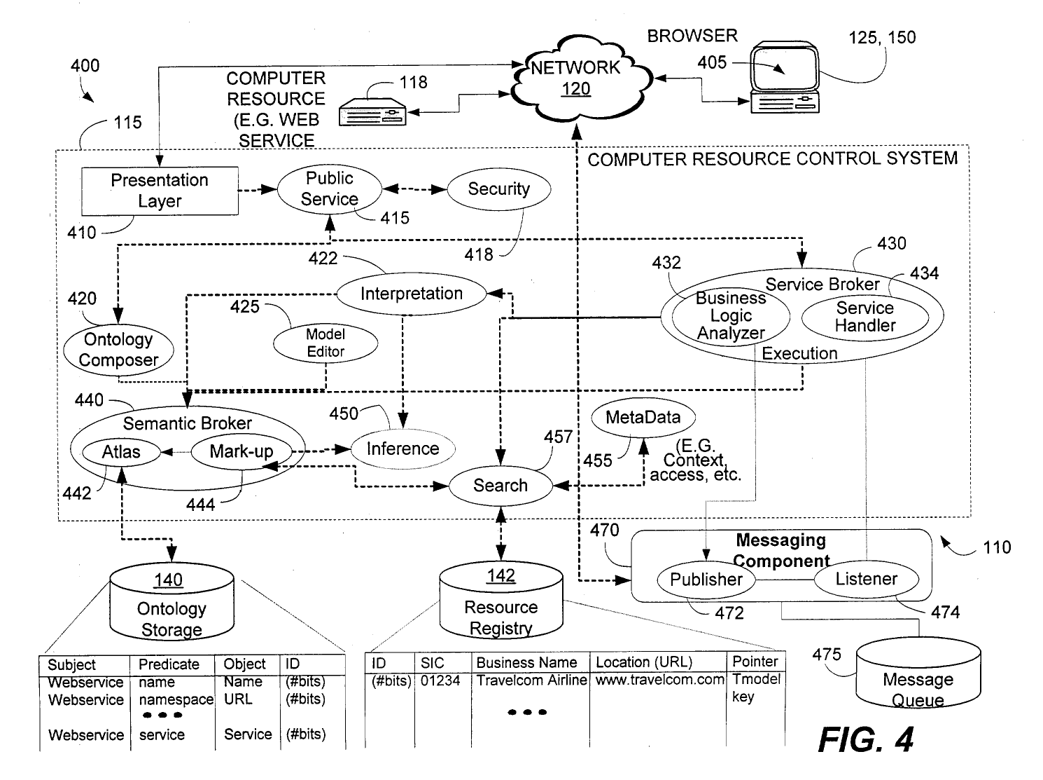

Turning now to FIG. 2, a high-level block diagram 200 illustrating five primary systems of an exemplary computer resources control system 115 (from FIG. 1) is illustrated. Each of the five modules is comprised of multiple subsystems, which are described in greater detail in FIGS. 3 and 4 hereinafter. The five primary modules include a user interface 202, a model editor 204, a web services broker 206, a semantic broker 208, and an event modeling and monitoring component 210.

The user interface 202 handles all interaction between the system user 151, end user 126, or third party computer system 128, and the computer resources management system 110. The user interface 202 includes subsystems for security, user authentication, and a graphical user interface. The user interface 202 determines the format and the content to be presented external to the computer resources management system 110 and interprets inputs that are presented to the computer resources management system 110. Content presented may be determined by, among other criteria, the access rights of the user accessing the system or the access rights of the organization with which the user is associated.

The model editor 204 allows for the registration and creation of ontology schemas, and the population of instances in the various ontologies—thereby forming descriptive models. The model editor 204 provides a graphical user interface for creation of such ontologies and ontology instances. For example, execution models consisting of populated instances of the model execution ontology may describe web service programs, scripts, or routines to be executed and the underlying conditions and logic describing the execution flow. Such models may also be configured to enable the execution of a single web service or the execution of multiple web services, invoked sequentially or otherwise, to perform complicated tasks. In addition, series of event-condition-action (or “rules) statements may be modeled to invoke, conditionally, various web services. Thus, execution models define calls to or invocations of web services in a manner similar to the way conventional computer programs use calls to functions and subroutines.

The web services broker 206 communicates with and monitors web services invoked by the business information models. The services broker 206 initiates the calls to the web services, monitors the status of the initiated web services, and receives data back from the web services.

The semantic broker 208 manages an ontology database (e.g. the ontology stotrage 140) that provides the index and the classification of specific computer resources, such as web services, their functions, data structures, and use—based on ontological representations. The semantic broker 208 is used to build an ontology by adding concepts and defining relationships between those concepts in order to describe computer resources. Finally, the semantic broker 208 allows a user or systems to search for desired computer resources.

The event modeling and monitoring component 210 manages the creation of rules related to computer resource events. The component 210 monitors events for the purposes of invoking rules related to ontology searches, computer resource discovery, and computer resource execution.

Turning now to FIG. 3, a detailed view 300, in block diagram format, of the various subsystems of a first aspect of the exemplary computer resources management system 110 is illustrated. Each function block in FIG. 3 represents portion, modules, and components of the first aspect of the overall computer resources management system 110 from FIG. 1. Those skilled in the art will appreciate that various aspects of the present invention operate using a subset of the function blocks. Each function block will be described separately and then some of the interactions of the blocks in implementing the various aspects of the present invention will be discussed.

The presentation layer 302 is a conventional subsystem that provides the primary interface between the computer resource management system 110 and external systems (not shown in FIG. 3). The presentation layer 302 interacts with a user interface to receive commands and instructions and to provide results. The presentation layer 302 operates, for example, to generate HTML code, graphic images, and text, to arrange data into a format suitable for the intended recipient, to receive commands, and to display messages. In an alternative embodiment, the presentation layer 302 may be replaced by a third-party user interface solution, may be eliminated if the system is not intended to interface with a user, or may be customized to interface to specific browsers or systems in conventional manner.

The security component or security marshal 304 provides security services for the computer resource management system 110. The security marshal 304 authenticates users of the system and insures, for example, that only approved users and systems have access to the computer resource management system 110. A simple example of a service provided by the security marshal 304 is user authentication/verification by means of userID and password.

The event modeling and monitoring component 225 (from FIG. 2) includes the following components identified in FIG. 3, namely, a rules or event editor 308, a business activity monitor 312, an event subscription manager 314, an event monitor 324, and an inference engine 334.

The event editor 308 is a tool by which the user is able to establish the rules or conditions associated with the execution of an execution model, including the search and discovery of computer resources that meet or satisfy the particular rules or conditions specified by the user. The event editor 308 is also used to establish the rules that describe conditional flow between computer resources. This occurs by creating an event-condition-action (ECA) script that includes one or more ECA statements. An ECA statement initiates, for example, a web service or action upon the happening of a predetermined event. As one specific example, the following ECA script conducts a stock purchase when a given condition exists. This example contains two separate statements, as shown:

Statement 1

Event=periodic

Condition=every 10 minutes

Action=poll stock web service “Alpha” to get current value of stock A

Statement 2

Event=stock A value

Condition=<$50

Action=invoke web service “Beta” to purchase shares of stock A

Thus, in this simplified example, the ECA script interacts first with a stock ticker web service, Alpha. The stock ticker web service, Alpha, returns the price of the requested stock when given the relevant and appropriate input. The ECA script then communicates with a second web service, Beta, to purchase shares of the same stock when the stock ticker web service, Alpha, returns a price below a predetermined level.

Additionally, the event editor 308 is configurable to perform other functions other than discovery of computer resources. For example, the ECA script can be configured to initiate an email, a page, a screen display, or other action upon the occurrence of the predetermined event. Further, the event editor 308 allows direct entry of ECA commands from a user or the system. Directly entered commands may be used, for example, to invoke individual computer resources, or they may be used in succession to emulate the operation of a predefined script without loading the script into the event editor 308.

The business activity monitor (“BAM”) component 312 monitors the status of the computer resources based on the above-described ECA scripts. It consists of and/or communicates with several other components: the event subscription manager 314, the event monitor 324, and a message queue 346. The BAM component 312 monitors, for example, active functions to determine when the function ends or returns data, monitors the results of computer resource calls, monitors the computer resources called by other computer resources, and performs other monitoring activities associated with computer resources.

The event subscription manager 314 is a subsystem of the BAM component 312 and serves as a “listener” for specific events associated with specific ECA scripts associated with computer resources. The event subscription manager 314 manages the subscriptions to specific business activities. The event subscription manager 314 identifies the specific events that should be monitored, creates the monitoring function, and insures that the monitoring function is operating. The event subscription manager 314 works closely with the event monitor 324, which will now be described in greater detail.

The event monitor 324 is another subsystem of the BAM component 312 and is used to monitor active computer resources in conjunction with a service broker 306, the event subscription manager 314, and the message queue 346. In particular, the service broker 306 (discussed in greater detail hereinafter) invokes a computer resource, which creates an event that is deposited in the message queue 346. The event monitor 324 monitors the message queue 346 for subscribed events. If a subscribed event occurs, then the event monitor 324 invokes the appropriate computer resource or initiates another action. The event monitor 324 then monitors the computer resource and waits for a response from the computer resource. If the computer resource fails to respond, the event monitor 324 takes an action, such as instructing the event subscription manager 314 to issue another call to the computer resource, query the computer resource for its status, or any other action capable of assessing the status of the initiated computer resource.

The inference engine 334 is used to execute rules and conditions defined in ontological models. The inference engine 334 groups concepts having related terms or related links. The ontological model then returns these related concepts when a query is run, as will be described in greater detail subsequently. Generally, the inference engine 334 uses user-defined linking terms to associate related concepts.

The graphical display engine 326 manages the display of ontologies and instances of ontologies in a graphical interface, which provides users with the ability to create, edit, update, and delete ontological models graphically. The interface also supports search, selection, and display of ontological concepts and models, as will be explained in greater detail hereinafter. The graphical display engine 326 also manages the graphical modeling of execution models by identifying and configuring concepts defined in business information models. Therefore, as the user manipulates the concepts and business information models, an actual instance of model execution ontology, having sequence, flows, parameters, rules, and restrictions, is created graphically by the user in the graphical interface and, preferably, is constructed in XML automatically by the system 110. Thus, non-technical users are able to create execution model ontologies without having to know how to write computer code or how to populate ontology instances in the form of DAML+OIL, for example, or XML.

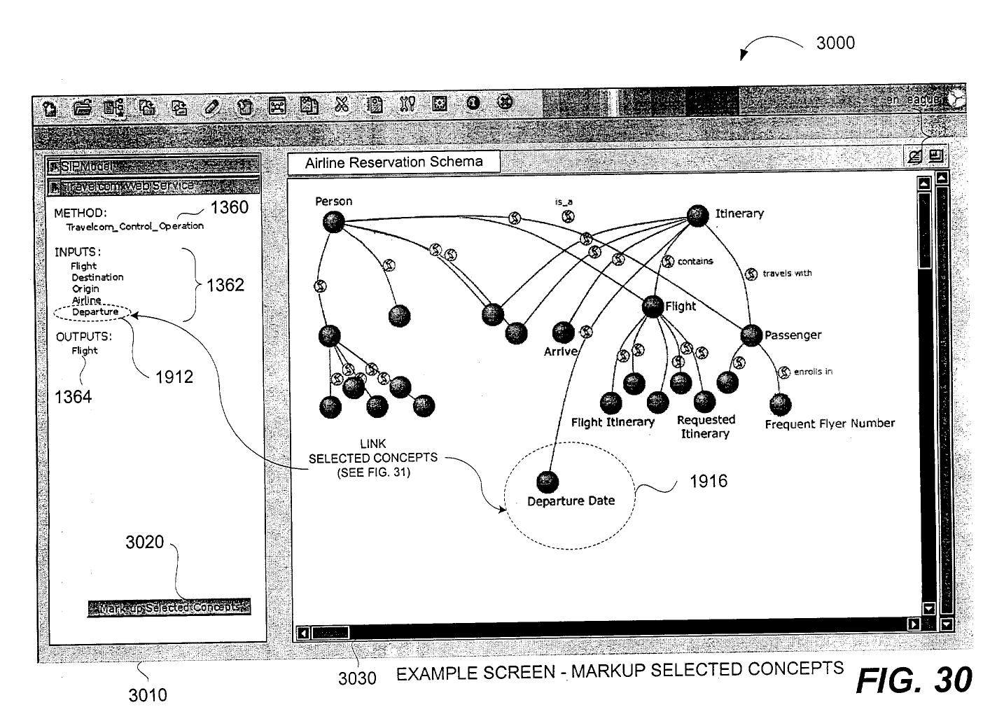

In an exemplary embodiment, the graphical display engine 326 provides the user with a pictorial representation of ontologies. This pictorial representation of the ontology is displayed as a directed graph, similar to that shown in FIG. 30, as described herein. Such a representation appears as a three-dimensional web of objects. When the results of a query are displayed using the graphical display engine, the ontology is preferably shown centered on the most relevant objects. The user is then permitted to explore the ontology by following the links between related objects starting with the most relevant object.

A model editor 316 is a specific instance of the graphical display generated by the graphical display engine 326, which is used to create execution models and to direct the flow between computer resources. Typically, the model editor 316 is used to enable the sequential invocation of computer resources so that they work in conjunction with one another. For example, web services may be linked for the sequential performance of an interrelated task. The model editor 316 operates closely with the event editor 308 to allow the creation of complicated execution models.

The service broker 306 performs a variety of tasks that enable computer resources to be accessible for discovery and invocation by users of the computer resource management system 110. The service broker 306 enables the registration, storage, access to (i.e., “publishing”), and invocation of computer resources. Additionally, the service broker 306 provides functional security. Functional security prevents unauthorized access to information or functions of the system 110. The security function of the service broker 306 differs from that of the security component 304 in that the security component 304 prevents unauthorized users or entities from accessing the system 110 while the service broker 306 prevents authorized users or applications from obtaining information outside the scope of their permitted authorization. For example, a first company may have a first set of web services that is permissibly available to the public and a second set of web services that is permissibly available only to users associated with the first company. The service broker 306 ensures that only permitted users associated with the first company have access to the second set of web services. The service broker 306 also manages invocation of computer resources, including the detection of and management of invocation errors or failures.

A business logic analyzer 318 is a sub-component of the service broker 306 that manages the sequential execution of services. The business logic analyzer 318 manages calls to various computer resources and manages the invocation of execution models. The business logic analyzer 318 utilizes a publish and subscribe messaging component 332, such as the Java Messaging Service (JMS) 336. Those skilled in the art are familiar with such messaging hubs. The message queue 346 is a storage device for storing messages prior to processing. Those skilled in the art are familiar with message queuing.

A registry server 328 serves a specific interface implementation of the resource registry 142 and consists of a registry of computer resources and their classification. The registry server 328 may be a proprietary software package or an open source UDDI server. For example, the registry server 328 may be a Cape Clear server, a pUDDIng Server, an IBM UDD14J server, or any other UDDI-compliant server. The registry server 328 allows computer resources to be registered. As part of the registration process, identifying information about the computer resource, its properties, and functions required for invocation are identified and classified.

The resource registry 142 is the physical data store for the registry of computer resources and provides an index and description of computer resource for easy description and discovery. Management of the UDDI tables occurs through a registry server 328. The resource registry is discussed in greater detail with reference to FIG. 4 hereinafter.

Still referring to FIG. 3, an ontology management system typically includes, but is not limited to, the following components: a semantic broker 320, an interpretation component 322, a semantic cache 330, and an ontology composer module 420. The semantic broker 320 includes functionality for (i) creating, editing, updating and deleting ontologies and concepts, (ii) creating models of computer resources through population of structural ontologies based on computer resource characteristics, and (iii) registering, storing and accessing ontologies. The semantic cache 330 is used to increase the efficiency of ontology queries. Any conventional cache capable of caching XML object query results may be used with the present invention. Those skilled in the art are familiar with the use of a cache. The ontology store 140 is a memory device for storing an ontology.

The interpretation component 322 transforms ontological execution models into queries that are understandable to the computer resource being invoked by the execution model (i.e., the execution model is “transformed” into the native query language of the receiving computer resource). For example, the interpretation component 322 creates a “post-discovery” version of an execution model after the system has determined which computer resource or web service is actually going to be invoked by the execution model. The interpretation component is also capable of creating a translation of parameters between two different web services and of translating queries into the native query format of a specific data store.

The ontology composer 310 manages the display of and the logic for defining how ontologies and instances of ontologies associated with a computer resource should be displayed to the user. When the model editor 316 creates business information models, which consist of a sequence of functions, and the event editor 308 establishes the conditions for the sequence, the service broker 306 manages the invocation of those resources. As various resource functions and operations are executed during the invocation, values are returned. When those values are displayed to the user through the presentation layer 302, the ontology composer 310 is activated for use with the computer resource. The ontology composer 310 handles the passing of user-defined functions, such as invoke commands or input parameters, for the actual computer resource. Additionally, the ontology composer 310 determines what content a particular user or entity sees. If, for example, the user is an employee of company A, the ontology composer 310 displays content specifically designed for users from company A. Also, if a specific content arrangement for a display is desired, the ontology composer 310 deploys the appropriate display information to the user interface.

The browser 338 is used with the HTTP call 340 in conventional manner to access the system from an Internet connection. Any conventional or proprietary Internet browser may be used.

Turning now to FIG. 4, a detailed view 400, in block diagram format, of the various subsystems of a second, preferred aspect of the exemplary computer resources management system 110 from FIG. 1 is illustrated. Each function block in FIG. 4 represents portion, modules, and components of the second aspect of the overall computer resources management system 110. FIG. 4 further includes communication flow lines between the various components illustrated. It should be further understood that the components/modules illustrated in FIG. 4 are implemented as computer program software modules or routines that execute on a computer system that is provided for carrying out the tasks of the computer resource management system 110 as described herein. Those skilled in the art will understand that the preferred method for carrying out many, if not all, of the functional tasks provided for in the disclosed system may be implemented as computer software running in a network environment with a physical architecture of multiple computer processors configured to operate with a conventional computer operating system, and may be deployed on a J2EE-compliant application server, such as IBM Websphere, BEA Weblogic, or the opensource JBOSS. The application server environment provides general transaction management including failover, load balancing, and error handling. Unless stated otherwise, components identified in FIG. 4, which have the same name (but different reference numerals) as components previously identified in FIGS. 1, 2, or 3, are intended to have the same or similar characteristics to the comparable components in such previous FIGS.

As stated previously, most functional access to the computer resource management system 110 occurs externally through an end-user computer system 125 or a system user computer system 150, which runs a conventional Internet browser, such as Internet Explorer or Netscape or the like. Those skilled in the art will understand and appreciate that browser software 405 is operative to receive user commands through the user computer 125, 150 and to translate those into HTTP commands, and to display the results received from network computers through a display screen associated with the computers. The browser software 405 is shown functionally coupled to the network 120, and then to the computer resource control system 115, which is likewise connected to the network 120.

Within the computer resource control system 115, a presentation layer component or module 410 handles the presentation of information (typically in HTML format) back to the browser 405 and receives HTTP commands and provides them to other related software components. The presentation layer 410 is a framework for insuring a decoupling of presentation from business logic. Those skilled in the art will understand and appreciate that an example of such a presentation layer includes Model-Controller-View (MVC)-based architectures, such as the Struts Framework. The presentation layer 410 is shown coupled to a public service module 415. The public service module 415 is the external web services interface to the computer resource management system 110. The public service module 415 analyzes input data streams and determines if the data streams should be directed to an ontology composer module 420 or to an execution module 430, such as the service broker. A security module 418 handles access and authentication rights and controls for users. The security module 418 has access to certain other software modules and determines what level of access certain users may have to system 110 or to specific ontologies or business models. Further details of the security module 304 are beyond the scope of the present discussion, as those skilled in the art will understand how to implement security protections.

The two principle functions carried out by the computer resource control system 115 is that of ontology management and model execution. The remaining components or modules, working together and described hereinafter, are used to carry out these two principle functions. For example, the ontology management function provides for the construction of ontologies and instances of ontologies, the storage of constructed ontologies, and searching for applicable ontologies for editing and storage. Similarly, the ontology management function also handles storage and indexing of information about various ontologies and computer resources in the resource registry 142. The ontology management function also provides for the semantic mark-up of ontologies to create associations between the ontological representations of computer resources with available business information ontologies, as will be discussed in greater detail hereinafter. The model execution function, on the other hand, primarily provides for executing pre-constructed execution models, conducting searches (i.e., “discovery”) to locate applicable ontologies and instances thereof to identify the “best” computer resource for satisfying the execution model based on criteria selected by the respective user, and controlling the operation of a messaging function, described in greater detail below, which handles the communication (outputs and inputs) between the system 110 and relevant external computer resources 118.

More specifically, the ontology management function enables the display of ontologies through the ontology composer module 420 based on interactions with the semantic broker module 440 and the creation of execution models through use of the model editor module 425. In this process, two sub-components of the semantic broker 440 are utilized: an atlas module 442 and a mark-up module 444.

The ontology composer module 420 enables the display of the ontologies and the creation of ontology schemas and instances of ontologies. The ontology composer module 420 makes calls to the atlas module 442, which handles the functions for storing the various ontologies in the ontology store 140 and retrieving them upon command for editing and/or execution when needed by other components or modules of the system 110. In particular, the atlas module 442 finds and returns ontologies and ontological concepts based on particular context metadata returned by a metadata module 455. The mark-up component 444 provides a common interface to the profiles of computer resources. The mark-up component 444 operates according to the following flow: (i) web services descriptions are extracted, parsed, and a web service structural ontology instance (discussed in greater detail hereinafter) is populated; (ii) users create metadata descriptions of computer resources through a mark-up or “mapping” process; (iii) these metadata descriptions are written to an ontology instance in a web service classification ontology (also discussed in greater detail hereinafter) in the ontology store 140; (iv) the mark-up component 444 extracts context from the metadata module 455 and populates the ontology instance with context information associated with the relevant web service; (v) the mark-up component 444 passes the “final” ontological model for the web service to the atlas module 442 for storage in the ontology store 140; and (vi) the mark-up component 444 queries the atlas module 442 to return descriptions of computer resources, such as web service security parameters, web service methods, applicable inputs and outputs for a web service, and access control information for a web service. The mark-up module 444 also communicates with the search module 457 to locate computer resources stored in the resource registry 142 and to allow such computer resources to be described in the appropriate DAML/XML format and to be stored in the ontology store 140.

The model editor module 425 handles the construction of execution models through creation of ontology schemas or population of ontology instances. A system user 151 is able to manipulate these models and to construct or change them as appropriate. The model editor module 425 is functionally coupled with the semantic broker 440.

The model execution function of the system 110 is primarily handled by the execution component 430 (also known as the service broker), which includes two subcomponents: a business logic analyzer module 432 and a service handler module 434. The model execution function of the system 110 also includes the search module 457, which manages searches of the resource registry 142 for purposes of service discovery based on context information maintained by the meta-data module 455. The business logic analyzer module 432 is primarily responsible for handling the methods and “outputs” from the system (“input” to the relevant computer resource) required by appropriate execution model ontologies. Translation of parameters between services is handled by the interpretation module 422 as described elsewhere herein. The service handler module 434 is primarily responsible for receiving “inputs” to the system (“outputs” from the relevant computer resource) anticipated by the execution of the appropriate execution model ontologies.

The business logic analyzer module 432 receives execution model ontologies, deconstructs them into discrete and logical segments, and is responsible for initiating the invocation of the appropriate computer resource(s) to satisfy the execution ontologies. If more than one computer resource needs to be invoked, the business logic analyzer 432 is responsible for sequencing or ordering such invocations and, when necessary, waiting for an appropriate response from a first computer resource before invoking a subsequent computer resource. The business logic analyzer module 432 is coupled to the messaging component 470, and in particular to the publisher subcomponent 472, which is responsible for generating messages for transmission to the specified computer resource. Messages are stored in a message queue 475 for conventional handling by the messaging component 470.

Conversely, the service handler module 434 is also coupled to the messaging component 470 and in particular to the listener subcomponent 474, for purposes of detecting and receiving responses from the relevant computer resource 118.

As previously mentioned, the search module 457 is coupled to the metadata module 455 and to the resource registry 142. The search component 457 is operative to receive search queries provided from various modules, such as the mark-up module 444, the interpretation module 422, and the execution module 430. The search module 457 retrieves information from the resource registry 142 corresponding to the search terms so that such information corresponding to a selected computer resource stored therein may be marked up or utilized as applicable.

The metadata component 455 intentionally limits the functionality of the search component 457 by controlling access to the search module 457 or filtering results returned by the search module 457, as a function of the context of the user or application (e.g. only providing search results for what the user or application is interested or permitted to see).

Also shown in FIG. 4 is a simplified data structure for the ontology store 140 and for the resource registry 142. Generally speaking, the data structure of the ontology store 140 is preferably that of the known Resource Description Framework Schema (RDFs) as described above. As known to those skilled in the art, the RDFs format is an RDF triple, which comprises a resource (i.e., the “subject”) that is linked to another resource (i.e., the “object”) through a description of the relationship between the two (i.e., the “predicate”). Graphically, RDF triples can be represented as two nodes (the subject and the object), which are represented in further diagrams below as ovals or circular elements, with an arc or line (the predicate) providing the connection between the two. The RDFs identify each element in the triple with a Uniform Resource Identifier (URI) that constitutes a unique namespace. Thus, each concept has a unique identifier, which is typically defined within some file hierarchy.

For example, if the concept “jaguar” has the URI of “www.animals.com.asia.mammals.#jaguar,”all descriptions of “jaguar” will refer to this URI; thereby, allowing unique definitions of specific concepts to be created. The fact that the URI serves as a unique identifier for each concept and relationship in the RDF triple as it is created allows the triple to be distinguished from other triples. This is particularly important for modeling descriptions or meanings. Computer standards can be considered as a common dictionary for defining a particular computer task. However, as described above, it is unlikely that a single standard, or description and definition, will be accepted. Therefore, the RDFs triples provide a logical framework for creating multiple dictionaries capable of describing computer resources. These dictionaries are made up of common elements that are discoverable and traceable based on their unique identification. In an embodiment of the present invention, ontologies are used to create unique descriptions and definitions of computer resources including web services in ways that allows the definitions to be understood by different computer systems across a network and allows the meaning of those computer resources to be shared in a consistent and dependable manner. Ontologies will be better understood with reference to the specific examples ontologies described hereinafter. It will thus be understood and appreciated that the ontology store 140 comprises a collection of data entries or records in the form of subject, predicate, object, identifier (not necessarily in that order), where each entry in the ontology store 140 may be linked to others through their relationships and inference, as will be described further herein and as will be understood by those skilled in art.

As stated previously, the resource registry 142 is the physical data store for the registry of computer resources and provides an index and description of computer resource for easy description and discovery. The resource registry 142 is used to publish computer resources and to locate published computer resources on the Internet in a open standard format. The resource registry 142 is the collection of data entries in the known UDDI-compliant format, which, like a typical yellow pages directory, provides a database of businesses searchable by the type of business, which is typically searched using a business taxonomy such as the “North American Industry Classification System” (NAICS) or the Standard Industrialized Classification (SIC). A UDDI-compliant registry is also searchable by business name, geographic location, and various other parameters, as will be known by those skilled in the art. Typically, each business registered in a UDDI-compliant database lists all of its services and gives each of these services a type, with each service type having a unique identifier that comes from a pool of known service types, that are registered also with UDDI. These particular service types, as known to those skilled in the art, are called “tModels.” Thus, in the preferred embodiment, the data structure in the UDDI-compliant resource registry 142 comprises a tModel that has a name, description, and a unique identifier. The unique identifier (or pointer) is called the tModelKey. Further information regarding the structure of the UDDI-compliant database or resource registry is beyond the scope of this discussion; however, such information is available to those skilled in the art or with reference to conventional literature supplied by the various promoters of the UDDI standard.

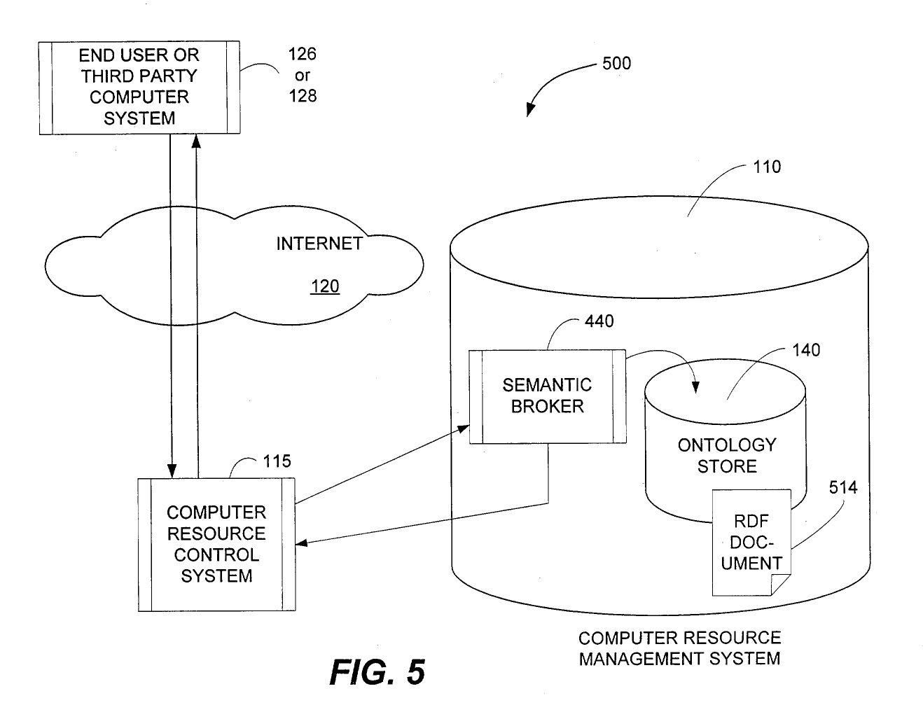

Turning now to FIG. 5, a block diagram illustrating a simplified, exemplary operating environment 500 in which the system and methods of the present invention are used to invoke a web service is shown. A user 126 (or system 128) connects to the computer resource management system 110 remotely through a network 120, such as the Internet. In an exemplary embodiment of the present invention, the user 126 connects to the computer resource management system 110 using a web browser and an Internet connection. Alternatively, the user 126 may connect to the computer resource management system 110 using customized software designed for use with the computer resource management system 110. Such customized software may allow more efficient operation of the system.

The computer resource control system 115 handles the interface between the user 126 and the computer resource management system 110. The computer resource control system 115 provides the user interface, receives commands from the user 126, and formats data for presentation to the user 126.

The computer resource management system 110 comprises a semantic broker 440 and an ontology store 140. The semantic broker 440 receives commands from the user 126 and restructures these commands into RDF requests. Typical commands include instructions to add a new concept to an ontology in the ontology store 140, instructions to populate instances of ontologies in a form describing a web service in the ontology store 140, or instructions to query the ontology store 140 for desired web services. The RDF requests are communicated to the ontology store 140 to perform the desired action. The ontology store 140 returns the desired information to the semantic broker 440. The semantic broker 440 then converts the information back to a format for user interaction. Typically, RDF documents 514 are returned from the ontology store 140 to the semantic broker 440.

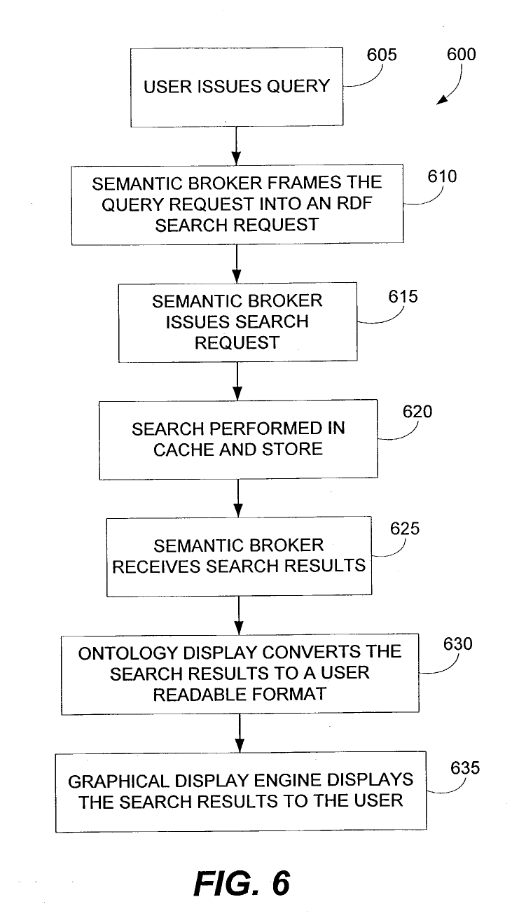

FIG. 6 is a flow chart illustrating a query process 600 in an exemplary embodiment of the present invention. In the present invention, a query is used, for example, to locate web services based on classification criteria contained in an instance of an ontology. A typical query is initiated when the user issues (Step 605) a query request to the system. This is generally performed and passed through the presentation layer. Next, the semantic broker 440 receives the query and reformulates the user query for execution against the ontology store (Step 610). This allows the user interface to gather information from the user in a format comfortable for the user while still issuing a proper request to the ontology store 140. The semantic broker 440 issues (Step 615) the search request. The search is performed on the ontology of RDF triples. In an exemplary embodiment of the present invention, the search is initially performed (Step 620) on the ontology stored in the semantic cache 330 (from FIG. 3) and, if the results are not stored in the semantic cache 330, the search is performed on the ontology store 140. As will be appreciated, the ontology store 140 holds all available ontologies while the semantic cache 330 only holds the results from the most recent search requests.

After the search is complete, the semantic broker 440 receives (Step 625) the RDF search results and communicates the results to the interpretation component 422. The interpretation component 422 converts (Step 630) the search results to a user readable format. The graphical display engine then displays (Step 635) the results to the user.

Specific Discussion Example to Illustrate Further Aspects of the Invention

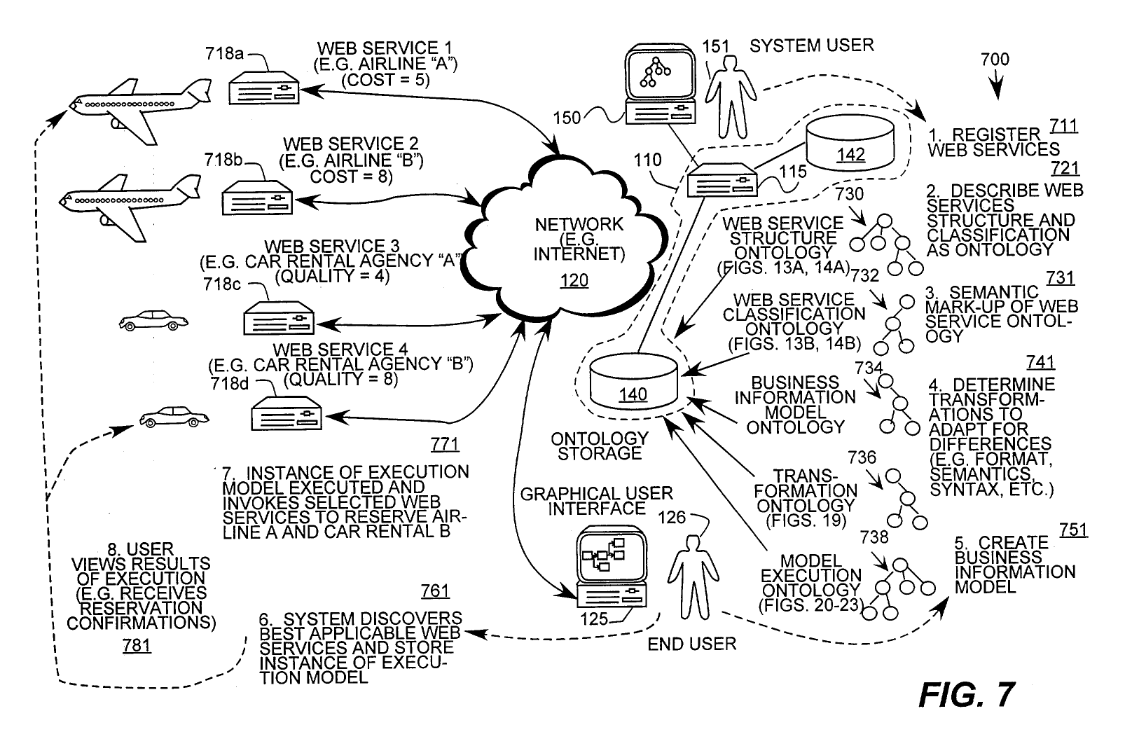

A specific example of how the system and methods of the present may be used in a powerful and practical way is illustrated by FIGS. 7-39. Turning first to FIG. 7, it will become apparent that, like FIG. 1, FIG. 7 provides an overview of the relationships between various computer resources 718 and various ontologies 730, 732, 734, 736, 738, as well as of the general process 700 by which the computer resources 718 are captured and modeled for use by the system, how further ontological models are created, and, ultimately, how the end user 126 is able to create and execute an ontological model to obtain a practical benefit, in this case, obtaining an airline and car rental reservations according to a proposed travel itinerary and according to other criteria pre-selected by the end user 126.

For purposes of this “travel reservation” discussion example (for FIGS. 7-39), it should be understood that the relevant computer resources that will be discussed hereinafter are web services 718a, 718b, 718c, 718d, which are available to the system 110 and to the end user's computer 126 via the network 120. More specifically, the web services include two different car rental services and two different airline ticket reservation services: Web Service 1 (corresponding with airline reservation system A) is shown at 718a; Web Service 2 (corresponding with airline reservation system B) is shown at 718b; Web Service 3 (corresponding with car rental agency A) is shown at 718c; and Web Service 4 (corresponding with car rental agency B) is shown at 718d.

Each of these web services is assumed to be described and classified according to certain criteria. In the present example the web services are classified based on criteria of “cost,” “quality,” and “availability.” Of course, many other objective and subjective attributes or characteristics may be associated with the various web services. But for purposes of the present discussion, only these three will be referenced. In this example, “cost” and “quality” are assumed to exist on a numeric scale from 0-10, and each of the particular web services has been assigned a “cost” or “quality” level that will be useful as this discussion example unfolds. In practice, the business entity associated with the system user 151 may utilize extensive classification criteria for defining and describing the web service. In accordance with the present invention, these additional attributes are considered meta-data, which are incorporated into the system as part of the web service classification ontology, discussed in greater detail hereinafter.

Still referring to FIG. 7, a general process is shown at 700, and comprises a number of steps in accordance with aspects of the present invention that provides for service registration, mark-up additional metadata, use of business information models for the purposes of describing and classifying the web service, creation of transformation and execution models, discovery of best applicable web services that satisfy the criteria and parameters selected by the end user to define an instance of the execution model, execution of such execution model in stance, and viewing of results of the execution.

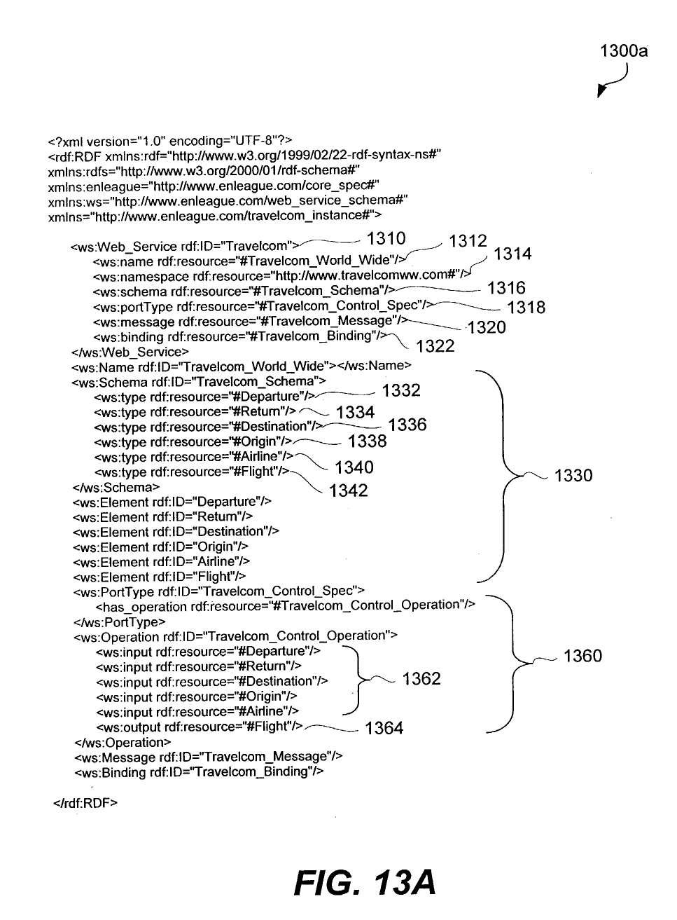

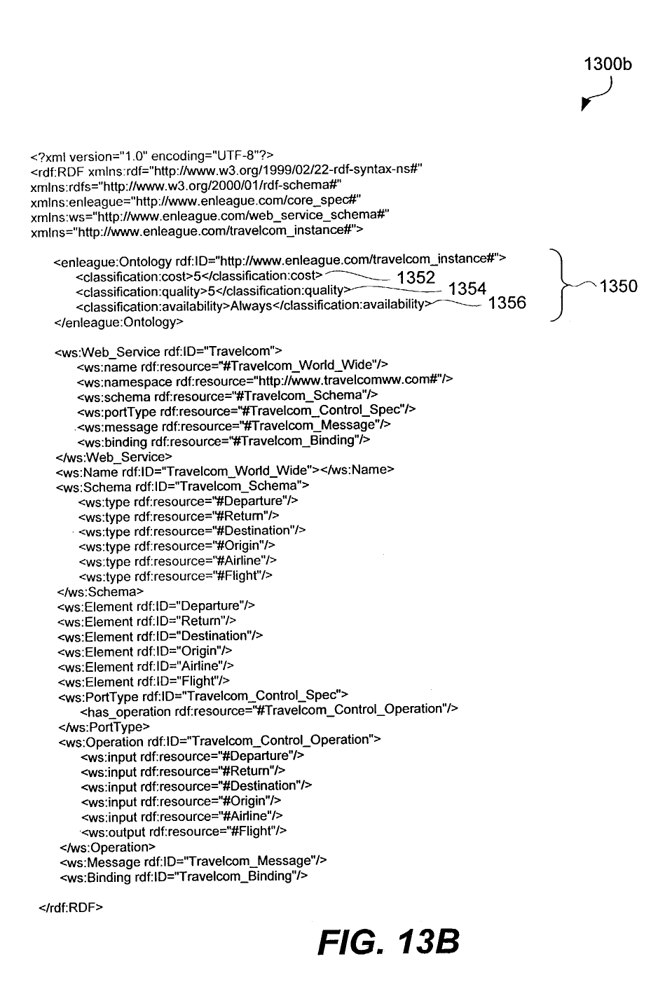

More specifically, at Step 711, the various web services 718 are registered. The registration process is described in greater detail elsewhere herein. For the present, it should merely be understood that registration may be affected as a separate process conducted independently of other steps in the process. Registration may be affected by persons external to the system. For example, information concerning registered web services may be reflected in a computer resources registry 145 that is external to the system, as shown in FIG. 1. Alternatively, web services 718 may be registered by a system user 151, and information reflective of the registration stored in the internal computer resource registry 142, also as shown in FIG. 1. In either case, a web service must be registered, that is, information concerning the availability of such web service and other information associated with the web service, that may be necessary to invoke it, must generally be available as a prerequisite to other steps carried out in connection with the present invention. It should be understood, however, that although the preferred format for registering such web services is in a UDDI-compliant structure, other formats for registration may be used within the scope of the present invention. The system “parses” the actual web service in known manner to determine, for example, the web service creator, the service type, methods associated with the web service, applicable inputs and outputs for each method, and similar elements. Such “parsable” information is available from the web service “definition” (i.e., WSDL), which is an XML document, defined by the web service creator and accessible at a designated URL at the relevant web service server. The final result of the registration of the web service is the population of instances in a web service structural ontology 130, and in this particular instance, this web service structural ontology 130 is stored in the ontology storage 140. A specific web service structural ontology will be described in connection with FIG. 13A.

At Step 721 the system user 151 classifies the web service and describes basic characteristics, from the viewpoint of the system, that will index and classify the system. An example of such indices include whether the web service is private or publicly-accessible and, if private, what ID-password combination is required to invoke the web service. The system user 151 may provide additional information describing the web service and/or its attributes, characteristics, features, quality, and other objective or subjective information that may not be revealed by the web service itself or that may be pertinent to the particular business entity or entities that invoke the web service. The end result of providing such additional information is providing specific attributes for classifying the web service through the creation of meta data that populates an instance of the web services classification ontology 732 and is stored in the ontology store 140 in conjunction with the corresponding web service structural ontology 730 for this web service. A specific web service classification ontology consistent with the present example will be described in connection with FIG. 13B.

Preferably, Steps 711 and 721 occur substantially simultaneously, such that mere registration and description of the web service 718 by the system user 151 results in registration of the web service, which is stored in computer resource registry 142, and simultaneous creation of an instance of the web service structural ontology 730 and an instance of the web services classification ontology 732, which are both maintained in the ontology storage 140. It should be understood that the computer resource registry 142 and the ontology storage 140 maintain pointers to each other so that the information about a particular web service remains coordinated and synchronized between both types of data storages.

At Step 731, the system user 151 carries out steps to describe the available web service and its available operations and parameters. Typically, the description and classification of the web service is carried out by a technically-trained system user 151, who is trained to use the invention, in conjunction with automated processes carried out by the system. More specifically, at Step 731 the system user 151 semantically “marks-up” the operations and parameters of the web service in terms of business information models that are stored as business information model ontologies 734 and stored in the ontology storage 140. The process of semantic mark-up involves describing or defining these operations of the web service based on descriptive concepts and relations defined within the business information models. The result of the semantic “mark-up” process is a definition of operations of the web service in terms of concepts in the business information model. These “mark-up” definitions are stored as an instance in the transformation ontology 736 and are described as a Semantic Integration Model (SIM) that is stored in the ontology storage 140.

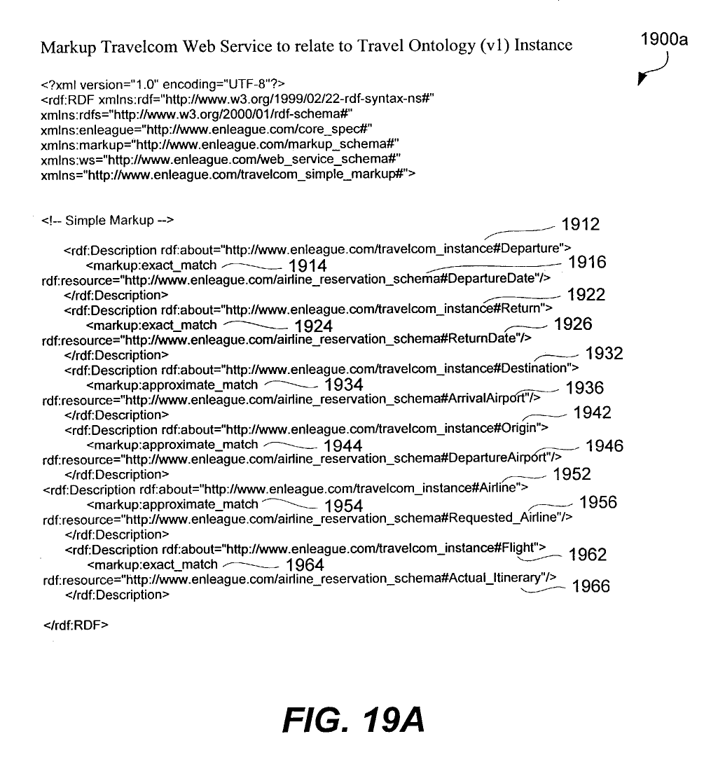

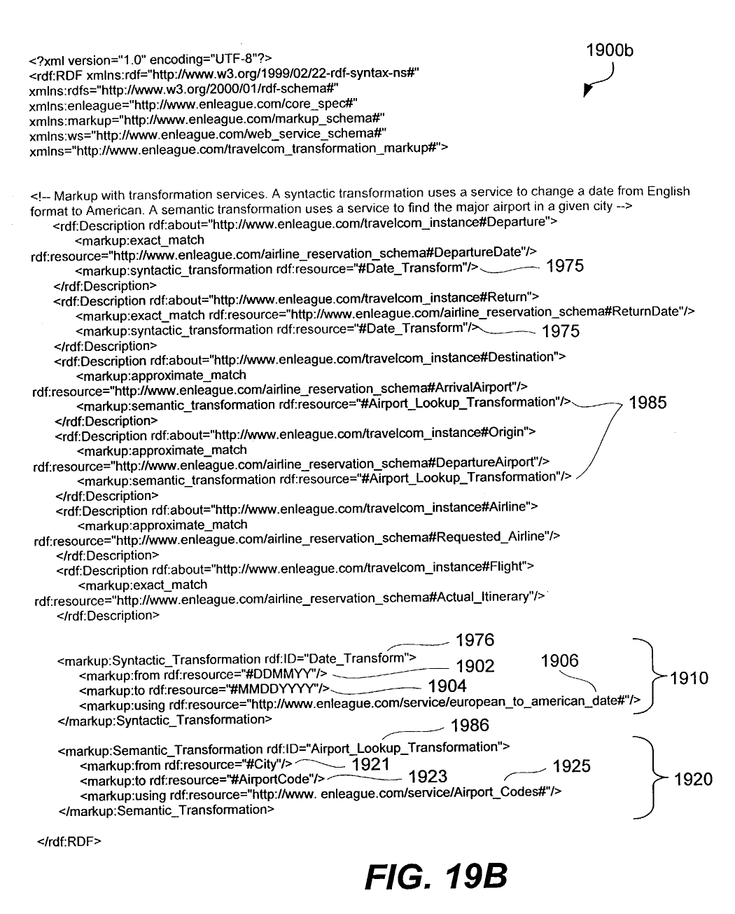

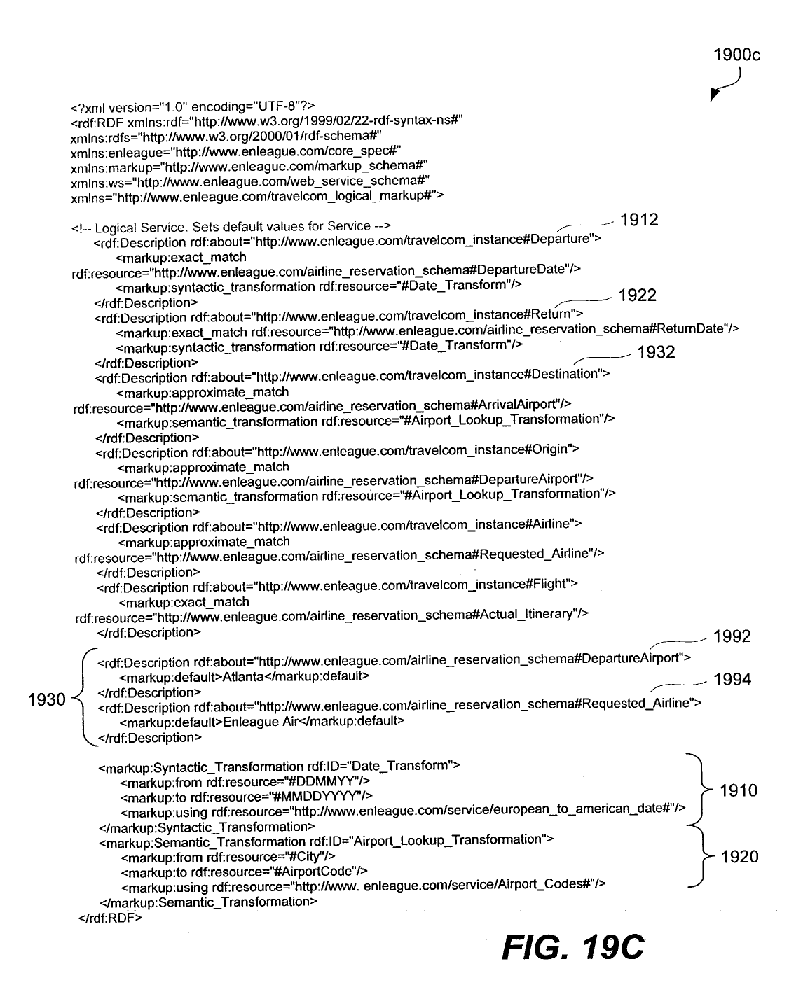

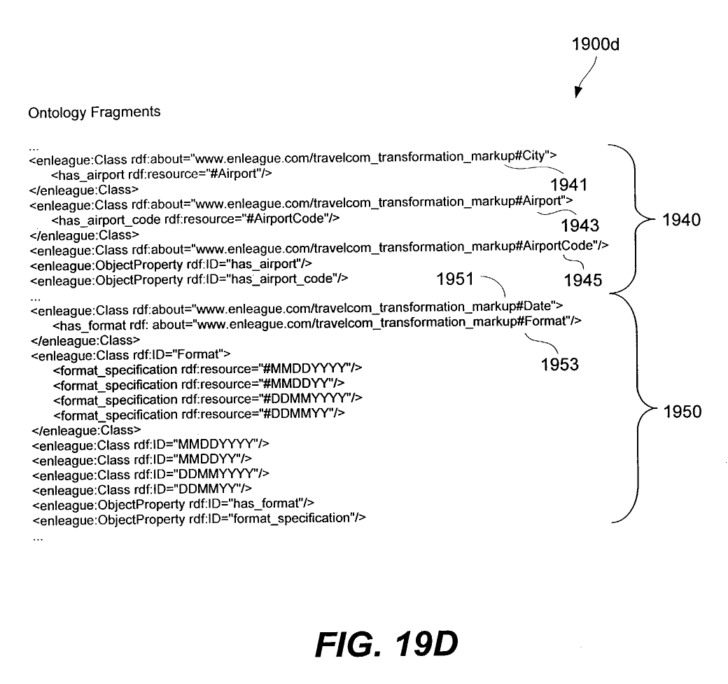

At Step 741, the system user 151 is also able to define various parameters (e.g., method or function calls, input parameters, output parameters) in terms of various abstract transformation functions, which are also described in the transformation ontology 736 that is stored in the ontology storage 140. The transformation ontology reflects concepts, such as described in the example above wherein one particular computer resource may have a date parameter of “Departure,” while another computer resource may have a similar or related parameter “DepartureDate,” both of which, in this case, are used for the same variable. Specific examples of transformation ontology instances or SIM models will be described in connection with FIGS. 19A-19D.

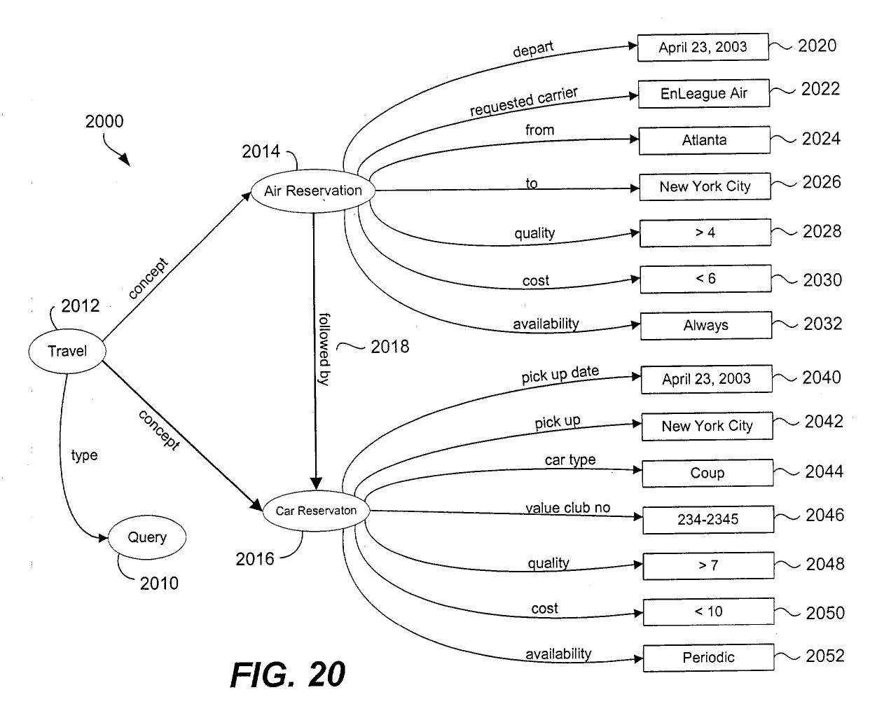

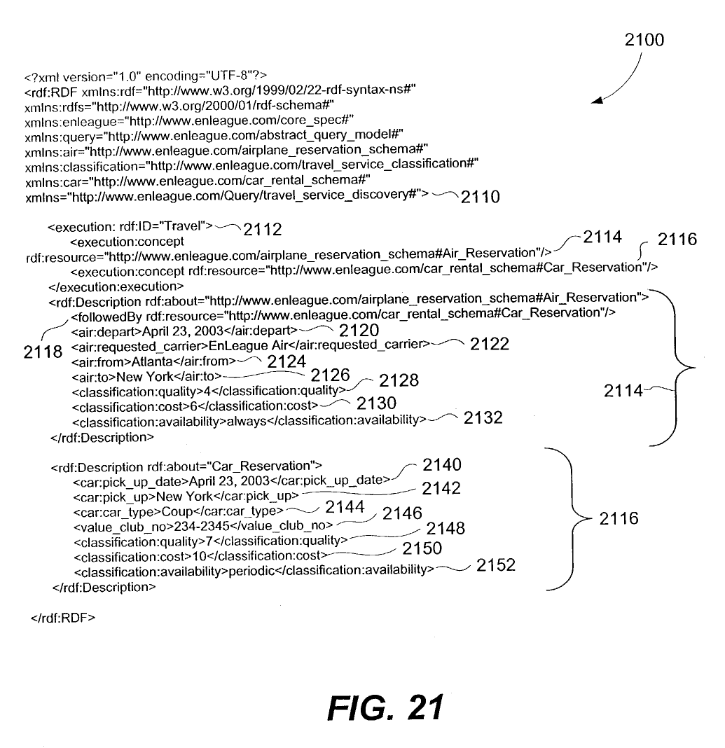

At Step 751, the system user 151 typically constructs one or more execution models that carry out a specific and often complex computing task. The execution model combines one or more business information ontologies in a desired manner to represent an abstract description of a certain function, operation or process. The execution model is reflected in an instance of the model execution ontology 734 and is stored in the ontology storage 140. A specific example of an execution model and corresponding ontology will be described in connection with FIGS. 20-21.

At Step 761, the system 110 discovers various computer resources based on discovery constraints. The system 110 queries the mark-up sub-component 444 of the semantic broker 440. The mark-up sub-component formulates queries to be executed against the transformation ontology instances described as the SIM models. These queries are passed to the atlas sub-component 442 for execution against the ontology store 140. Web services are discovered based on how those services are defined through the business information models, which are referenced in the execution model and that meet selection criteria and constraints. The inference module 450 is called to determine which services satisfy such parameters, restrictions, and limitations based on specific rules. The interpretation component 422 also translates operations and parameters to provide a common interface. The discovery occurs by searching for SIM models to determine which web services are described based on business concepts contained in the business information model. Once services are discovered, the execution model is stored as an instance of the model execution ontology 738 and is stored in the ontology storage 140.

At Step 771, a stored model execution ontology instance is invoked. The system imposes the parameters, restrictions, and limitation requested as part of the model execution ontology. The system then attempts to access the relevant web service(s), using the appropriate method call and input parameters, which may or may not be modified by an applicable transformation ontology to ensure that the information provided to the web service is in appropriate format.

In the example shown in FIG. 7, the invoked execution ontology executes selective and particular web services to make a reservation using a particular airline reservation service (e.g. airline reservation service “A”) and then to reserve a car at the destination location through a selective car rental agency “B.” In the example being given, one or more web services may have been available to provide flight reservation services and car rental services, but execution of the complex task resulted in selection of a particular one of the airline reservation services and a particular one of the car rental agencies based on results of the discovery process, which may have been triggered by the entry of particular parameters by the user, or may have been triggered by the application of particular default parameters. For example, if the particular user executing the model execution ontology only wanted to select a car rental agency of a quality greater than 6, only car rental agency “B” (having quality 8) would have been invoked. Similar selection may have occurred in connection with reserving a seat using airline reservation service “A” as opposed to airline reservation service “B,” if the user had requested a service having a cost less than 7, for example.

Finally, at Step 781, the end result of the computing task carried out by the model execution ontology instance is the viewing of the results of the execution. For example, receiving reservation confirmation from the selected airline reservation service and car rental agency is the end result of performance of the model execution ontology instance that requested an airline reservation from a web service having a cost less than 7 and a car rental reservation from a car rental agency having a quality greater than 6. Obviously, the model execution ontology can be configured to be much more complex; however, the present example is sufficient for describing the much greater functionality also available with the present invention.

FIG. 8 illustrates relationships between the exemplary ontologies that are utilized in the disclosed system and methods of the present invention. Such ontology schemas 800 include both schema type ontologies (top row) as well as specific instances or instantiations (lower row) of such schema types, as will be appreciated by those skilled in the art. The present invention contemplates creation and provision of a web service structural ontology 810 and a web service classification ontology 815. A business information model ontology 820 schema is provided, as well as a transformation ontology 825, and a execution model ontology 830. It will of course be appreciated that the present discussion example relates to computer resources that are “web services,” but it will be recalled from previous discussion that other types of computer resources may also be modeled and represented in a corresponding manner. It should be understood that each of these various ontologies has its own schema, which in the disclosed embodiments is represented in a DAML-described XML document. Each schema type represents a high level “abstraction” or model of a particular concept, while a particular instance represents a more detailed and specific example of the higher level schema. In some, but not all cases, an instance will include specific “data” associated with the variables and terms defined in a higher level schema.

For example, with continuing reference to the travel discussion example from FIG. 7, an instance of the web service structural ontology 810 may be represented by information corresponding to a particular airline reservation service or a particular car rental agency. In the specific discussion example that has been provided, a particular instance or instantiation of a web service structural ontology is that of the fictional airline reservation service “TravelCom,” whose online airline reservation system may be accessed at the URL http://www.travelcomww.com. Information about the structural aspects of the TravelCom web service are incorporated into the web service structural ontology 810, and therefore represents an instance thereof. Similarly, although it will not be discussed further, an instance of a different web service, such as that of a car rental reservation system, is also shown.

The web service classification ontology 815 similarly has specific instances that represent addition of particular meta data that classifies and indexes the corresponding and associated web service in terms of use, function, and origin. For example, the exemplary car rental reservation service has associated meta data indicating the quality, availability, cost, or other parameters associated therewith. The web service classification ontology 815 provides a structure and format for storing this additional information about the car rental reservation service. As specifically illustrated, a particular instance of a web service classification ontology for one of the car rental reservation services is shown with the following specific metadata associated therewith, such as quality equals 8 (on a 0-10 scale), availability equals “periodic,” cost equals 8 (on a 0-10 scale). Typically, such metadata will be added by a system user, as such information will be additional to or supplementary to information provided by the web service itself As is also specifically illustrated, a particular instance of a web service classification ontology for one of the airline reservation services is shown with the following specific metadata associated therewith, such as quality equals 5 (on a 0-10 scale), availability equals “always,” cost equals 5 (on a 0-10 scale).

Still referring to FIG. 8, a business information model ontology 820 provides a structure for storing information as to particular business or technical concepts that the system user may wish to implement and that serves to describe and define the web service and its operations. For example, business entities may wish to construct a complex computing task generally and semantically described as “get information about major customers and go visit them.” This high-level semantic meaning, when applied in a specific computing context, may indicate that a predefined computing task involving: (i) accessing the company's internal computer system to obtain the five largest customers, (ii) followed by the execution of a predefined business information model “travel” to go visit such business customers, while applying certain default parameters and rules, such as the selection of the particular quality levels, cost factors and other parameters that may be deemed applicable or appropriate for the travel selection process. Therefore, one particular instance of a business information model ontology 820 may be reflected in the general form: travel from (city A) to (city B) on (day) with (other parameters). Note that this is a general model that contains specific business concepts of travel, location, date, and other parameters. As such, this instance of a business information model is still unfinished as it requires the input of additional parameters such as starting and ending destination cities, travel dates, and other parameters. Such more specific parameters will be provided during model execution, as discussed herein.

In this regard, the execution model ontology 830 provides a structure and framework for storing information associated with the execution of a particular process or operation. This framework contains descriptions of functions in terms of business concepts contained in the business information model, pre-defined parameters related to those functions, and criteria for discovery of web services. In the present example, a execution model ontology instance would refer to the “Travel” business information model schema and present undefined parameters that require populating prior to execution. For example, specific parameters as defined in the “Travel” business information model such as ATL to NYC as the starting and destination values, Apr. 23, 2003 as the beginning date of the trip, with additional parameters of cost<6 using any particular airline reservation service having an availability as “always” and a quality>7 on any particular available car rental are indicated as required in order to execute the model.

The transformation ontology 825 provides a structure and framework for storing information to relate certain specific concepts from one ontology to another. Transformation occurs in two ways in the present invention. First, the transformation ontology is used to relate operations and parameters from a specific web services ontology to concepts in a business information model ontology. Second, the transformation ontology is used to create abstract definitions of operations and parameters to allow for invocation of services that create data translations. In this second instance, the transformation ontology is used to transform data into a normalized form or between two operations in a flow. This includes semantic and syntactic transformations, which will be discussed in greater detail herein.

For example, the generic concept of “travel” generally has the notion of a starting date associated with it. A specific instance of an airline reservation web service may have DepartureDate as a name for an input parameter. However, a specific instance of a car reservation service may have an input parameter of StartofTrip. Logically, these terms are the same. The parameters differ in terms of name and may differ in terms of syntax and data type. The transformation ontology provides a mechanism to store information to relate the fact that these two date-related pieces of information DepartureDate and StartofTrip are truly the same thing or specifically related that they should be treated the same in the computing context. The transformation ontology contains references to the specific methods for translating data between these two parameters.

From the foregoing, those skilled in the art will understand and appreciate that ontologies are used to relate concepts to one another, that each ontology possesses its own schema type that reflects the information that it is intended to carry and the logical structure for such information, and that specific instances of the various schemas contain, in some case, yet more specific information and structure or, in other cases, specific values for the information associated with a particular occurrence of that schema.

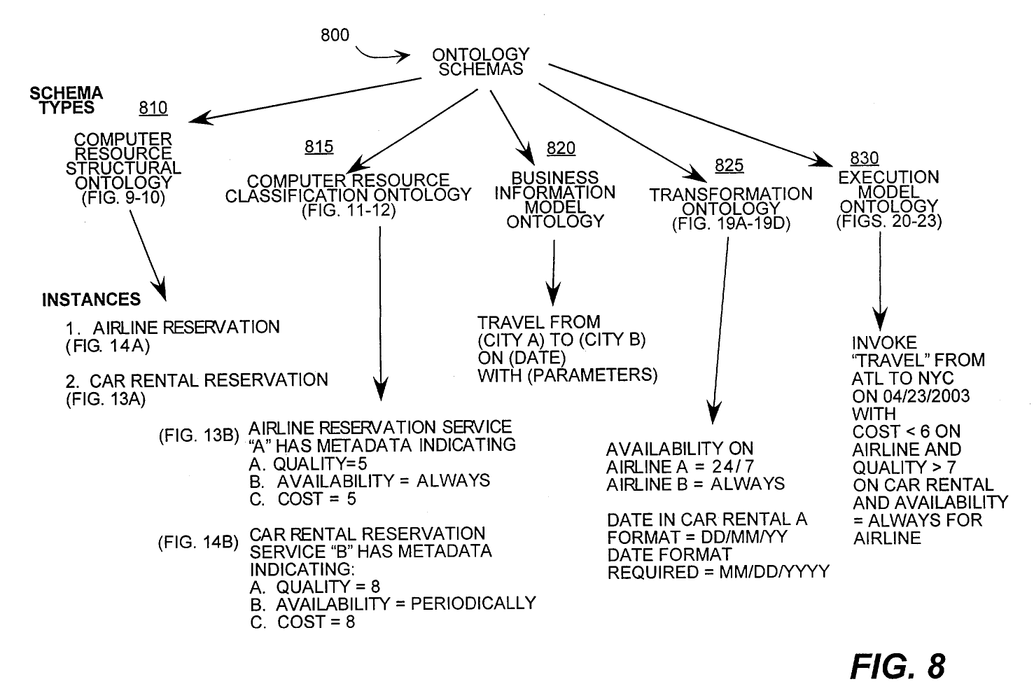

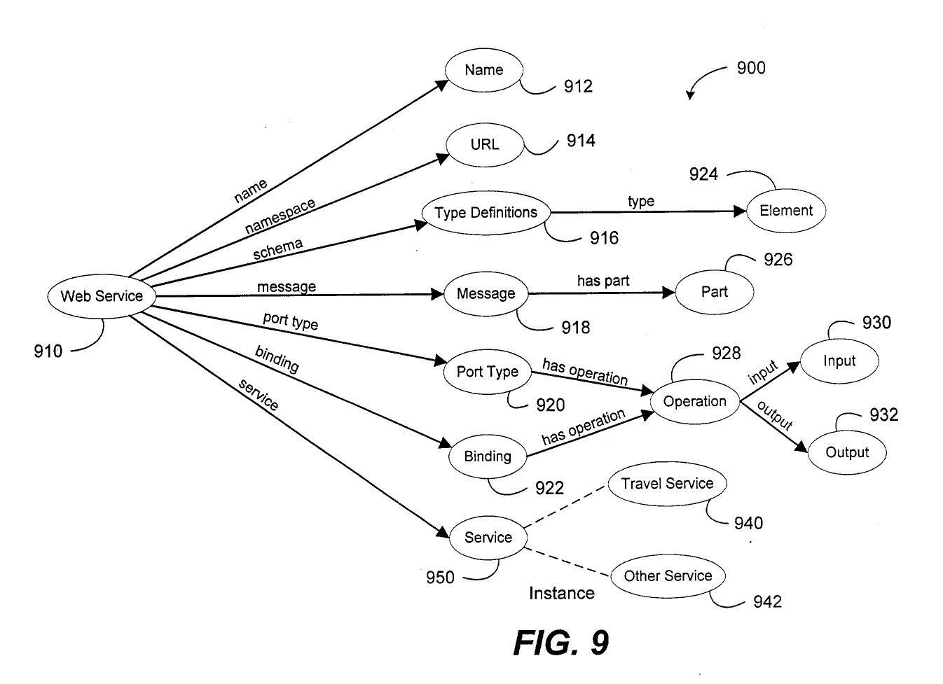

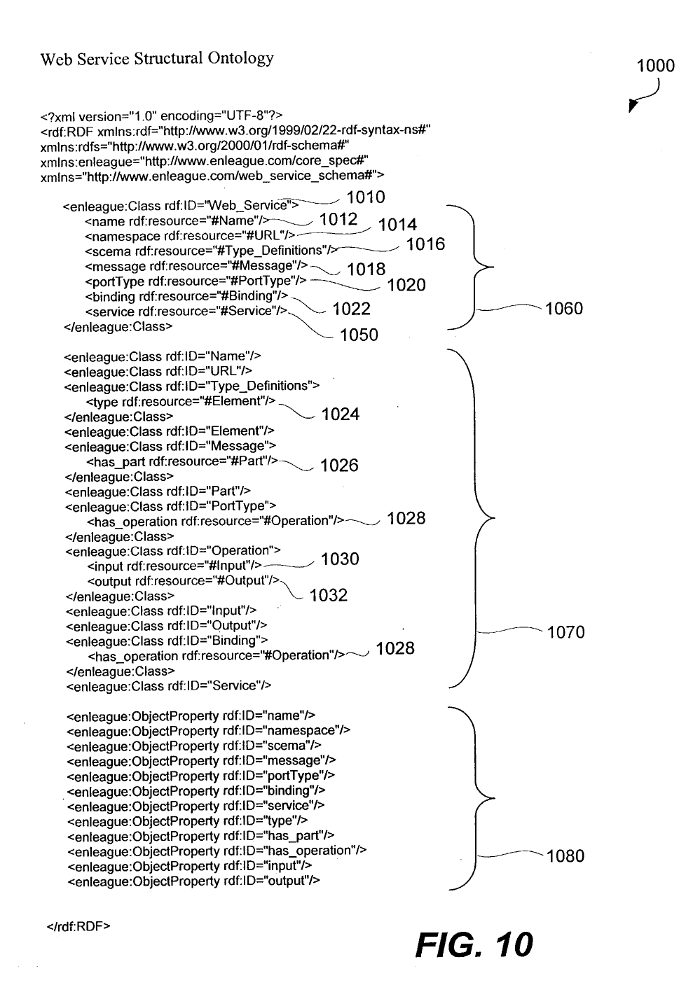

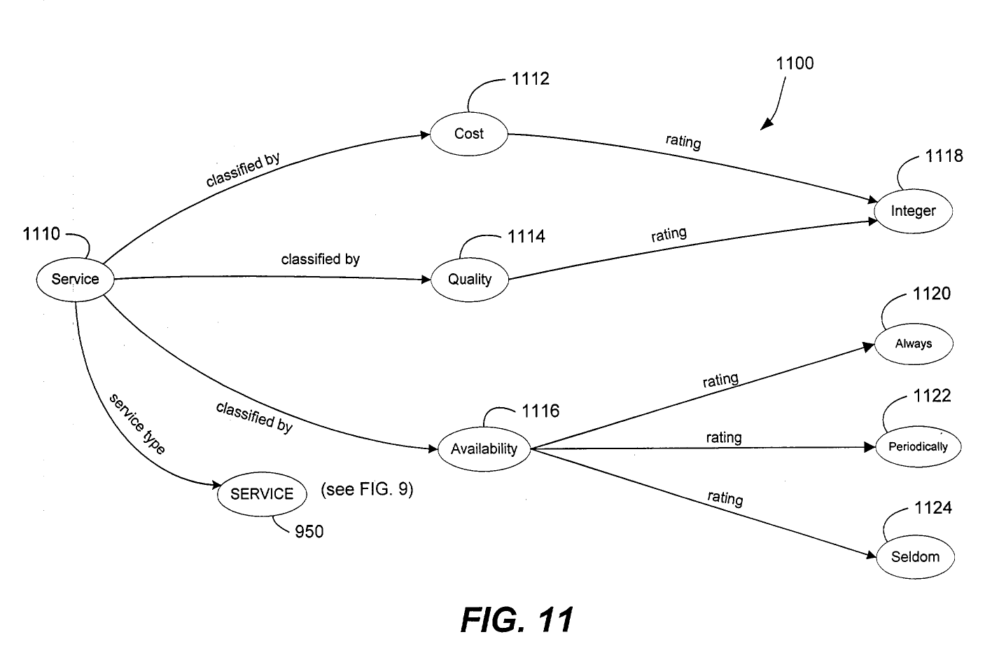

Turning now to FIG. 9 and still with reference to the previous “travel reservation” discussion example from FIGS. 7-8, a graphic form of a generic, simple, but exemplary, web service structural ontology. 900 is illustrated. As described above, the graphical representation is that of a directed graph consisting of nodes (subject) connected by an arc or line (predicate) to other nodes (object). Each node-arc-node combination represents a specific RDF triple, which is stored in the ontology storage 140.

In evidence in the XML schemas are the structural characteristics of the description logics of DAML as an exemplar of ontologies. Illustrated in the present example are class, sub-class, objectproperty, resource, and ID. Classes are groups of objects that have similar characteristics. Subclasses inherit the characteristics of the classes but reflect a limited sub-set of properties. Objectproperties are themselves classes and define class properties and relationships. These are predicate relationships in the subject-predicate-object structure. Resources are things described by RDF expressions (e.g., web pages, part of a web page, collections of web pages, objects not directly accessible via the web) named by a URI or optional anchors or identifiers. ID describes a specific type of a class.

By way of example and not limitation, the web service structural ontology 910 has a number of properties (objects) illustrated, such as a name relationship to Name 912, a namespace relationship to URL 914, a schema relationship to Type Definitions 916, a message relationship to Message 918, a port type relationship to Port Type 920, a binding relationship to Binding 922, and, of particular note, a service relationship to Service 950.

As is also readily apparent when viewing FIG. 9, an object at one level can be a subject at another level. For example: (i) the Web Service property Type Definitions 916 has a type relationship to Element 924; (ii) the Web Service property Message 918 has a has part relationship to Part 926; and (iii) the Web Service properties Port Type 920 and Binding 922 both have the identical has operation relationship to Operation 928. At an even deeper level into this ontology 900, the Operation 928 attribute has multiple possible further properties of an input relationship to Input 930 and of an output relationship to Output 932.

As can also be seen in FIG. 9, the Service 950 property also defines a schema that has instances of Travel Service 940 and Other Service 942. The lines connecting Service 950 to Travel Service 940 and to Other Service 942 is shown dotted to indicate that the relationship is a schema-instance relationship and creates a different RDF triple.

FIG. 10 provides an alternate representation of the web service structural ontology 900 graphically presented in FIG. 9 and should be read in combination therewith. In FIG. 10, the web service structural ontology 1000 is illustrated in a DAML-described XML representation; however, there is no substantive difference between the two web service structural ontologies 900, 1000; there is only a difference in the manner in which this single ontology is presented. Thus, the web service 1010, like web service 910, has a number of properties (objects) represented, such as a name relationship to Name 1012, a namespace relationship to URL 1014, a schema relationship to Type Definitions 1016, a message relationship to Message 1018, a port type relationship to Port Type 1020, a binding relationship to Binding 1022, and a service relationship to Service 1050.

This first level of ontology 1000, designated by section 1060, defines the minimum necessary structure for this ontology to be UDDI or WSDL compliant. This does not mean that all of the particular properties must be included; rather, it means that a “class,” in this case Web Service 1010, must be defined to include at least one attribute.

Section 1070 of FIG. 10 further defines the second, third, and any subsequent levels of properties associated with Web Service 1010. For example: (i) the Web Service attribute Type Definitions 1016 has the further attribute of type relationship to Element 1024; (ii) the Web Service attribute Message 1018 has the further attribute of has part relationship to Part 1026; and (iii) the Web Service properties Port Type 1020 and Binding 1022 both have the identical further attribute of has operation relationship to Operation 1028. At an even deeper level into this ontology 1000, the Operation 1028 attribute has multiple possible further properties of input relationship to Input 1030 and of output relationship to Output 1032.

Section 1080 of FIG. 10 provides a comprehensive listing and structure for each of the predicates (e.g., name, has part, has operation, etc) used to related each subject-object pair identified in FIGS. 9 and 10.

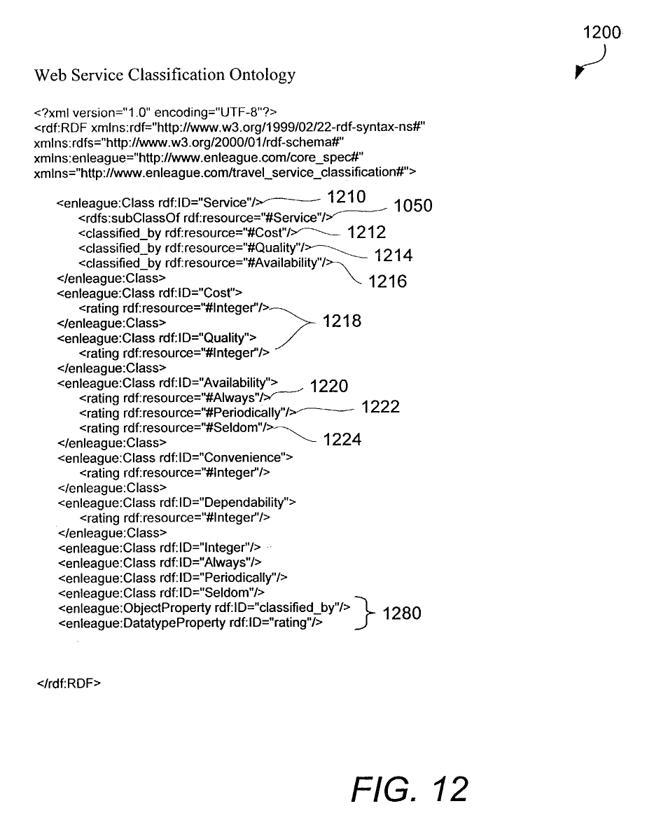

FIGS. 11 and 12 describe a generic, simple, but exemplary service classification ontology. In FIG. 11, this service classification ontology is shown by reference numeral 1100 and, in FIG. 12, by reference numeral 1200. It will be recalled from previous discussion that a classification ontology allows the association of meta data with a particular web service for further classification and description of such web service. In this case, the service classification ontology is generically defined so that it applies to “all” potential services, not just web services. However, since web services are a “type” of service, this classification ontology applies to web services as well because of the class properties (based on the principle of inheritance) that are included in the description logic framework.

By way of example and not limitation, Service 1110 has a number of descriptive properties (objects) illustrated. In other words, Service 1110 is classified by Cost 1112, Quality 1114, and Availability 1116. It should be understood that many additional and potential properties (not shown) could have been included to provide even more detail in describing relevant properties (such as “convenience,” dependability,” and the like) that a Service 1110 may have and that may serve as classification criteria, indices, further characteristics, or characterizations of the Service 1110. It should also be noted that both Cost 1112 and Quality 1114 have been defined to have a rating expressed as an Integer 1118. Conversely, Availability 1116 has been defined to have a rating expressed as three possible “word” values: Always 1120, Periodically 1122, and Seldom 1124. As will be appreciated by one skilled in the art, the range of possible properties for Cost, Quality, and Availability is arbitrary and innumerable. For example, Cost could have been defined to have possible values of “Expensive,” Moderate,” and Cheap;” Quality could have been defined to have possible values of “4 Star,” “3 Star,” “2 Star” or “1 Star;” and Availability could have defined to have an integer value or to have other possible values, such as “Business Hours,” “Weekends,” and “24/7.” Finally, ontology 1100 illustrates that Service 1110 is a “subclass of” Service 950 (defined previously in FIG. 9). This makes clear that this classification ontology will be applicable to any web service structural ontology defined in FIGS. 9 and 10.

FIG. 12 illustrates the service classification ontology 1100 from FIG. 11 in a DAML-described XML representation 1200. Thus, Service 1210 is classified by Cost 1212, Quality 1214, and Availability 1216. Service 1210 is also a subclass of Service 1050. Both Cost 1212 and Quality 1214 have a “rating” expressed as an Integer 1218. Conversely, Availability 1216 has a “rating” expressed as three possible “string” or “word” values: Always 1220, Periodically 1222, and Seldom 1224. Section 1280 provides a comprehensive listing and structure for each of the predicates (e.g., classified by and rating) used to related each subject-object pair identified in FIGS. 11 and 12.

Turning now to FIG. 13A, a specific and exemplary “instance” 1300a of the web service structural ontology 900, 1000 from FIGS. 9 and 10, is illustrated. No graphical representations for this instance are included herein; however, it will be self-explanatory how this instance matches up with the schema 1000 of FIG. 10. More specifically, FIG. 13A illustrates an instance 1300a of an airline reservation service that maps to the web service structural ontology schema 1000 of FIG. 10. This instance is for a web service 1310 that is called “Travelcom.” Travelcom web service 1310 has the following properties: its name is Travelcom World Wide 1312, its namespace is the URL http://www.travelcomww.com 1314, its schema is Travelcom Schema 1316, its port type is called Travelcom Control Spec 1318, its message is Travelcom Message 1320, and it has a binding called Travelcom Binding 1322.

As shown in section 1330 of FIG. 13, the Travelcom Schema 1316 is further defined to have the following elements: Departure 1332, Return 1334, Destination 1336, Origin 1338, Airline 1340, and Flight 1342. Finally, section 1360 illustrates that the first five elements of the Travelcom Schema 1316 are used as the “input” variables 1362 to the Travelcom web service and the last element of the Travelcom Schema (“Flight” 1342) is the “output” variable 1364 received from the Travelcom web service.

FIG. 13B illustrates a specific instance 1300b of the airline reservation service 1300a that maps not only to the web service structural ontology schema 1000 of FIG. 10 but also to the generic services classification schema 1200 from FIG. 12. Thus, instance 1300b is essentially a further and “more complete” embodiment of the instance described in FIG. 13A. Specifically, the instance 1300b of FIG. 13B is essentially identical to instance 1300a but with the addition of section 1350, which defines the classifications (or meta data) that have been added by a system user 151 to further describe the Travelcom web service. Namely, this web service has been described to have a cost factor 1352 with an integer value of 5, a quality factor 1354 also with an integer value of 5, and availability 1356 with a string value of “always,” each of which corresponds with the exemplary airline reservation service “A” instance illustrated in FIG. 8.

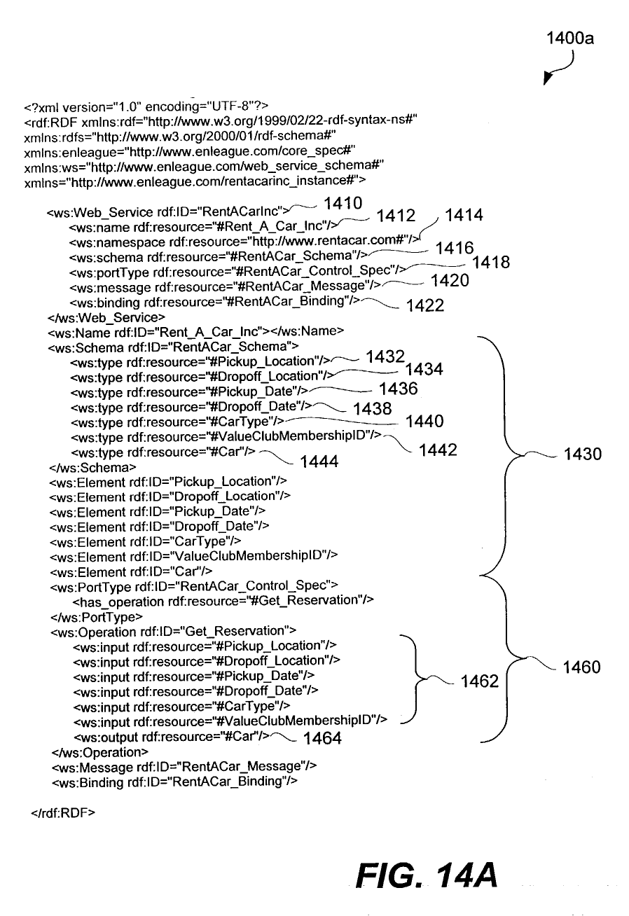

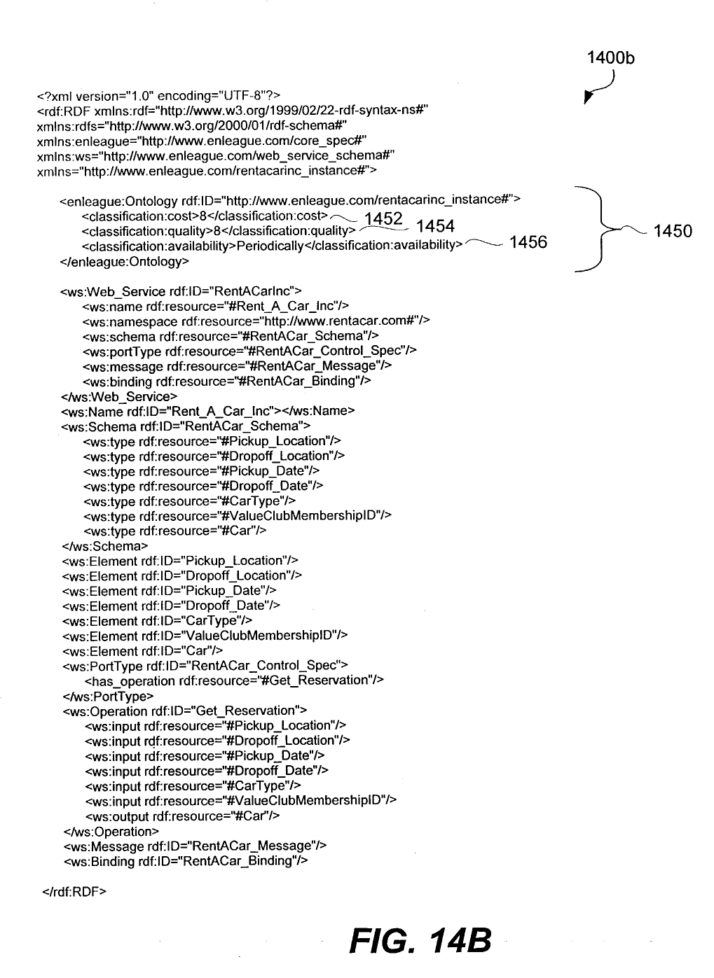

Turning now to FIG. 14A, a specific and exemplary instance of a car rental reservation service 1400a that also maps to the web service structural ontology schema 1000 of FIG. 10 is illustrated. This instance 1400a is for a web service 1410 that is called “RentACarInc.” RentACarInc web service 1410 has the following properties: its name is Rent A Car Inc 1412, its namespace is the URL http://www.rentacar.com 1414, its schema is RentACar Schema 1416, its port type is called RentACar Control Spec 1418, its message RentACar Message 1420, and its binding is called RentACar Binding 1422.

As shown in section 1430 of FIG. 14A, the RentACar Schema 1416 is further defined to have the following elements: Pickup Location 1432, Dropoff Location 1434, Pickup Date 1436, Dropoff Date 1438, CarType 1440, ValueClubMembershipID 1442, and Car 1444. Finally, section 1460 illustrates that the first six elements of the RentACar Schema 1416 are used as the “input” variables 1462 to the RentACar web service and the last element of the RentACar Schema (“Car” 1444) is the “output” variable 1464 received from the RentACar web service.

Like FIG. 13B, FIG. 14B illustrates a specific instance 1400b of the car rental reservation service 1400a that maps not only to the web service structural ontology schema 1000 of FIG. 10 but also to the generic services classification schema 1200 from FIG. 12. Thus, instance 1400b is essentially a further and “more complete” embodiment of the instance described in FIG. 14A. Specifically, the instance 1400b of FIG. 14B is essentially identical to instance 1400a but with the addition of section 1450, which defines the classifications (or meta data) that have been added by a system user 151 to further describe the RentACar web service. Namely, this web service has been described to have a cost factor 1452 with an integer value of 8, a quality factor 1454 with an integer value of 8, and availability 1456 with a string value of “periodically,” which corresponds with the exemplary car rental reservation web service “B” instance illustrated in FIG. 8.

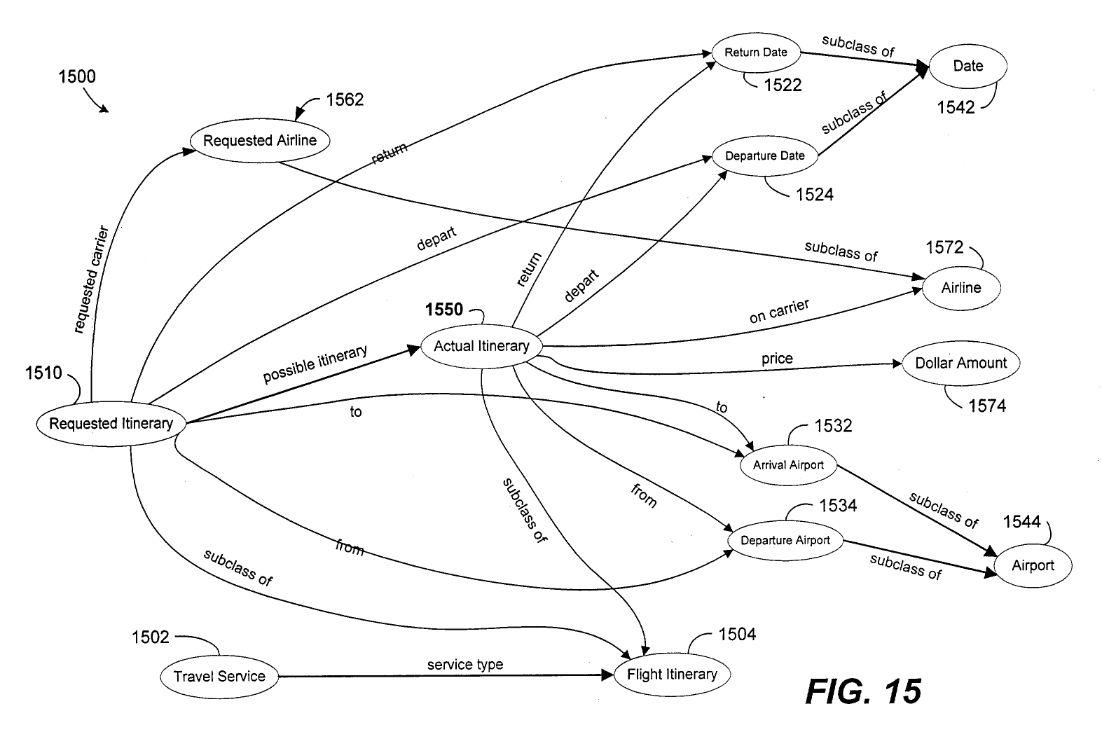

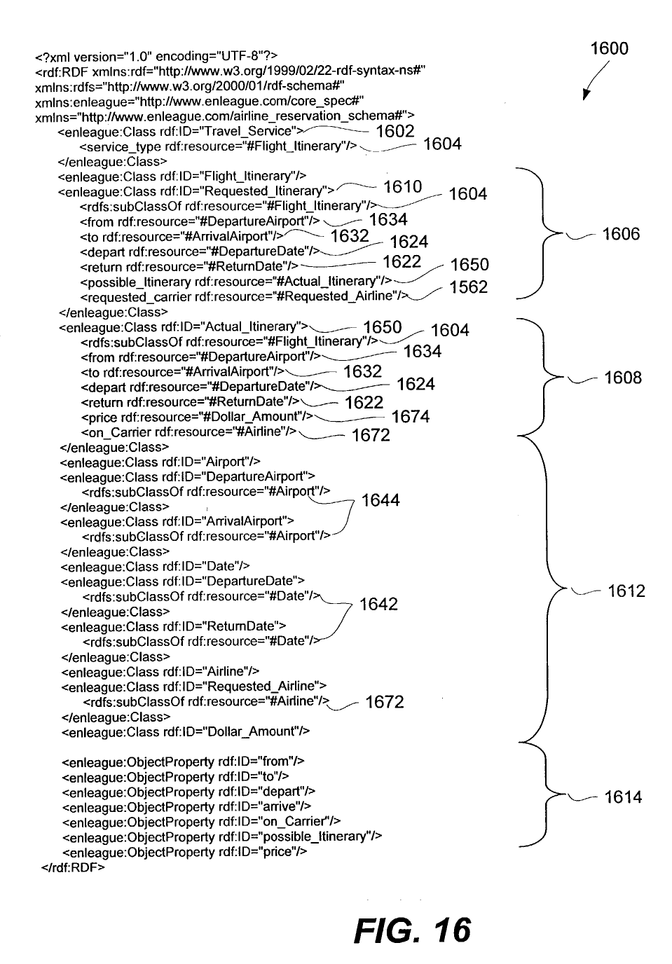

FIGS. 15 and 16 describe a simple, exemplary business information model ontology consistent with our present travel discussion example. In particular, this business information model ontology is a travel ontology schema 1500,1600 for making an airline reservation. With reference first to FIG. 15 and by way of example and not limitation, this airline reservation schema 1500 has a number of descriptive properties (objects) illustrated. First, it is readily apparent that this exemplary schema defines a class Travel Service 1502 and that Flight Itinerary 1504 is a service type relationship to the Travel Service 1502. The two primary properties of the schema, however, are the Requested Itinerary 1510 and Actual Itinerary 1550, each of which is defined to be a subclass of Flight Itinerary 1504.

The Requested Itinerary subclass 1510 is further defined to have its own properties, as follows: Departure Airport 1534, Arrival Airport 1532, Departure Date 1524, Return Date 1522, and Requested Airline 1562. Actual Itinerary 1550 is also defined to have a possible itinerary relationship to Requested Itinerary 1510. The Actual Itinerary subclass 1550 likewise is defined to have its own properties (many of which overlap with the properties of the Requested Itinerary 1510), as follows: Departure Airport 1534, Arrival Airport 1532, Departure Date 1524, Return Date 1522, Dollar Amount 1574, and Airline 1572.

Some of the above classes have class relations such as sub-class relationships. For example, Return Date 1522 and Departure Date 1524 are both subclasses of Date 1542; Arrival Airport 1532 and Departure Airport 1534 are both subclasses of Airport 1544; and Requested Airline 1562 is a subclass of Airline 1572.

FIG. 16 illustrates the travel ontology schema 1500 from FIG. 15 in a DAML-described XML representation 1600. Thus, the airline reservation schema has a class relationship to Travel Service 1602 class and Flight Itinerary 1604 has a service type relationship to the Travel Service 1602. The two primary properties of this schema, however, are the Requested Itinerary 1610 and Actual Itinerary 1650, each of which is defined to be a subclass of Flight Itinerary 1604.

As shown in Section 1606, the Requested Itinerary 1610 is further defined to have its own properties, as follows: a from relationship to the Departure Airport 1634, a to relationship to the Arrival Airport 1632, a depart relationship to Departure Date 1624, a return relationship to Return Date 1622, the possible itinerary relationship to the Actual Itinerary 1650, and a requested carrier relationship to the Requested Airline 1662. As shown in Section 1608, the Actual Itinerary 1650 likewise is defined to have its own properties (many of which overlap with the properties of the Requested Itinerary 1610), as follows: the from relationship to the Departure Airport 1634, the to relationship to the Arrival Airport 1632, the depart relationship to Departure Date 1624, the return relationship to Return Date 1622, the price relationship to Dollar Amount 1674, and the on carrier relationship to Airline 1672.

Section 1612 further identifies sub-properties of some of the previously mentioned properties. For example, ArrivalAirport and DepartureAirport are both subclasses of Airport 1644; ReturnDate and DepartureDate are both subclasses of Date 1642; and Requested Airline is a subclass of Airline 1672.

Section 1614 of FIG. 16 provides a comprehensive listing and structure for each of the classes that act as relationships between classes or as class properties. These classes define each predicates (e.g., from, arrive, price, etc) used to relate each subject-object pair identified in FIGS. 15 and 16.

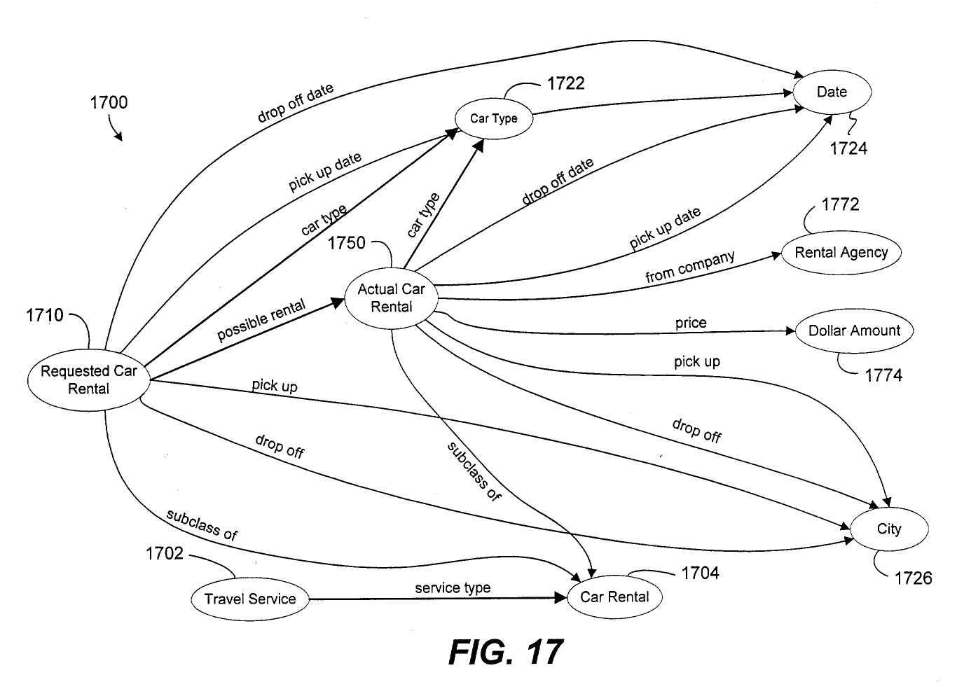

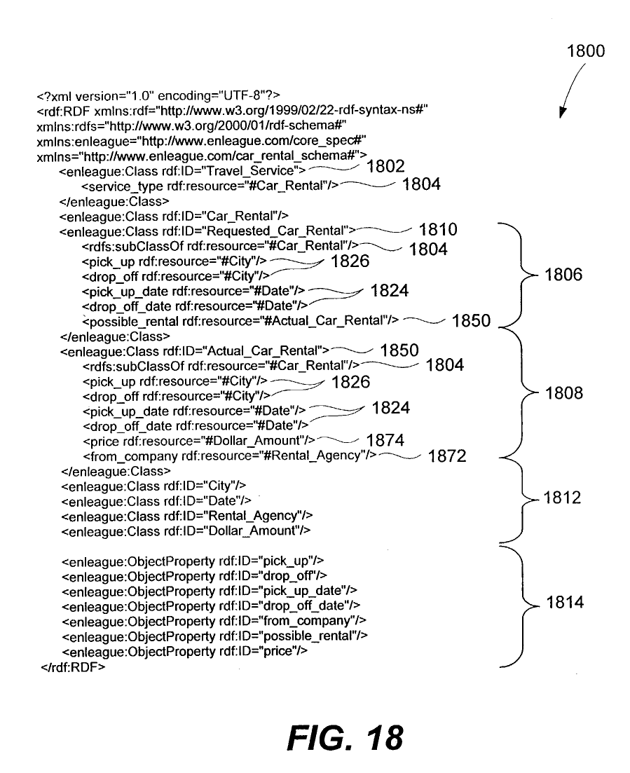

FIGS. 17 and 18 describe another simple and exemplary business information model ontology consistent with our present travel discussion example. In particular, this business information model ontology is a travel ontology schema 1700,1800 for making a car rental reservation. Turning first to FIG. 17 and by way of example and not limitation, this car rental schema 1700 has a number of class properties (objects) illustrated. For example, as with schema 1500 (from FIG. 15), it is readily apparent that this exemplary schema 1700 is a Travel Service 1702 class and that Car Rental 1704 is a service type of the Travel Service 1702. The two primary properties of this schema, however, are the Requested Car Rental 1710 and Actual Car Rental 1750, each of which is defined to be a subclass of Car Rental 1704.

The Requested Car Rental class 1710 is further defined to have its own properties, as follows: City 1726, Date 1724, and Car Type 1722. Actual Car Rental 1750 is also defined having a possible rental relationship to Requested Car Rental 1710. The Actual Car Rental class 1750 likewise is defined to have its own properties (many of which overlap with the properties of the Requested Car Rental 1510), as follows: City 1726, Date 1724, Car Type 1722, Dollar Amount 1774, and Rental Agency 1772.

In this particular example, none of the above properties of Requested Car Rental 1710 and Actual Car Rental 1750 have any further sub-properties.

FIG. 18 illustrates the travel ontology schema 1700 from FIG. 17 in a DAML-described XML representation 1800. Thus, the car rental schema 1800 has a class relationship to Travel Service 1802 class and Car Rental 1804 has a service type relationship to the Travel Service 1802. The two primary properties of this schema, however, are the Requested Car Rental 1810 and Actual Car Rental 1850, each of which is defined to be a subclass of Car Rental 1804.

As shown in Section 1806, the Requested Car Rental 1810 is further defined to have its own properties, as follows: a pick up relationship to the City 1826, a drop off relationship to the City 1826, a pick up date relationship to Date 1824, a drop off date relationship to Date 1824, a car type relationship to Car Type 1822, and a possible rental relationship to the Actual Car Rental 1850. As shown in Section 1808, the Actual Car Rental 1850 likewise is defined to have its own properties (many of which overlap with the properties of the Requested Car Rental 1810), as follows: a pick up relationship to the City 1826, a drop off relationship to the City 1826, a pick up date relationship to Date 1824, a drop off date relationship to Date 1824, a car type relationship to Car Type 1822, a price relationship to Dollar Amount 1874, and a from company relationship to Rental Agency 1872.

Section 1812 of FIG. 18 would further identify sub-properties, if there had been any, of some of the previously mentioned properties. Section 1814 provides a comprehensive listing and structure for each of the predicates (e.g., pick up, drop off date, price, etc) used to related each subject-object pair identified in FIGS. 17 and 18.

Turning now to FIGS. 19A, 19B, and 19C, three exemplary transformation ontologies 1900a, 1900b, and 1900c associated with the current travel discussion example are illustrated in DAML-described XML representations. With quick reference to FIG. 19D, an exemplary ontology schema 1900d that provides, at a high level, the RDF triples necessary to implement the three transformation ontologies in FIGS. 19A, 19B, and 19C, is illustrated. The three transformation ontologies 1900a, 1900b, and 1900c are essentially the same, with each successive transformation ontology (in FIGS. 19B and 19C) adding yet further complexity to the example ontology 1900a from FIG. 19A. More specifically, FIG. 19A illustrates a simple transformation ontology with simple definition (i.e., conceptual binding) of the properties of an instance of the airline reservation web service (in this case, the Travelcom instance 1300a from FIG. 13A) in terms of a relevant business information model ontology (in this case, the airline reservation schema 1600 from FIG. 16).

Specifically, FIG. 19A illustrates six transformations that result from the process of marking up the operations and parameters of an instance of the airline reservation web service (in this case, the Travelcom instance 1300a from FIG. 13A). For example: (i) the Travelcom attribute Departure 1912 (1332 from FIG. 13A) is defined to be an “exact match” 1914 to the DepartureDate attribute 1916 (1624 from FIG. 16) from the airline reservation schema; (ii) the Travelcom attribute Return 1922 (1334 from FIG. 13A) is defined to be an “exact match” 1924 to the ReturnDate attribute 1926 (1622 from FIG. 16) from the airline reservation schema; (iii) the Travelcom attribute Destination 1932 (1336 from FIG. 13A) is defined to be an “approximate match” 1934 to the ArrivalAirport attribute 1936 (1632 from FIG. 16) from the airline reservation schema; (iv) the Travelcom attribute Origin 1934 (1338 from FIG. 13A) is defined to be an “approximate match” 1944 to the DepartureAirport attribute 1946 (1634 from FIG. 16) from the airline reservation schema; (v) the Travelcom attribute Airline 1952 (1340 from FIG. 13A) is defined to be an “approximate match” 1954 to the Requested Airline attribute 1956 (1662 from FIG. 16) from the airline reservation schema; and (vi) the Travelcom attribute Flight 1962 (1342 from FIG. 13A) is defined to be an “exact match” 1964 to the Actual Itinerary attribute 1966 (1650 from FIG. 16) from the airline reservation schema.

Again, as stated above, FIG. 19B is essentially identical to that of FIG. 19A; however, transformation ontology 1900b includes a syntactic transformation 1910 and a semantic transformation 1920, which will be described hereinafter. A syntactic transformation is merely a data syntax or format rearrangement, such as the addition or removal of punctuation or the mere rearrangement of data, which may be necessary for such data to be readable or understandable by a web service or other computer resource. In this particular example, the syntactic transform 1910 is a date format transformation called Date Transform 1976 that converts dates from a DDMMYY (European) format 1902 to a MMDDYYYY (American) format 1904. The date transformation actually occurs by means of a process or function call to a specified file location 1906, which, in this example, is a URL. Transformation functions are registered, marked-up, and stored as services within the system. Specific transformation functions are bound to the concept attribute in the ontology. Function calls query the ontology for parameter configuration resulting in a format translation.

Turning briefly to FIG. 19D, an exemplary transformation fragment 1950 from an ontology describes date structures and their syntactical transformation. It should be understood that the various properties defined in FIG. 19D each contain a reference to the transformation markup URL for linking purposes with the ontologies from FIGS. 19A, 19B, and 19C. Date 1951 is described as a class, which has format of Format 1953. Formats 1953 are classes that contain a format specification 1955. Four potential format specifications are illustrated consisting of MMDDYYYY, MMDDYY, DDMMYYYY, and DMMYY. For example, referring to both FIGS. 19B and 19D, Date 1951 has as a property Format 1953, which in turn has as a syntactic transformation 1910, which is then stored in a transformation ontology 736.

Returning to FIG. 19B, a semantic transformation, in contrast, actually converts data based on some logic whether rule based or semantics. Semantic transformations require inference about concepts and their meaning based on the underlying description logic. Such transformation may be accomplished by means of querying a specific ontology sub-type, cross-referencing to look-up table, application of logical rules or formulas, a combination of the above, and the like. In this particular example, the semantic transformation 1920 creates an ontology query through an Airport Lookup Transformation 1986 and using a semantic inference “convert City to AirportCode.” The Airport Lookup Transformation 1986 converts the name of a City 1921 to an AirportCode 1923 by means of a process or function call, which itself is a service 1925 located at a specific URL.

FIG. 19D further provides a fragment 1940 from an ontology schema that describes the semantic relationships between AirportCode and City. The relevant ontology schema can be populated with instances of airport code, city, and airport name data. When populated, semantic-level queries are created and executed against the ontology, and results are returned. In the present example 1900d, the classes of city 1941, airport 1943, and airport code 1945 are defined. City 1941 is defined to have a has airport relationship to airport 1943. Airport 1943, in turn, is defined to have a has airport code relationship with airport code 1945. A semantic query, such as “Select X from #AirportCode {X}.#has_airport_Code.#airport.#has_airport.city {Y} where Y=‘NYC’” would return an airport code.

It should be understood that such process or function calls in either of the above transformations can be to any service 1925 location that is accessible by the system of the present invention; thus, such file locations may be internal or remote to the system or servers used in the present invention.

Returning to FIG. 19B, two Date Format syntactic transformations 1975 occur as part of the simple transformation performed for the Travelcom attribute Departure to the DepartureDate attribute from the airline reservation schema and for the Travelcom attribute Return to the ReturnDate attribute from the airline reservation schema. Likewise, two Airport Lookup semantic transformations 1985 occur as part of the simple transformation performed for the Travelcom attribute Destination to the ArrivalAirport attribute from the airline reservation schema and for the Travelcom attribute Origin to the DepartureAirport attribute from the airline reservation schema.

FIG. 19C illustrates yet a further exemplary transformation ontology 1900c, that is essentially the same as the ontology 1900b from FIG. 19B, with the addition of “default values” for two of the properties of the airline reservation schema. Default values are created during web service mark-up by the system user 151 and reflect pre-configuration of service parameters. For example, as shown in Section 1930, the DepartureAirport is defined to have a default value 1992 of “Atlanta” for this particular ontology 1900c (which could be specific to a particular individual or business, etc.). Likewise, the Requested Airline is defined to have a default value 1994 of the fictional airline “Enleague Air.”

FIGS. 20 and 21 illustrate a specific, simple example of an instance of an execution model ontology 2000, 2100, respectively, prior to service discovery. As will become apparent, no specific services are referenced in this ontology instance because the system has not yet determined which web service(s) best satisfy the specified criteria and user parameters. The execution model ontology 2000 is similarly constructed of RDF triples, and shows that the execution model 2010 is of the type Travel 2012 and contains two specific concepts that were selected by the user during the model editing process: an air reservation concept 2014 and a car reservation concept 2016. Based on the execution model, invocation of the air reservation concept will be “followed by” 2018 invocation of the car reservation concept. Each of these concepts (air reservation and car reservation) is associated with a plurality of specific properties related to the reservation and to specific preferences provided by the user as part of the execution. For example, airline reservation 2014 has properties of depart 2020, which is constrained to “Apr. 23, 2003,” requested carrier 2022, which is constrained to “EnleagueAir,” from (location) 2024, which is constrained to “Atlanta,” to (location) 2026, which is constrained to “New York City,” quality 2028, which is constrained to “greater than or equal to 4,” cost 2030, which is constrained to “less than or equal to 6,” and availability 2032, which is constrained to “always.” Further, car reservation 2016 has properties of pick up date 2040, which is constrained to “Apr. 23, 2003,” pickup (location) 2042, which is constrained to “New York City,” car type 2044, which is constrained to “Coup,” value club number 2046, which is constrained to “234-2345,” quality 2048, which is constrained to “greater than or equal to 7,” cost 2050, which is constrained to “less than or equal to 10,” and availability 2052, which is constrained to “Periodically.”

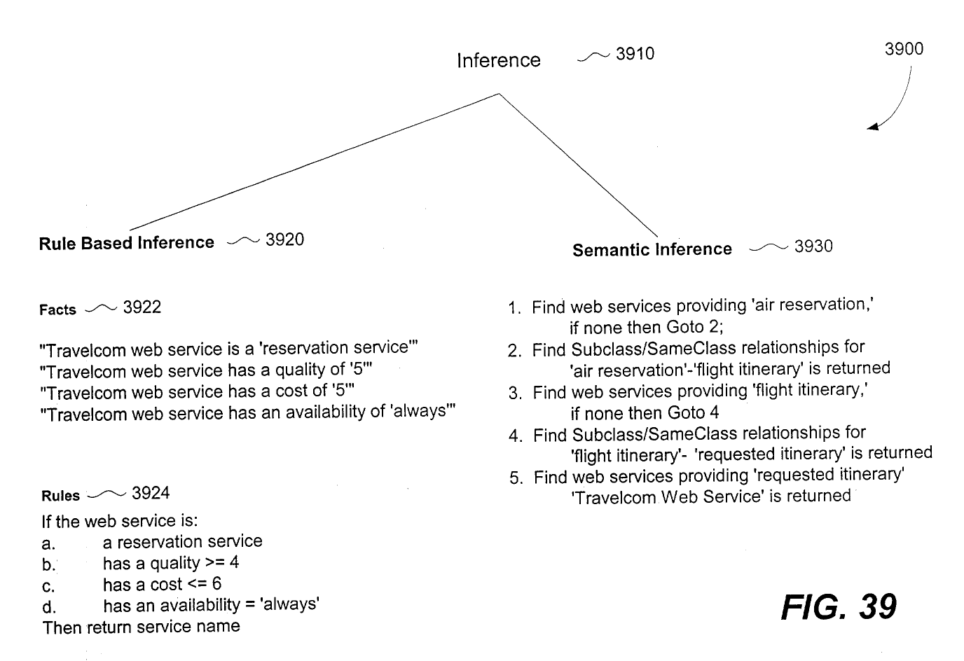

FIG. 21 illustrates the instance of the execution model ontology 2000 from FIG. 20 shown in a DAML-described XML representation 2100. Thus, the execution model ontology 2100 contains a class Execution 2110 with a specific type Travel 2112 and contains two specific concepts: an air reservation 2114 and a car reservation 2116. Based on the execution model, invocation of the air reservation concept will be “followed by” 2118 invocation of the car reservation concept. Each of these concepts (air reservation and car reservation) is associated with a plurality of specific properties related to the reservation and to specific preferences provided by the user as part of the execution. For example, airline reservation 2114 has properties of depart 2120, which is constrained to “Apr. 23, 2003,” requested carrier 2122, which is constrained to “EnleagueAir,” from (location) 2124, which is constrained to “Atlanta,” to (location) 2126, which is constrained to “New York City,” quality 2128, which is constrained to “greater than or equal to 4,” cost 2130, which is constrained to “less than or equal to 6,” and availability 2132, which is constrained to “always.” Further, car reservation 2116 has properties of pick up date 2140, which is constrained to “Apr. 23, 2003,” pickup (location) 2142, which is constrained to “New York City,” car type 2144 which is constrained to “Coup,” value club number 2146, which is constrained to “234-2345,” quality 2148, which is constrained to “greater than or equal to 7,” cost 2150, which is constrained to “less than or equal to 10,” and availability 2152, which is constrained to “Periodically.” Jumping briefly ahead to FIG. 39, it will now be helpful to understand the inference process 3910 that is implemented by the inference engine 450 during the discovery process (and during searches of the ontology storage 140) to make “leaps” of understanding and to derive and determine relationships between concepts of various ontologies. The inference process 3910 occurs through two functions. First, inference occurs through reasoning using rules (i.e., rules-based inference 3920); second, inference occurs as a result of executing indexing algorithms against ontologies for the purposes of establishing semantic relationships between concepts (i.e., semantic inference 3930). With regard to rule-based inference, rules are modeled in transformation ontologies. A rule associates one or many prerequisites with one conclusion. The rule prerequisites are also called the body of the rule; the conclusion is called the head of the rule. If prerequisites are true then the conclusion is determined to be true. Prerequisites of a rule are connected using “and” or “or.” The prerequisites and the conclusion are facts. Facts can also occur standalone, such as the statement “Travelcom Web Service provides airline reservations.” The facts themselves consist of terms and of predicates associating those terms. In ontological terminology, terms represent concepts, and predicates represent relationships between terms.

The facts 3922 are derived from the web service classification ontology and are inputs into the inference engine 450. Using the present discussion example, facts concerning the web service include: (i) “Travelcom web service is a ‘reservation service’;” (ii) “Travelcom web service has a quality of ‘5’;” (iii) “Travelcom web service has a cost of ‘5’;” and (iv) “Travelcom web service has an availability of ‘always’.”

The rules 3924 are inputs from the instance of the execution model ontology. Again, using the present discussion example, an exemplary set of rules would be: (i) If the web service is (a) a reservation service; (b) has a quality ≦4; (c) has a cost ≦6; and (d) has an availability=‘always,’ then return web service name.

With regard to semantic inference 3930, the process includes establishing semantic relationships indexing algorithms, which are used to derive relationships based on description logic. For example, class and sub-class relationships are established between concepts. Using the indexing algorithms, the system is able to return a specific super-class when a sub-class concept is provided or vice versa. Inverse relations and negation can also be returned. In the present example, the “Travel” ontology contains the class Requested Itinerary as a subClassOf Flight Itinerary, which is the sameClassAs Air Reservation. If an execution model is constructed that contains reference to an Air Reservation, since Air Reservation has no web service associated with it, the inference engine 450 looks for similar classes or subclasses and is able to trace the subclass relations to Air Reservation and return Flight Itinerary. Flight Itinerary does not have a web service associated with it, so the inference engine 450 continues to look for similar classes or subclasses, returning Requested Itinerary and Actual Itinerary. Based on the mapping to the Travelcom web service in the discussion exmaple, the inference engine 450 infers that Requested Itinerary meets the criteria for the query.

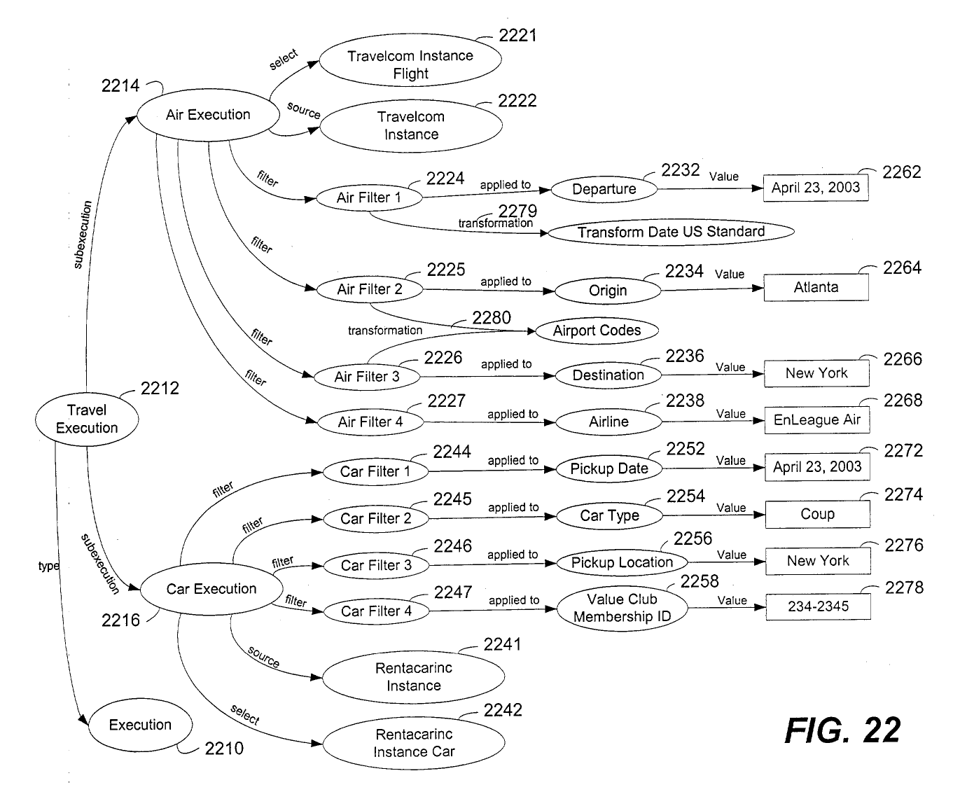

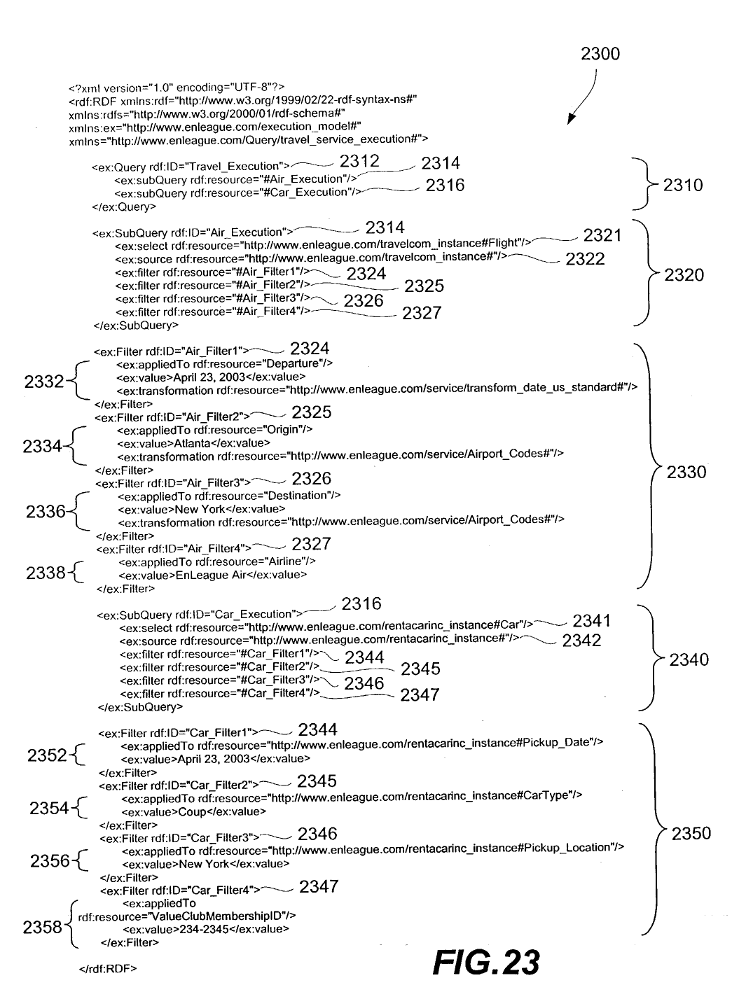

FIGS. 22 and 23 illustrate an exemplary instance 2200, 2300, respectively, of an execution model ontology after specific web services have been discovered. Thus, the execution model instance includes specific parameters available to the selected web service as well as appropriate transformations of input parameters that are understandable by the respective web service. FIG. 22 illustrates the instance of the execution model ontology 2200 in graphical format showing relationships between concepts in RDF triples. The execution model ontology 2300 of FIG. 23 illustrates the same execution model ontology in DAML-described XML representations.

Turning first to FIG. 22, this particular instance 2200 of an execution model 2210 is defined to be a Travel Execution 2212 model. Travel Execution comprises or includes two sub-executions: Air Execution 2214 and Car Execution 2216.

The Air Execution 2214 sub-execution model defines the selected service of Travelcom “Flight” Instance web service 2221, which was identified as the “best” available web service that satisfied the user criteria and which is located at the source of the specific URL 2222. The model contains four parameters which are displayed as properties. Associated with the four parameters are filters (or configured parameters) that will be provided to the instance of the Travelcom airline reservation web service. These four filters are relationship to Air Filter1 2224, Air Filter2 2225, Air Filter3 2226 and Air Filter4 2227.

Air Filter1 is applied to the Departure 2232 input for the Travelcom web service, which is set to a value 2262 of “Apr. 23, 2003.” The value 2262 requires a transformation function 2279, which converts the date to an appropriate format for the Travelcom web service. Air Filter2 is applied to the Origin 2234 input for the Travelcom web service, which is set to the value 2264 of “Atlanta.” The value 2264 requires a transformation function 2280 to transform the city code to an appropriate airport code. Air Filter3 is applied to the Destination 2236 input for the Travelcom web service, which is set to the value 2266 of “New York.” The value 2264 also requires a transformation function 2280 to transform the city code to an appropriate airport code. Air Filter4 is applied to the Airline 2238 input for the Travelcom web service, which is set to the value 2268 of “Enleague Air.”

The Car Execution 2216 sub-execution defines the selected service of RentaCarlnc “Car” Instance web service 2242, which was identified as the “best” available web service that satisfied the user criteria and which is located at the source of the specific URL 2241. The model contains four parameters which are displayed as properties. Associated with the four parameters are filters (or configured parameters) that will be provided to the instance of the RentACarInc car rental web service. These four filters are relationship to Car Filter1 2244, Car Filter2 2245, Car Filter3 2246, and CarFilter4 2247.

Car Filter 1 is applied to the Pickup Date 2252 input for the RentACarInc car rental web service, which is set to a value 2272 of “Apr. 23, 2003.” Car Filter2 is applied to the Car Type 2254 input for the RentACarInc car rental web service, which is set to the value 2274 of “Coup.” Car Filter3 is applied to the Pickup Location 2256 input for the RentACarInc car rental web service, which is set to the value 2276 of “New York.” Car Filter4 is applied to the Value Club Membership ID 2258 input for the RentACarInc car rental web service, which is set to the value 2278 of “234-2345.”

Turning now to FIG. 23, the execution model 2200 of FIG. 22 is now illustrated in DAML-described XML representation 2300. This particular Execution Model 2310 is defined to be a Travel Execution 2312 subexecution. Travel Execution comprises or includes two subexecutions: Air Execution 2314 and Car Execution 2316.

The Air Execution 2314 subexecution is defined, as shown by Section 2310, as consisting of the selected service of Travelcom “Flight” Instance web service 2321, which resulted from service discovery phase and which is located at the source of the specific URL 2322. The model contains four parameters, which are displayed as properties. Associated with the three parameters are filters (or configured parameters) that will be provided to the instance of the Travelcom airline reservation web service. These four filters are relationship to Air Filter1 2324, Air Filter2 2325, Air Filter3 2326, and Air Filter4 2327.

The four Air Filters are further described and defined at section 2330. More specifically, Air Filter1 is applied 2332 to the Departure input for the Travelcom web service, which is set to a value of “Apr. 23, 2003.” Air Filter2 is applied 2334 to the Origin input for the Travelcom web service, which is set to the value of “Atlanta.” Air Filter3 is applied 2336 to the Destination input for the Travelcom web service, which is set to the value of “New York.” Air Filter4 is applied 2338 to the Airline input for the Travelcom web service, which is set to the value of “Enleague Air.” It should be noted that the first three Air Filters each include a transformation XML line of code so that the actual values passed to the Travelcom web service will be converted into a format or convention acceptable and understandable by the Travelcom web service (i.e., Date Transformation, Airport Code Transformation, and Airport Code Transformation, respectively).

The Car Execution 2316 subexecution, as shown by Section 2340, defines the selected service of RentaCar Inc Car instance web service 2341, which resulted from the service discovery phase and which is located at the source of the specific URL 2342. The model contains four parameters, which are displayed as properties. Associated with the four parameters are filters (or configured parameters) that will be provided to the instance of the RentACarInc car rental web service, as specified by XML line 2342. These four filters are relationship to Car Filter1 2344, Car Filter2 2345, Car Filter3 2346, and CarFilter4 2347.

The four Car Filters are further described and defined at section 2350. More specifically, Car Filter 1 is applied 2352 to the Pickup Date input for the RentACarInc car rental web service, which is set to a value of “Apr. 23, 2003.” Car Filter2 is applied 2354 to the Car Type input for the RentACarInc car rental web service, which is set to the value of “Coup.” Car Filter3 is applied 2356 to the Pickup Location input for the RentACarInc car rental web service, which is set to the value of “New York.” Car Filter4 is applied 2358 to the Value Club Membership ID input for the RentACarInc car rental web service, which is set to the value of “234-2345.”

Screen Shots

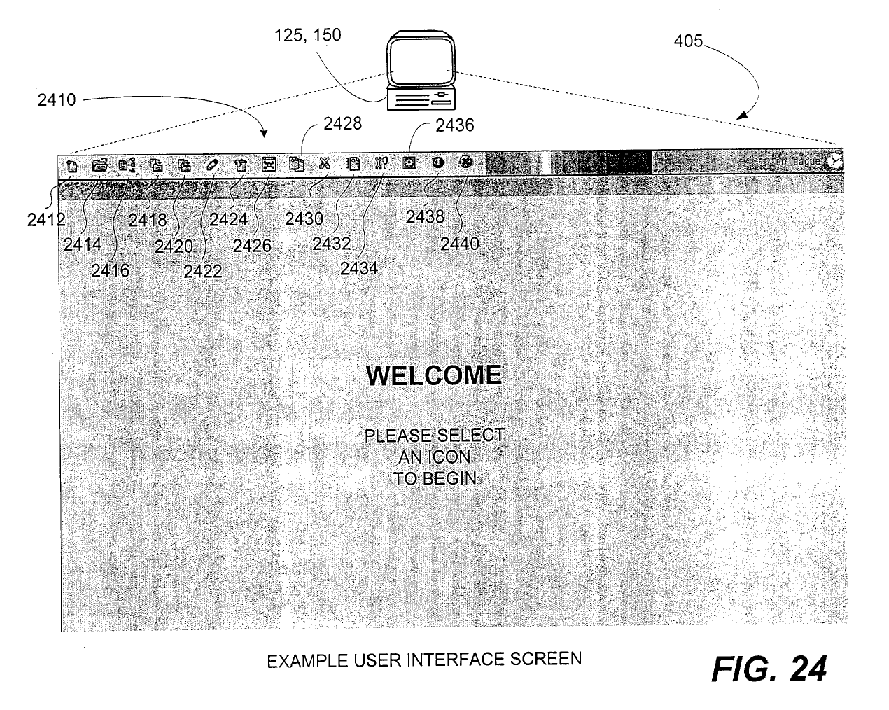

FIGS. 24-38 are examples of particular user interface screens and graphical user interface components that are provided in the described and disclosed embodiments of the present invention. Those skilled in the art will understand and appreciate that these user interface screens can take various forms and layouts, and can be implemented with various input devices, such as keyboard, mouse, push button, voice activation, or other user input devices and can display appropriate information in various forms, such as display screens, printouts, audible announcements, tactile feedback, and other forms of communication of information to a human. In like manner, although the following user interface screens are providing connection with a human interface, it will of course be appreciated that many aspects of the present invention can be implemented by computer-to-computer communications wherein input information is provided automatically in a predetermined format, with output provided in return in a predetermined format, with no intervening displays to a human being to provide a totally-automated operation on a computer-to-computer basis. It will thus be understood that the following description relates solely to interactions of a human being with the computer system, typically while an end user's computer system 125 or a system user's computer system 150 accesses the system of the present invention.

FIG. 24 illustrates an initial main display screen 2400 and includes a row of control icons 2410 that execute, when activated in conventional manner, various functions associated with the present mentioned embodiments thereof. For example, NEW icon 2412 enables the user to create new business information models, computer resource models, users and companies, resource logs, message queues, message subscribers, monitoring events, etc.; FILE OPEN icon 2414 opens existing business information models resource models, user, company, log, queue, subscriber, events, etc; OPEN PALETTE icon 2416 opens modeling palettes, including resource, query, rules, ontology; SAVE icon 2418 saves models; SAVE AS icon 2420 saves models with a different name; EDIT icon 2422 opens models for editing; DELETE icon 2424 deletes models; VIEW icon 2426 toggles view between palette view and system view; COPY icon 2428 copies text in conventional manner; CUT icon 2430 cuts text in conventional manner; PASTE icon 2432 pastes text in conventional manner; TOOLS icon 2434 accesses ontology management, ontology validation, query configuration, and model management function; ADMIN icon 2436 accesses administrative functions including security, user management, server management, and system monitoring; HELP icon 2438 accesses help functions in conventional manner; and LOGOUT icon 2440 performs system logout in conventional manner.

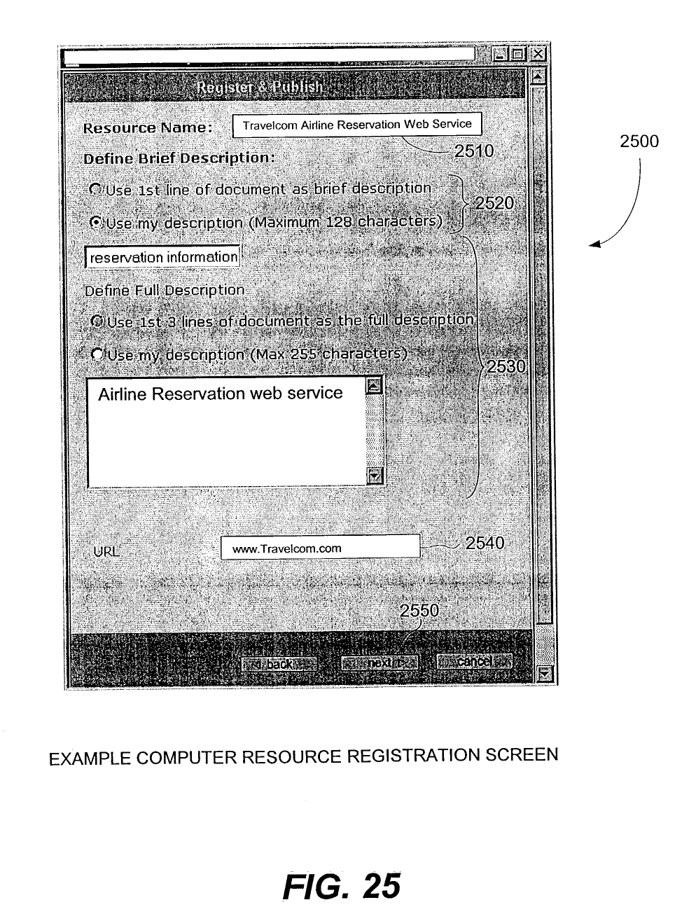

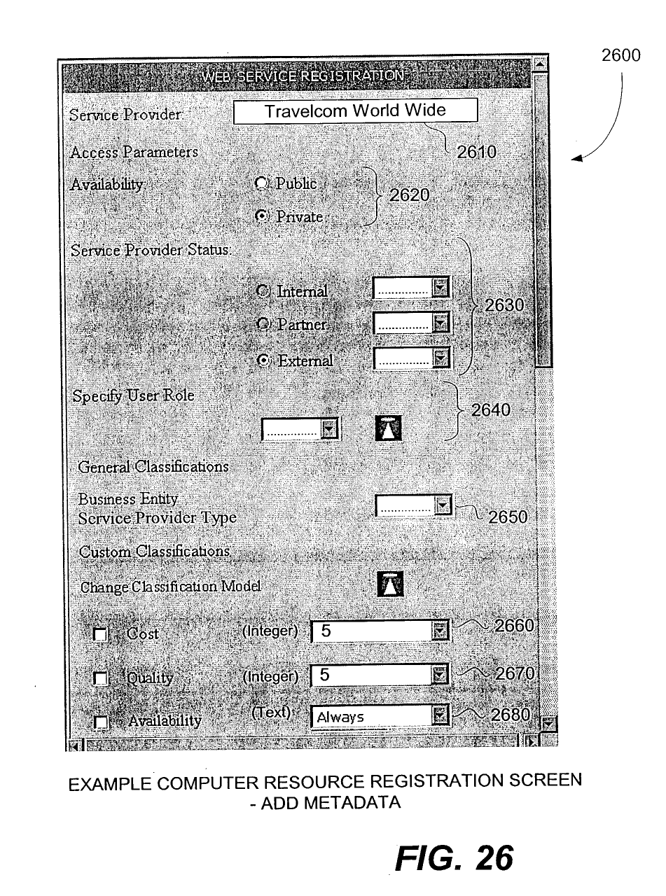

FIG. 25 illustrates a first registration display screen 2500 that is displayed to enable a system user 151 to input information about a particular computer resource, in this case a web service, as a part of the process of registering the web service in the internal computer resource registry 142 (FIG. 1). In particular, the screen 2500 is used to input information about the resource's name, as shown in field 2510, a brief description 2520 of the web service, a detailed or full description 2530 of the resource, and the location information or URL of the web service definition associated with the resource, which is entered into field 2540. Once the NEXT button 2550 is selected, the system parses the selected web service and obtains a substantial amount of information about the web service, and the user moves to display screen 2600 of FIG. 26. Upon completion of display screen 2500 the web service structural ontology is populated with information obtained from the web service description.

FIG. 26 illustrates a second registration display screen 2600 that is displayed to a system user to allow the user to input additional information or meta data associated with the particular computer resource initially registered on the previous display screen 2500. It will be recalled from the discussion in connection with FIGS. 11 and 12 that specific information can be associated with the particular computer resource. As shown, the service provider of the relevant web service is displayed in field 2610. This information is obtained when the web service is parsed, as discussed above. The system user is also able to specify in field 2620 whether the particular web service is publicly-accessible or private. In field 2630, the user specifies the status of the service provider (i.e., whether the service provider is internal, external, or a partner of the respective system user registering the web service). In field 2640, the system user is able to specify his role. In field 2650, the system user specifies what type of service provider the business entity is. Finally, the system user is able to specify additional classification properties that the system user wants to associate with the web service—using the convenient pull down menus. As stated previously, these classifications include, in this example, Cost 2660, Quality 2670, and Availability 2680. Information obtained on screens 2500 and 2600 are used to populate instance data in the web services classification ontology 732.

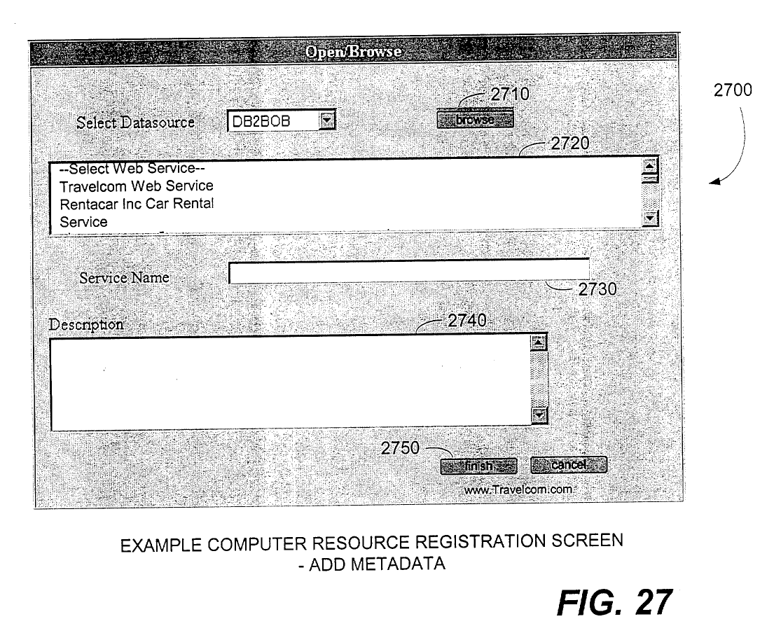

FIG. 27 illustrates a first semantic mark-up display screen 2700 that displays a list of selectable computer resources, here in the form of web services, that may be selected by a system user for further operations, in particular, as a part of the mark-up process to create ontologies associated with a particular selected web service. The system user is able to type in a web service name, if known, in field 2730 for searching or type in descriptive terms in field 2740 that may be associated with a desired web service. Selecting the browse button 2710 launches the requested search. Results of the search are displayed in field 2720 for actual selection by the user. After selection, the user selects the finish button 2750 to proceed with further with the mark-up process.

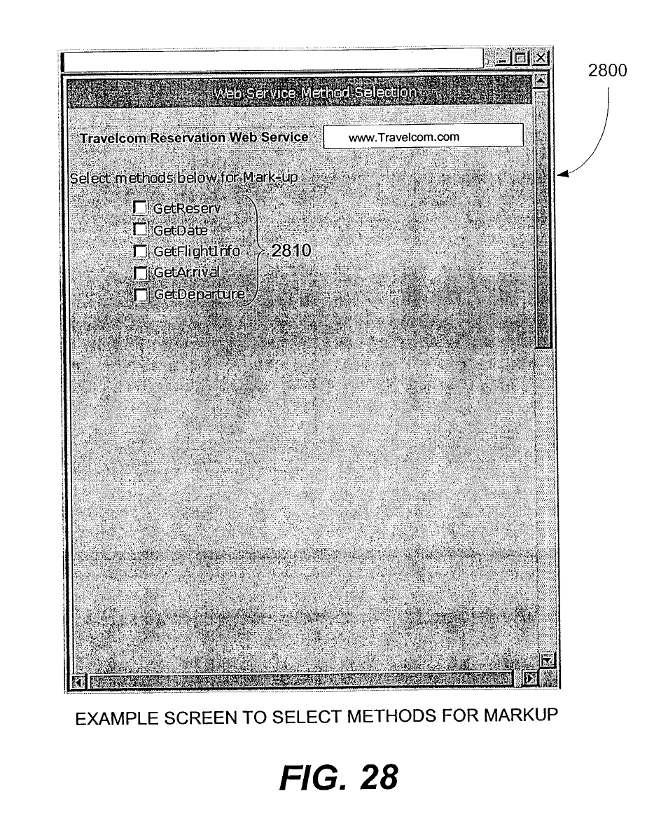

FIG. 28 illustrates a second semantic mark-up display screen 2800 that allows selection of particular methods (available for mark-up) that are associated with the particular web service selected in FIG.27.

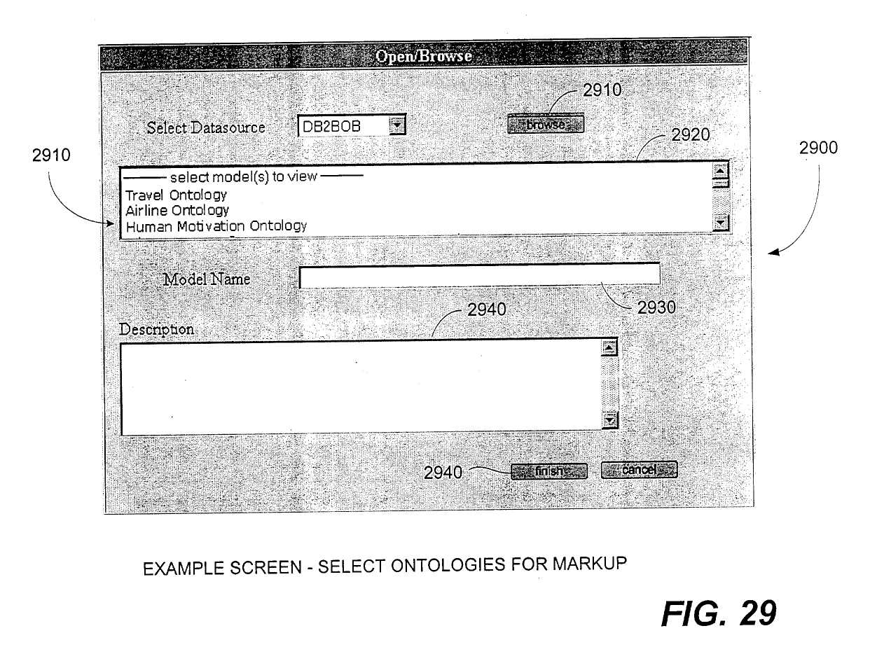

FIG. 29 illustrates a third semantic mark-up display screen 2900 that shows a list of available business information model ontologies in field 2920 that are available for association with the previously-selected web service. The available business information model ontologies are displayed after entering appropriate search criteria in fields 2930 or 2940 and selecting the browse button 2910. A selected business information model, such as the “airline ontology” (i.e., “airline reservation schema”), is selected for further operations as described in greater detail below.

FIG. 30 illustrates a fourth semantic mark-up display screen 3000 that illustrates the previously-selected business information model, the airline reservation schema, for association on an attribute-by-attribute and method-by-method manner with the previously-selected Travelcom Web Service. The region 3010 displays, in list format, the selected method 1360, and inputs 1362 and outputs 1364 of the Travelcom Web Service for mark-up. The region 3030 provides in graphical display format the various attributes of the airline reservation schema. The system user links attributes between each region by selecting one attribute from region 3010 and then its corresponding attribute in region 3030. As shown, the Departure attribute 1912 (corresponding to the same attribute from FIG. 19A) in region 3010 is selected and then linked with the Departure Date attribute 1916 (corresponding to the same attribute from FIG. 19A) from region 3030. More than one business information model may be selected and associations can be made between web service methods and input/outputs and concepts within business information models. As a result, a single attribute from a web service can be defined using multiple concepts obtained from business information models in order to capture the meaning of the particular web service element. Selecting button 3020 takes the user to the next screen.

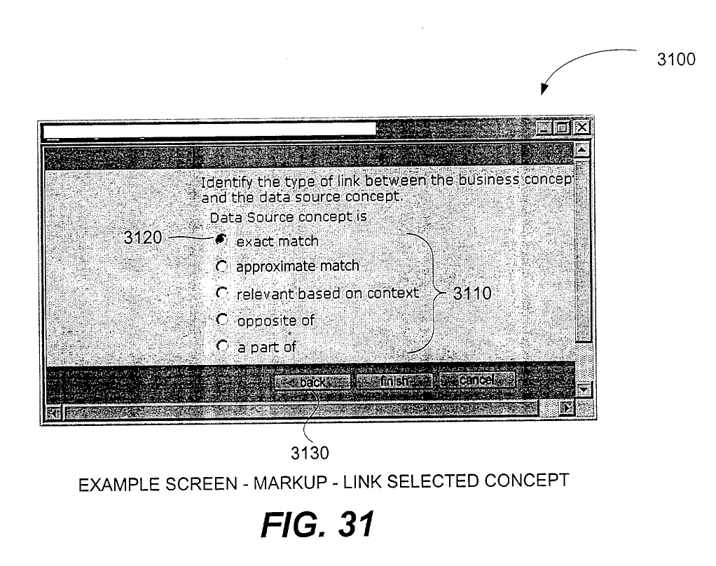

FIG. 31 illustrates a fifth semantic mark-up display screen 3100 that is displayed to the user after selection of the two attributes for association from the previous screen 3000. Several possible “types” of relationships between the two selected attributes are displayed in field 3110. In this particular example, the “exact match” relationship 3120 has been selected. Once the finish button 3130 is selected, the link between the two attributes is made and results, for example, in the automatic generation of DAML-described XML representation corresponding with that shown in FIG. 19. The process of linking or associating attributes between the web service and business information model attributes cycles between FIGS. 30 and 31 until all attributes for the particular method have been linked and a single method has been associated with concepts in one or more business information models to insure that the methods of the web service have been defined. This process can be repeated for other methods by selecting a different method from FIG. 28.

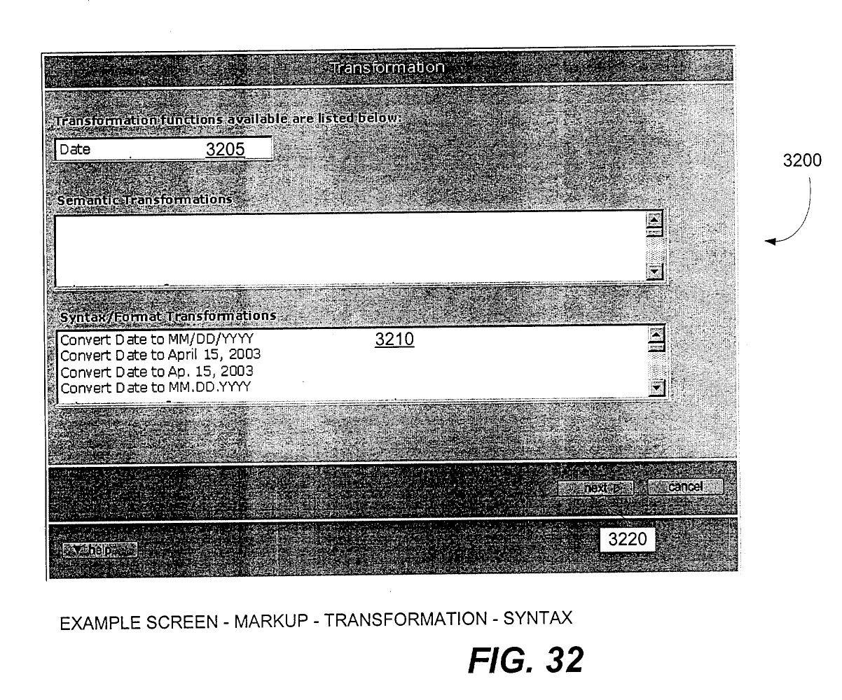

FIG. 32 illustrates a sixth semantic mark-up display screen 3200 that is displayed in connection with transformation ontology construction. In this example, the Date attribute, shown in field 3205, is identified and an appropriate syntactic transformation is selected from those relevant and available, as shown in field 3210. The user creates the transformation and moves on to the next screen by selecting the next button 3220.

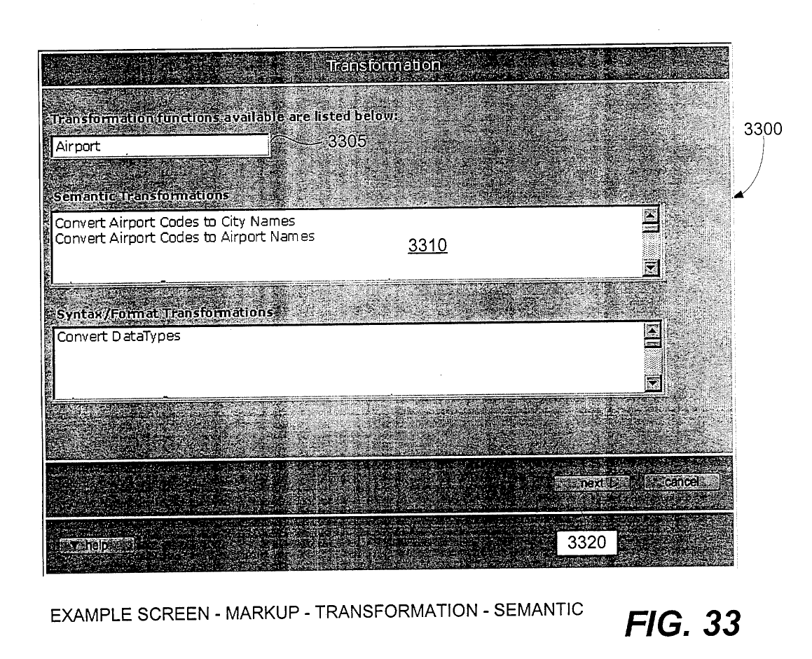

Correspondingly, FIG. 33 illustrates a seventh semantic mark-up display screen 3300 that is also displayed in connection with transformation ontology construction. In this example, the Airport attribute, shown in field 3305, is identified and an appropriate semantic transformation is selected from those relevant and available shown in field 3310. The user creates the transformation and moves on to the next screen by selecting the next button 3320.

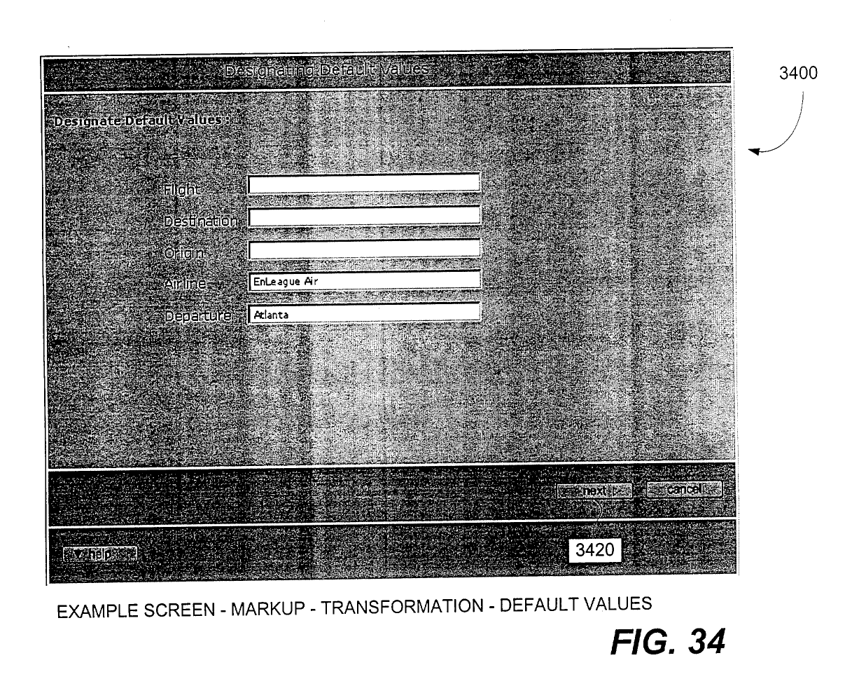

FIG. 34 illustrates an eighth semantic mark-up display screen 3400 in which the user is able to specify default values for any of the variable input parameters for a specific web service. Multiple different sets of input parameters may be specified, creating multiple instances of the service. Each of these web service instances would be registered and classified differently based on user-supplied meta-data. The specified input parameters populate the associated properties of the semantic integration model (SIM) that is being created to associate the selected web service with the selected business information model. In the example shown (and consistent with the DAML-described XML representation of FIG. 19C, “Enleague Air” is input as the default value for the Airline attribute and “Atlanta” is input as the default value for the Departure attribute. For the attributes in which no value is input, no default value is established. The user proceeds by selecting button 3420.

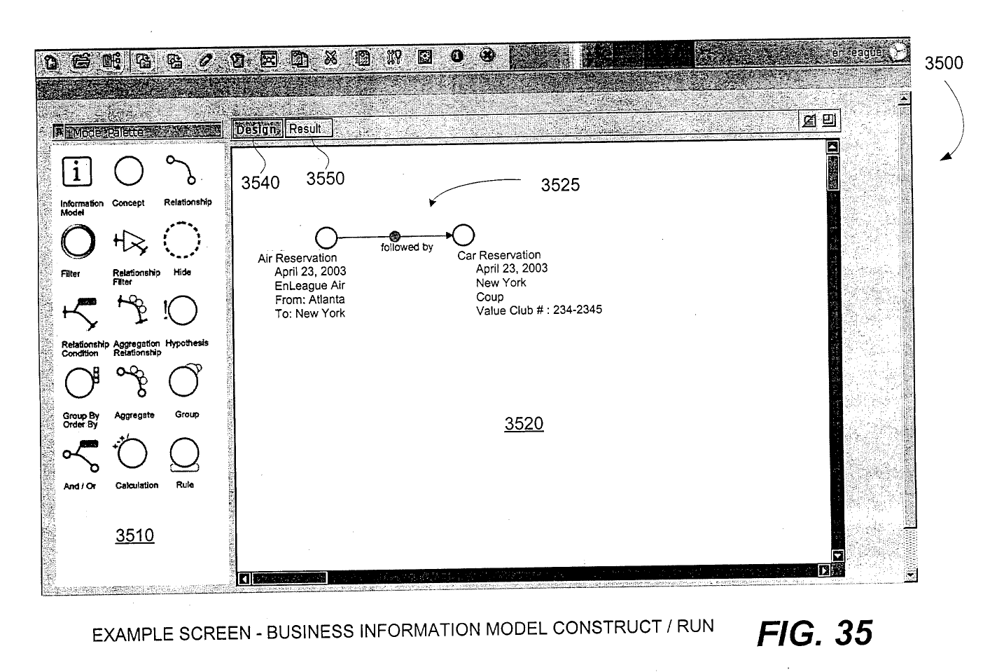

FIG. 35 illustrates a first execution model construction display screen 3500. This screen enables the user to construct a model of concepts, their relationships, and specific concept values. The user is also able to define the relationships or rules that will be applied as part of the execution of the model. It should be noted that this model defines a “pre-discovery” execution model, as discussed previously. Region 3510 provides the user with a number of different selectable icons representing various concepts and operators that can be used to construct such execution models. The user is permitted to “click and drag” icons from region 3510 and move them into region 3520 for further manipulation and arrangement. In the example in which Execution Model 3525 is shown, the user has selected two concepts: air reservation followed by a car reservation. By selecting button 3540, the user is taken to the next screen in which each concept can be further modeled to describe and define the specific concept attributes. For example, the air reservation concept may be specified by defining the airline attribute of the air reservation, as defined in the “Travel” ontology schema.

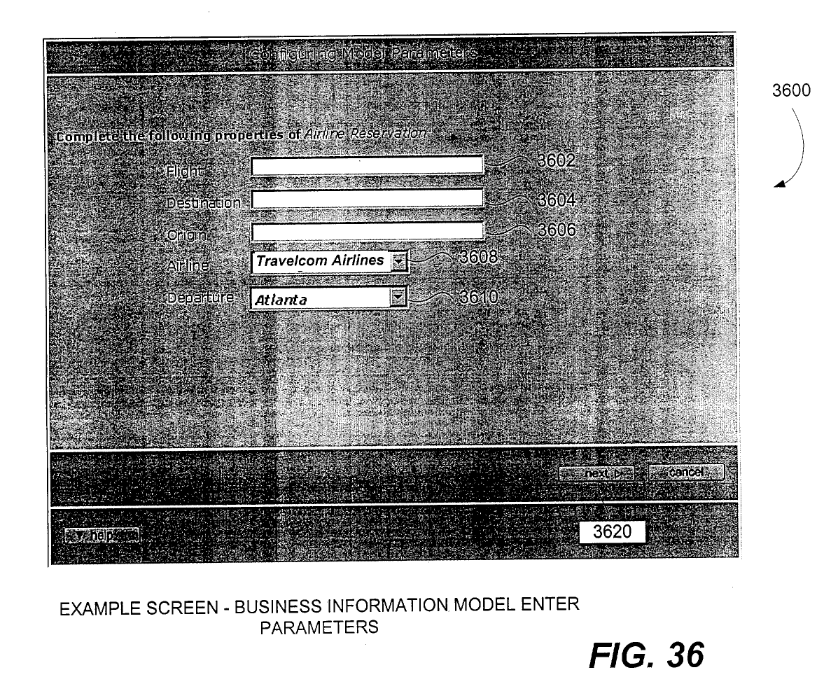

Turning now to FIG. 36, in a follow-up construct execution model display screen 3600, the user is prompted to input model parameters for the first concept: air reservation. As shown, previously-selected default values are pre-filled into the appropriate fields 3608,3610; however, the user is free to override or change these default values, if desired, for this particular execution model. The user is also able to input other non-default parameters into fields 3602,2604,3606. By clicking on the next button 3620, the user is taken to an almost identical screen (not shown) in which the user is able to input configuration parameters for the next concept: car reservation. This process is repeated for any other concepts or models that have been selected for use in the execution model of FIG. 35.

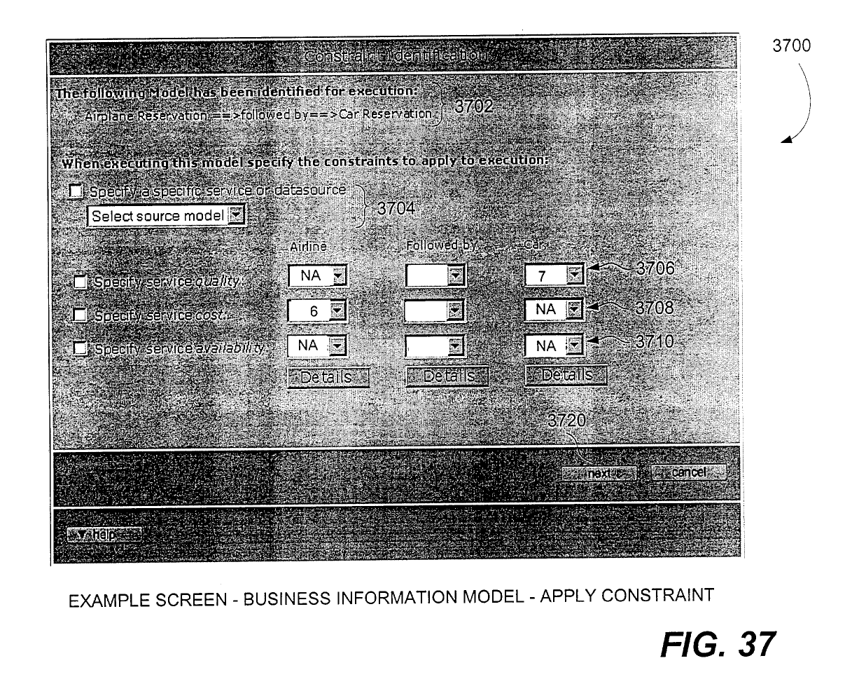

FIG. 37 illustrates a final execution model display screen 3700. The model, as currently formed, is displayed to the user in field 3702. In field 3704, the user is able to specify a particular web service or data source against which the present execution model will run. In the absence of a selection, the system will conduct a discovery process, as previously described, and then invoke the execution model against the web service that best satisfies all proscribed criteria and parameters. In fields 3706,3708, and 3710, the user is able to specify minimum (or maximum) classification values for the web services against which the execution model will run. As shown, the user has requested that the specified that the chosen airline reservation service have a costs of 6 or lower and that the chosen car reservation service have a quality of 7 or greater. All other fields remain unspecified and will not help or hinder the search for appropriate web services. By selecting the next button 3720, the user returns to screen display 3500 of FIG. 35. This time, on the display screen 3500, the parameters selected by the user are displayed along with each sub-execution. Here, for air reservation, the user has requested a flight on Apr. 23, 2003 on Enleague Air from Atlanta to New York. For car reservation, the user has requested a pickup of a Coup on Apr. 23, 2003 in New York and the user's membership ID, if applicable, is 234-2345. The user selects the results button 2550 to discover the best web services to satisfy the query (and subqueries) and to invoke the execution model against those particular web service.

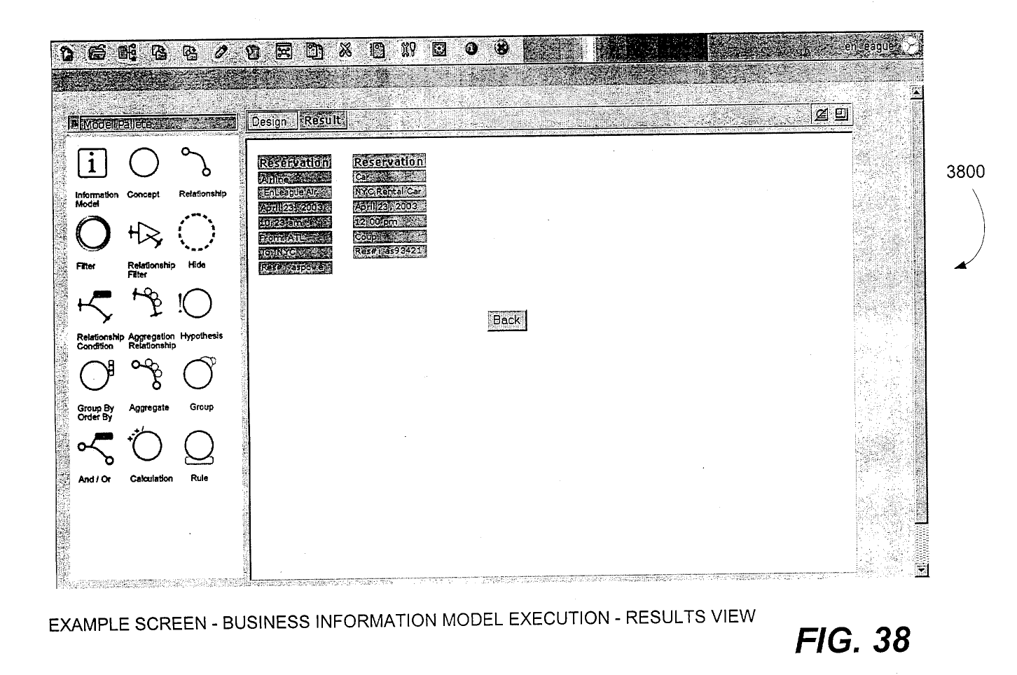

FIG. 38 illustrates a display screen 3800 that is generated to provide a “results view” of the execution of the query from the selected execution model. In this specific example being discussed, the net result of accessing the airline reservation service and the car reservation service, with particular restraints and parameters, results in a specific reservation on a specific airline and a specific reservation for a car from a particular car rental agency.

Although screen displays shown in FIGS. 24-38 are merely an example in the travel context, those skilled in the art will understand and appreciate that information and format and content displayed in each of these screen may likewise be displayed in many different manners and that no limitations are intended by the particular display shown in connection with FIGS. 24-38.

Sequence Diagrams

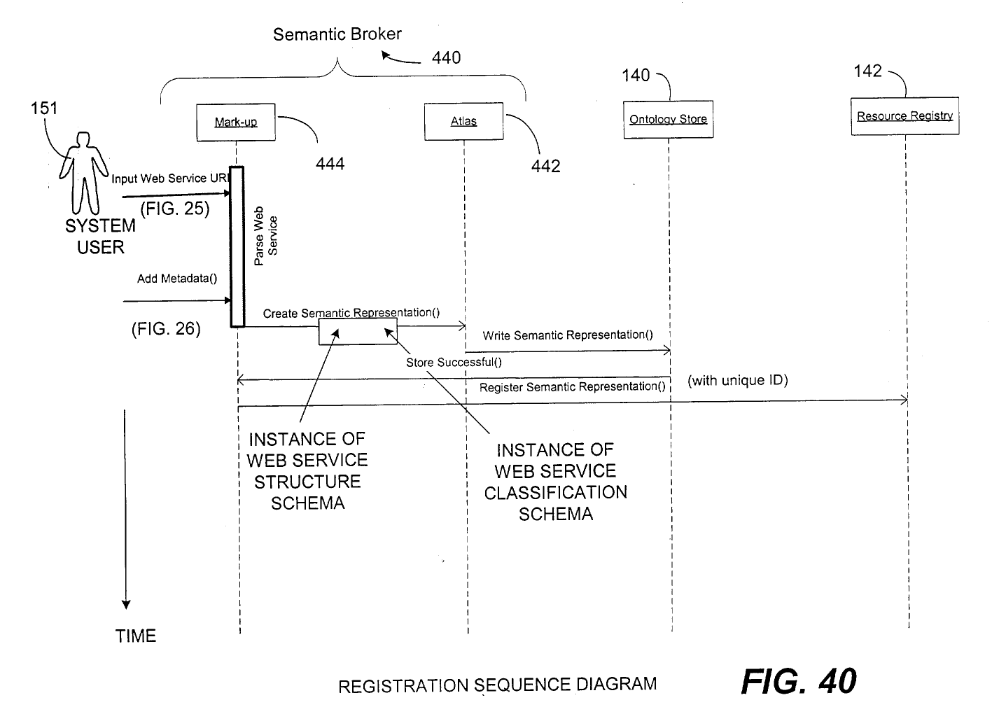

Turning now to FIGS. 40-46, sequence diagrams illustrating the various communications between the computer programs and modules of FIG. 4, and the preferred sequences of the same for an exemplary embodiment of the system and methods of the present invention are illustrated. It will be understood and appreciated by those skilled in the art that the sequence diagrams further illustrate the various inputs that trigger the processes, the various software components or modules that are executed to carry out specific computing tasks, and the results that are returned to reflect the execution of the specific sub-processes described in the individual figures. Those skilled in the relevant art will understand how to write computer program code to carry out the methods and functions of the various components shown in FIG. 4 by following the temporal sequence of these FIGS. 40-46. It should be understood that, for these FIGS. 40-46, time “begins” in the upper left hand corner of the diagram and extends downwardly, while the various computer program or components that are executed and the sequence in which such components executed carry across the top of the diagram.

FIG. 40 illustrates the registration process wherein a particular web service is input by the system user 151 and captured by the system, with the net result being storage of information corresponding to the particular web service in the resource registry 142 and creation of a semantic representation of the web service in the ontology storage 140. The first step taken is the inputting of an appropriate URL that references the web service definition of the particular web service, as discussed previously. The URL is provided to the mark-up component 444. The particular URL may be input directly by the system user 151 if he or she is aware of the URL or the system user 151 may select from a list of available web services through the screen 2500 (FIG. 25).

The mark-up component 444 is operative to access the particular web service and parse input and output information so as to create a semantic or XML representation of the particular web service. The next step is for the user 151 to input additional information about the web service (meta data) associated with the selected web service, for example through a screen display such as 2600 (FIG. 26). The mark-up component 444 is responsive to create a particular instance of the web service in a semantic representation of the web service, defined by a structural and classification schema, similar to that shown in FIG. 13B.

This semantic representation is then stored in two different locations in two different but complementary formats. Specifically, the Atlas component 442 is operative to receive and parse the semantic representation into RDF triples and store the web services structural and classification ontology in the ontology store 140. Upon return of a successful storage operation from the ontology store 140 to the mark-up component 444, the mark-up component 444 is responsive to provide appropriate data corresponding to the particular web service in UDDI-compliant format to the internal resource registry 142. Further, it should be understood that each particular registered representation of a web service contains a unique identifier, as shown and described in connection with FIG. 4, so that each entry in the ontology store 140 and resource registry 142 is unique and able to be cross-referenced.

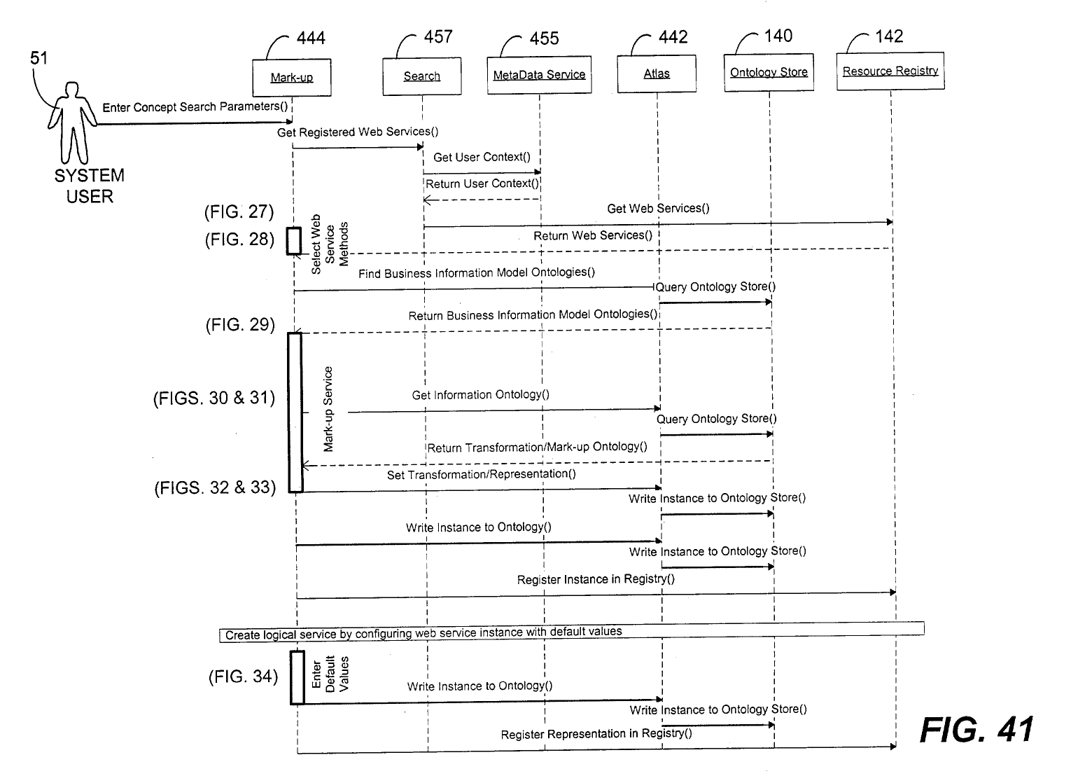

In summary, FIG. 41 illustrates the semantic mark-up process wherein a system user 151 searches for available web services in the resource registry, searches for business information models that would be applicable or useful in conjunction with describing and defining the form, purpose, and function of a particular web service, creates associations between respective properties of the web service and the selected business information model in order to describe the web service properties thereby generating a Semantic Integration Model (SIM) that will then be available for subsequent “discovery” queries and, ultimately, for subsequent invocations of execution models that perform complex computing processes by means of web services and other computer resources.

First, the system user 151 initiates a search based on particular concepts and search parameters, using the vernacular that the system user believes may result in retrieving the web services that the system user desires to mark up. The system user inputs certain parameters that are passed to the mark-up module 444 (using a display screen such as that shown in FIG. 27), which in turn provides these parameters to the search module 457. The search module 457 is responsive to pass a message to the metadata service 455 to retrieve the system user's “context.” The user context identifies what web services the user is entitled (or not entitled) to receive, access and mark-up and what web services are relevant (or not relevant) to the particular system user in response to the search request. Such context information is returned by the metadata service 455 to the search module 457. The search module applies the user context information to filter the search criteria, which search is then run against the resource registry 142 to identify relevant web services. The list of web services identified by the search is returned to the mark-up component 444 (and displayed to the user, for example, as shown in field 2720 of FIG. 27). After the user selects the desired web service, the instance data contained in the web service structural ontology for the service is returned to the Markup module 444. The user selects a desired method or operation provided by the web service for mark up (see e.g. FIG. 28).

The next step taken is the location of applicable business information model ontologies for association with the selected web service ontology. The mark up component 444 communicates with the Atlas 442, which responds by querying the ontology store 140 to retrieve any pre-stored business information models that may be relevant for association with the ontological model of the selected web service. The user's context is applicable in filtering, if necessary, what business information models are available to the system user and, thus, returned to the markup component 444. The user then associates properties of the ontological model of the web service with relevant concepts of the business information models to create a binding therebetween, as shown in FIGS. 30-31. If necessary, the markup component 444 requests transformation ontologies (see, e.g., FIGS. 32-33) from the Atlas 442, which in turn, queries the ontology store 140 for the same, which then responds by returning any appropriate transformation/mark up ontologies to the mark up component 444. After entering any applicable information necessary for associating the transformation ontology with the properties of the web service, the mark up component 444 sends such meta data to the Atlas 442, which writes the information to the ontology store 140. The mark up component 444 also registers the transformation ontology in the resource registry 142. If desired, the user is also able to specify default values (see FIG. 34) for any of the “input” properties of the web service. Once the user is finished configuring the association between the web service and the business information model(s), a SIM model is created. The mark up component 444 sends such SIM model to the Atlas 442, which writes the information to the ontology store 140. The mark up component 444 also registers the SIM model in the resource registry 142 and meta-data is bound to the model to create classification information. Classification information may include such information as when and how the SIM model should be used. Specifically, relevant business contexts, such as business processes or integration efforts, for defining the web service may be defined.

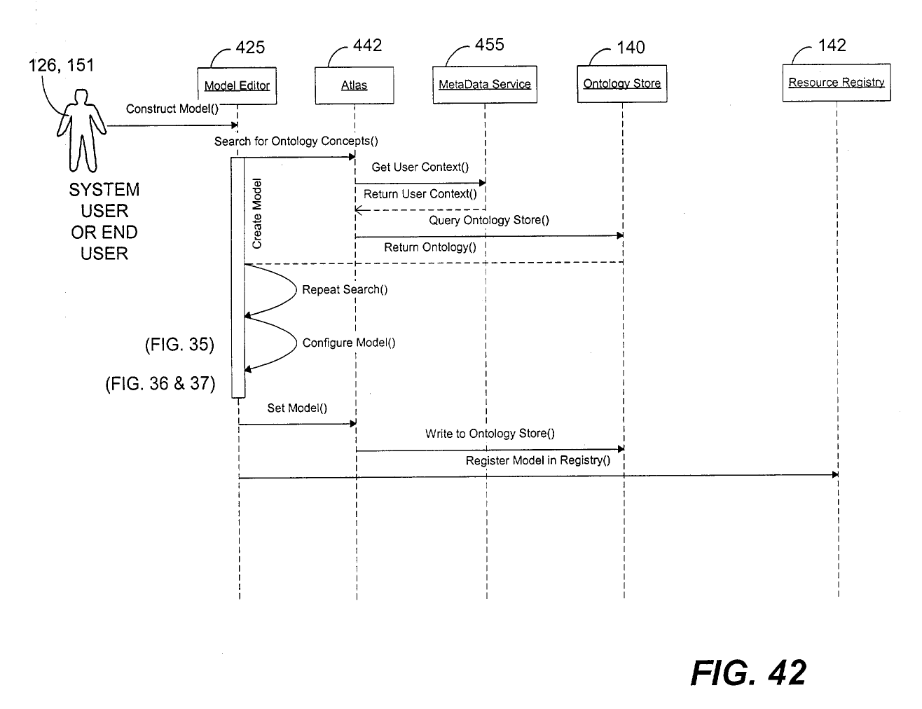

FIG. 42 illustrates the execution modeling process wherein a system or end user 151,126, respectively, retrieves pre-stored business information models (or concepts), configures and inputs parameters for invoking the same, and combines, assembles, or chains multiple such business information models or concepts to create a complex computing task. In particular, the user initiates the execution modeling process by launching the model editor component 425. The user then enters any desired search terms into a search display screen. The model editor 425 passes the search terms to the Atlas 442, which responds by retrieving any appropriate user context from the metadata service 455, which, in turn, returns any applicable user context information, such as access privileges to the particular business information models and ontology concepts.

The Atlas component 442 uses the user context information to construct an appropriate query to the ontology store 140, limited by any applicable user context information provided by the metadata 455. Any retrieved business information models or ontology concepts are returned in the form of the ontologies (and concepts) that will be available to the user for creation of an execution model. Once the user has retrieved all desired business information models and concepts (after one or multiple searches), the user proceeds to the model editor graphical display screens, such as those shown in FIGS. 35-37, to configure an execution model. Upon completion of any edits to the execution model, the model editor 425 “sets” or “saves” the execution model by communicating with the Atlas 442, which writes the model to the ontology store 140. The model editor 425 also registers the execution model in the resource registry 142. During the registration of the execution model, the user binds meta-data to the execution model instance which provides index and classification information to assist in model discovery. Further, the registration process creates a unique identifier for the model so that the model can be invoked at a future time by a system 128 or system user 151 who passes the model identifier as a parameter. Thereafter, the created or edited execution model ontology is available for further utilization by others, or further access by the user.

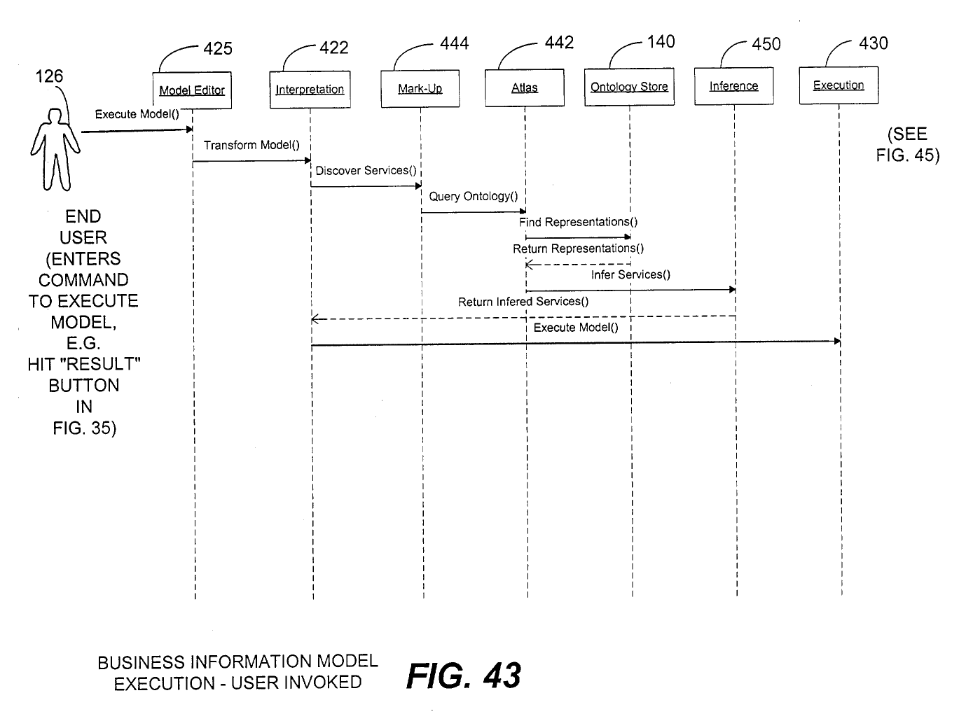

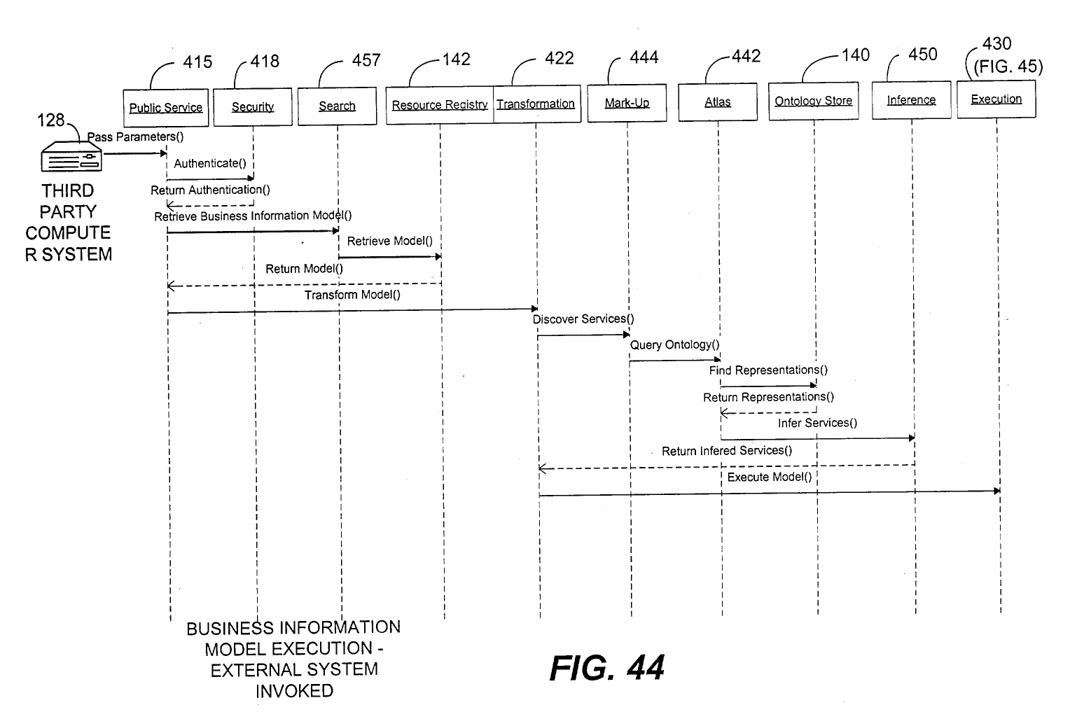

FIG. 43 illustrates the model execution process that is invoked by an individual user, as contrasted with the system-invoked model execution process (which will be discussed in association with FIG. 44 hereinafter) In FIG. 43, a particular execution model is retrieved and displayed by the model editor 425 in a graphical display, such as the display screen shown in FIG. 35. The user initiates the process, for example, by selecting button 3550 (from FIG. 35). The model editor 425 communicates with the interpretation module 422, which “holds” the execution model until the “discovery process,” described hereinafter, has been completed. The purpose of the discovery process is to identify which of the available web services best satisfies the criteria and parameters specified by the user, as has already been discussed at length.

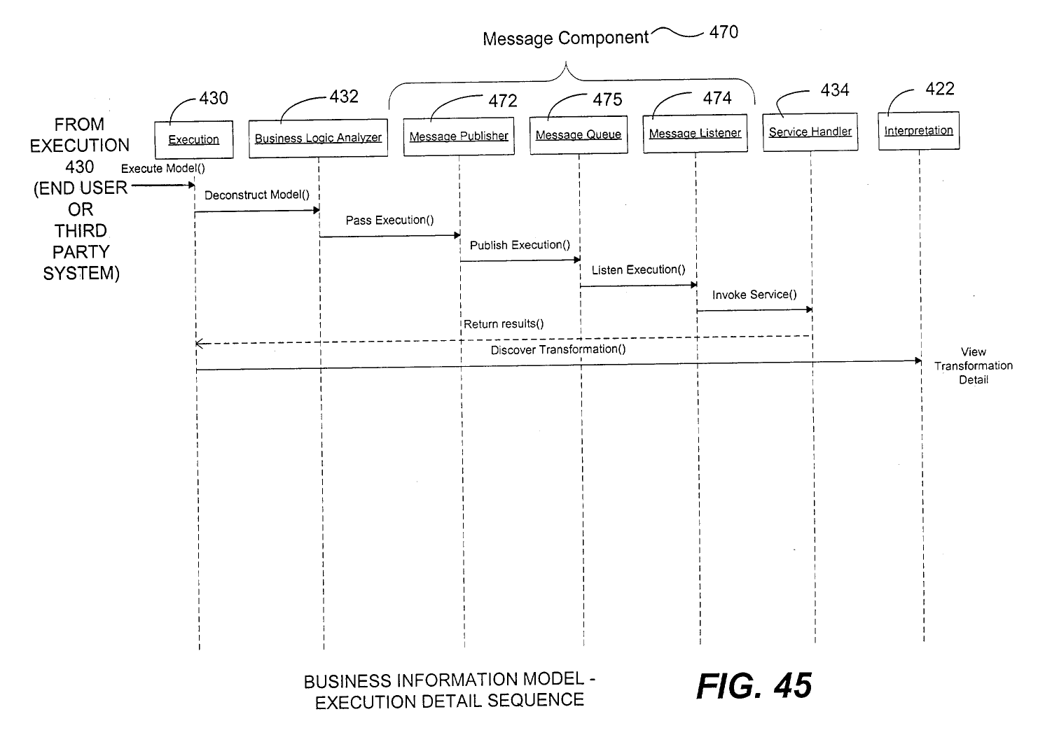

To perform the “discovery process,” the interpretation module 422 forwards the execution model to the mark up component 444, which queries the Atlas 442 to find and retrieve web service ontologies from the ontology store 140 that have been associated, through the mark up process, with the relevant business information models. Specifically, the mark-up component 444 creates queries of relevant SIM models to determine the associations between the business information models and the web service ontologies. Web service ontologies that meet the constraints specified in the execution models will be identified based on information contained in the SIM models. The Atlas 442 then communicates with the inference module 450, which compares the parameters and restrictions requested by the user with the characteristics and classifications of each potential web service (see, e.g., discussion associated with FIG. 39). Once a “best” web service ontology has been identified by the inference module 450, such information is returned and provided to the interpretation module 422 to apply any necessary transformation ontologies to the information and parameters input as part of the execution model and as applicable to the web service identified by the inference module 450. The interpretation module 422 then forwards the execution model, with relevant transformation ontologies, to the execution model 430 (see FIG. 45).

FIG. 44 illustrates the model execution process that is invoked by a computer system, typically an external third-party computer system 128, as opposed to an individual user as described in connection with FIG. 43. The steps taken in FIG. 44 are similar to that of FIG. 43, except that certain other software components are initially invoked and executed to control the access to the system and provide for appropriate security. The third party computer system 128 triggers the model execution process by passing parameters to a public service module 415, which is computer code which provides an interface to external computer systems over a network 120. The public service 415 communicates with a security component 418 to authenticate the third party computer system 128 and confirm that the computer system 128 is authorized to access the system and execute the specified execution model. The security component 418 returns appropriate authentication and/or authorization information to the public service module 415, which responds by communicating received parameters to the search module 457. It is, of course, assumed that the parameters are sufficient to cause retrieval of a particular execution model to be executed, based on the specific and particular parameters (e.g., unique identifier or name) provided by the computer system 128. Thus, such unique identifier or name of the desired execution model is passed by the public service module 415 to the search module 457, which communications with the resource registry 142 to retrieve the identified execution model, which is returned to the public service module 415.

The public service 415 communicates with the interpretation module 422, which “holds” the execution model until the “discovery process” has been completed. To perform the “discovery process,” the interpretation module 422 forwards the execution model to the mark up component 444, which queries the Atlas 442 to find and retrieve web services ontologies from the ontology store 140 that have been associated, through the mark up process, with the relevant business information models. This is accomplished through queries of the SIM models. The Atlas 442 then communicates with the inference module 450, which compares the parameters and restrictions requested by the user with the characteristics and classifications of each potential web service. Once a “best” web service ontology has been identified by the inference module 450, such information is returned and provided to the interpretation module 422 to apply any necessary transformation ontologies to the information and parameters input as part of the execution model and as applicable to the web service identified by the inference module 450. The interpretation module 422 then forwards the execution model, with relevant transformation ontologies, to the execution model 430 (see FIG. 45).

FIG. 45 continues the execution model process described both in FIGS. 43 and 44. The execution module 430, which includes the subcomponents of business logic analyzer 432 and service handler 434, communicate with the message component 470 to carry out communications with selective web services. The process starts when the execution component 430 receives an execution model with specified web service(s) identified for invocation. The execution component 430 passes the execution model to the business logic analyzer 432, which deconstructs and parses the elements of the execution model to identify and separate the appropriate messages and parameters that need to be sent to each web service. The business logic analyzer 432 then passes the required information in the form of an execution message to the message publisher 472. The message publisher 472 then publishes a message to establish communication with the selected web service, which is stored in a message query 475 for communication out to the network 120. After a message is communicated out the network 120, a message listener component 474 is activated to “listen” or be responsive to any returned messages from the particular web service indicating that communication has been established. Once such a response is received, the message listener 474 communicates such information to the service handler 434, which then invokes the web service using the inputs and parameters of the execution model pertinent to the particular web service. The service handler 434 then receives and returns the results of the invoked web service to the execution module 430.

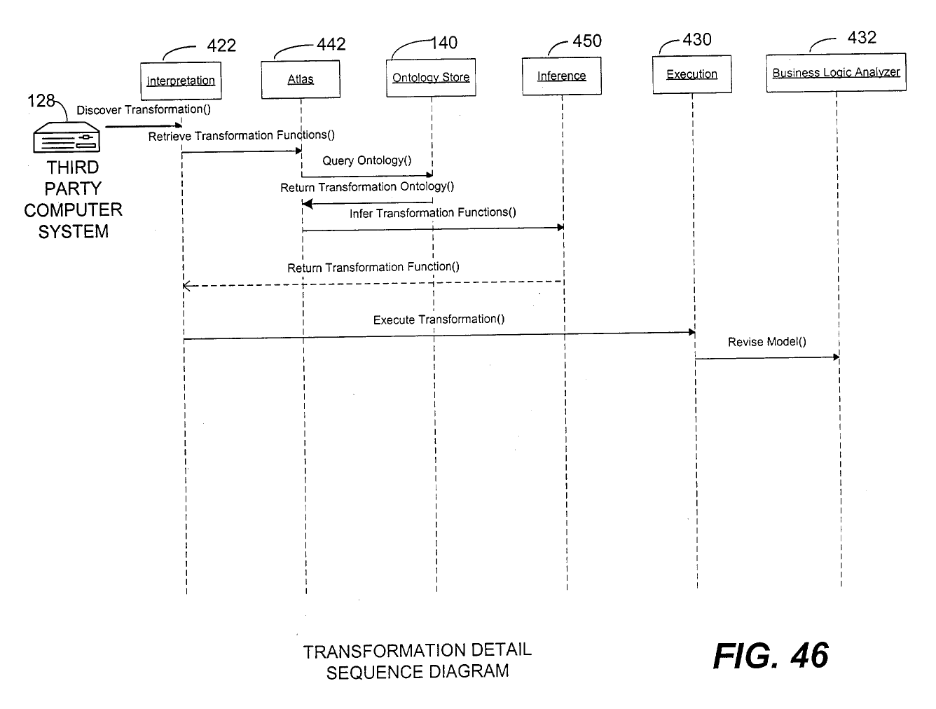

Any results returned from the invoked computing process may require a transformation operation to place them into an appropriate format required by the execution model. Accordingly, execution module 430 communicates the returned information to the interpretation module 422, which applies any required transformation to the information for further handling and processing. Further details of the operation of the interpretation module 422 are discussed in connection with FIG. 46.

FIG. 46 illustrates details of the interpretation module 422, and in particular its communications with various related other software components to apply required values, semantic transformations, and/or syntactical transformations to any ontologies, as described elsewhere herein. The interpretation module 422 is operative to retrieve any transformation ontologies, constructed and/or edited, as described herein, with other components and to invoke them to apply the transformations. The interpretation module 422 begins its operation in response to a communication message from various sources, as described in previous figures. It will be understood from previous discussion that pre-stored transformation ontologies may be associated with business information models and with instantiations of other higher-order ontologies to compensate for differences between web services and web service ontologies. The interpretation module 422 begins by passing a command to the Atlas 442 to retrieve any associated transformation functions. The Atlas 442 responds by querying the ontology store 140, which responds with any required transformation ontologies. The ontology store 140 returns any associated transformation ontology to the Atlas 442, which then communicates with the inference module 450 to apply any rules that are associated within the transformation ontology. The inference module 450 responds by returning the results of any transformation to the interpretation module 422. The interpretation module 422 then incorporates the transformation as a set of transformation services or functions, and input/out parameters into the execution model. The resultant execution model would consist of additional services requiring execution. The extended execution model is passed to the execution module 430. The execution module 430 then executes the execution model as above by forwarding the execution model to the business logic analyzer 432 for deconstruction.

In view of the foregoing detailed description of preferred embodiments of the present invention, it readily will be understood by those persons skilled in the art that the present invention is susceptible to broad utility and application. While various aspects have been described in the context of HTML and web page uses, the aspects may be useful in other contexts as well. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. A method of computing to address a predetermined computing requirement involving access to and use of computer resources, where more than one resource is capable of addressing the computing requirement, comprising the steps of:
(a) describing plural computer resources using a description language, thereby obtaining descriptions of the resources;
(b) arranging the descriptions in one or more semantic ontologies;
(c) accessing one or more of the ontologies to select a particular one of the plural resources as available and/or qualified for addressing the computing requirement; and
(d) executing a computing process that utilizes the selected one of the plural resources to satisfy the computing requirement.

2. The method of claim 1, wherein the description language is selected from the group comprising: XML, DAML, DAML+OIL, RDF, and WSDL.

3. The method of claim 1, wherein the computer resources comprise web services.

4. The method of claim 1, wherein the describing step involves identifying attributes of the computer-accessible resources.

5. The method of claim 4, wherein the attributes of the computer resources are selected from the group comprising but not limited to: message formatting for the computer resources, transport mechanisms associated with the computer resources, protocols associated with the computer resources, type serialization associated with the computer resources, and invocation requirements of the computer resources.

6. The method of claim 4, wherein the invocation requirements of the computer resources are selected from the group comprising: HTTP, SOAP, CORBA, JAVA RMI, and equivalent computer invocation specifications.

7. The method of claim 1, wherein a first ontology represents a computer resource structural ontology, and a second ontology represents a computer resource classification ontology relating to metadata associated with one or more computer resources.

8. The method of claim 1, further comprising a third ontology representing an information model.

9. The method of claim 1, further comprising an execution model ontology representing a set, sequence, and/or conditions of invoking computer resources to carry out a complex computing process.

10. The method of claim 1, further comprising a transformation ontology representing predetermined transformations to be applied to selected computer resources.

11. The method of claim 1, wherein the computer resources are selected from the group comprising but not limited to: computer application programs; web services; databases; directory services for users and groups of users (e.g., LDAP); file systems; digital media repositories; content repositories; enterprise resource registries; network-accessible resource registries; application interfaces; productivity applications such as spreadsheets or word processing applications; and network and system management systems.

12. A method of computing to address a predetermined computing requirement involving access to and use of computer resources, comprising the steps of:
registering one or more computer resources in a computer resource registry;
storing informational attributes of the computer resources obtained by marking up the one or more computer resources;
storing metadata associated with the computer resources reflecting supplemental informational attributes of the computer resources;
creating and storing descriptions of the computer resources in an information model utilizing the informational attributes and the supplemental informational attributes;
creating and storing a computer process execution model reflecting utilization of a an information model to address the predetermined computing requirement;
receiving input parameters from a computer system user, as a part of executing a computer process execution model; and
providing results of execution of the computer process execution model utilizing the user's input parameters.

13. The method of claim 12, wherein the informational attributes of the computer resources are selected from the group comprising: an interface to the computer resource, a precondition of executing the computer resource, a post-condition associated with the computer resource, a constraint associated with the computer resource, and one or more semantic relationships between the computer resources and other information.

14. The method of claim 12, wherein the informational attributes of the computer resources are stored in a computer resource structural ontology.

15. The method of claim 12, wherein the metadata is stored in a computer resource classification ontology.

16. The method of claim 12, further comprising the step of applying a transformation utilizing a transformation ontology to determine a correspondence between parameters of two different computer resources.

17. A method of computing to satisfy a predetermined computing requirement involving access to and use of computer-accessible resources, comprising the steps of:
locating computer resources that may be available to address a portion of the predetermined computing requirement;
registering located computer resources in a computer resource registry;
marking up registered computer resources to reflect their capabilities, constraints, and conceptual relationships in a mark-up language, thereby creating one or more ontologies and instances thereof;
storing the created one or more ontologies and instances thereof in an ontology store;
creating an information model that addresses aspects of the predetermined computing requirement, the information model utilizing the stored ontologies and instances thereof;
storing the information model in an information model store;
executing the information model based on input data, to address the predetermined computing requirement.

18. The method of claim 17, wherein the mark-up language is DAML+OIL.

19. The method of claim 17, wherein the input data is provided by a user of the information model.

20. The method of claim 17, wherein the input data is provided by a transformation ontology that stores default data for use in the process.
